(19) United States
(12) Patent Application Publication
(10) Pub. No.: US 2022/0013119 A1
(43) Pub. Date: Jan. 13, 2022

(54) INFORMATION PROCESSING DEVICE AND INFORMATION PROCESSING METHOD

(71) Applicant: SONY GROUP CORPORATION, TOKYO (JP)

(72) Inventor: KANA NISHIKAWA, TOKYO (JP)

(21) Appl. No.: 17/428,023

(22) PCT Filed: Dec. 10, 2019
(86) PCT No.: PCT/JP2019/048183

§ 371 Date: Aug. 3, 2021

(30) Foreign Application Priority Data
Feb. 13, 2019 (JP) 2019-024006

(51) Int. Cl. G10L 15/22; G06F 3/0481; G10L 15/18

(52) U.S. Cl. CPC G10L 15/22; G10L 2015/223; G10L 15/1815; G06F 3/0481

(57) ABSTRACT

An information processing device according to the application concerned includes an obtaining unit that obtains elements related to the dialogue state of the user of a dialogue system, and obtains the certainty factors of the elements; and a deciding unit that, according to the certainty factors obtained by the obtaining unit, decides on whether or not to treat the elements as the targets for highlighted display.

### FIELD

The application concerned is related to an information processing device and an information processing method.

### BACKGROUND

Typically, a dialogue agent system (a dialogue system) is known in which a response is given to an utterance of the user. For example, a technology has been provided in which a request is solved by combining the input made by the user in a natural language and the information selected from the current application, and is sent to an application for processing.

### CITATION LIST

### Patent Literature

Patent Literature 1: Japanese Patent Application Laid-open No. H8-235185

### SUMMARY

### Technical Problem

According to the conventional technology, processing is performed by combining the input made by the user in a natural language and the information selected from the current application.

However, the conventional technology may not always enable achieving enhancement in the accuracy of a dialogue system. For example, in the conventional technology, it is nothing more than performing processing according to the input made by the user in a natural language, and enhancing the accuracy of the dialogue system is a difficult task. Moreover, in the case of enhancing the accuracy of the dialogue system, it becomes important to receive corrections made by the user and utilize them. For that reason, in order to encourage the user to make corrections, the issue is to reduce the burden on the user of the dialogue system while making corrections.

In that regard, in the application concerned, an information processing device and an information processing method are proposed that enable achieving reduction in the burden on a user of a dialogue system while making corrections.

### Solution to Problem

According to the present disclosure, an information processing device includes an obtaining unit that obtains an element related to dialogue state of user of a dialogue system, and certainty factor of the element; and a deciding unit that, according to the certainty factor obtained by the obtaining unit, decides on whether or not to treat the element as target for highlighted display.

### BRIEF DESCRIPTION OF DRAWINGS

FIG. 1 is a diagram illustrating an example of the information processing performed according to an embodiment of the application concerned.

FIG. 2 is a diagram illustrating an exemplary configuration of an information processing system according to the embodiment of the application concerned.

FIG. 3 is a diagram illustrating an exemplary configuration of an information processing device according to the embodiment of the application concerned.

FIG. 4 is a diagram illustrating an example of an element information storing unit according to the embodiment according to the application concerned.

FIG. 5 is a diagram illustrating an example of a calculation information storing unit according to the embodiment of the application concerned.

FIG. 6 is a diagram illustrating an example of a target-dialogue-state information storing unit according to the embodiment of the application concerned.

FIG. 7 is a diagram illustrating an example of a threshold value information storing unit according to the embodiment of the application concerned.

FIG. 8 is a diagram illustrating an example of a context information storing unit according to the embodiment of the application concerned.

FIG. 9 is a diagram illustrating an exemplary network corresponding to a certainty factor calculation function.

FIG. 10 is a diagram illustrating an exemplary configuration of a display device according to the embodiment of the application concerned.

FIG. 11 is a flowchart for explaining the sequence of information processing performed according to the embodiment of the application concerned.

FIG. 12 is a flowchart for explaining the sequence of information processing performed according to the embodiment of the application concerned.

FIG. 13 is a flowchart for explaining the sequence of a dialogue with the user according to the embodiment of the application concerned.

FIG. 14 is a diagram illustrating an example of the display of information.

FIG. 15 is a diagram illustrating an example of a correction operation performed according to the embodiment of the application concerned.

FIG. 16 is a diagram illustrating an example of a correction operation performed according to a first modification example of the application concerned.

FIG. 17 is a diagram illustrating an example of the estimation of the dialogue state corresponding to a user utterance.

FIG. 18 is a diagram illustrating an example of updating the information that is estimated according to the utterances of the user.

FIG. 19 is a diagram illustrating an example of updating the information according to the correction made by the user.

FIG. 20 is a diagram illustrating an example of estimating the dialogue state based on sensor information.

FIG. 21 is a diagram illustrating an example of estimating the dialogue state based on the sensor information.

FIG. 22 is a diagram illustrating an example in which, in response to the correction of a particular slot value, the other slot values get updated.

FIG. 23 is a diagram illustrating an example in which, in response to the correction of a particular slot value, the other slot values get updated.

FIG. 24 is a diagram illustrating an example of an element information storing unit in which the slots have a hierarchical relationship.

FIG. 25 is a flowchart for explaining the sequence of operations performed when the user makes a correction.

FIG. 26 is a diagram illustrating an exemplary configuration of an information processing device according to a second modification example of the application concerned.

FIG. 27 is a diagram illustrating an example of a calculation information storing unit according to the second modification example of the application concerned.

FIG. 28 is a diagram illustrating an example of a target-dialogue-state information storing unit according to the second modification example of the application concerned.

FIG. 29 is a diagram illustrating an example of a context information storing unit according to the second modification example of the application concerned.

FIG. 30 is a hardware configuration diagram illustrating an example of a computer used for implementing an information processing device or implementing the functions of an information processing device.

### DESCRIPTION OF EMBODIMENTS

A preferred embodiment of the application concerned is described below in detail with reference to the accompanying drawings. However, an information processing device and an information processing method according to the application concerned are not limited by the embodiment described below. In the embodiment described below, identical constituent elements are referred to by the same reference numerals, and their explanation is not given repeatedly.

The explanation of the application concerned is given in the following order of items.

1. Embodiment

1-1. Overview of information processing according to embodiment of application concerned

1-2. Configuration of information processing system according to embodiment

1-3. Configuration of information processing device according to embodiment

1-4. Certainty factor, complementation

1-5. Configuration of display device according to embodiment

1-6. Sequence of information processing according to embodiment
1-6-1. Sequence of decision operation according to embodiment
1-6-2. Sequence of display operation according to embodiment
1-6-3. Sequence of processing of dialogue with user according to embodiment

1-7. Display of information of dialogue state

1-8. Information correction operation

1-9. Sequence of information processing according to first modification example

1-10. Domain goal, highlighting target
1-10-1. Plurality of domain goals
1-10-2. Updating
1-10-3. Constraints attributed to correction
1-10-4 Sensor information

1-11. Hierarchized slots
1-11-1. Correction of hierarchized slots
1-11-2. Data structure of hierarchized slots

1-12. Sequence of information correction operation

1-13. Visualization according to utterance order

2. Other exemplary configurations

2-1. Configuration of information processing device according to second modification example

3. Hardware configuration

### 1. Embodiment

[1-1. Overview of Information Processing According to Embodiment of Application Concerned]

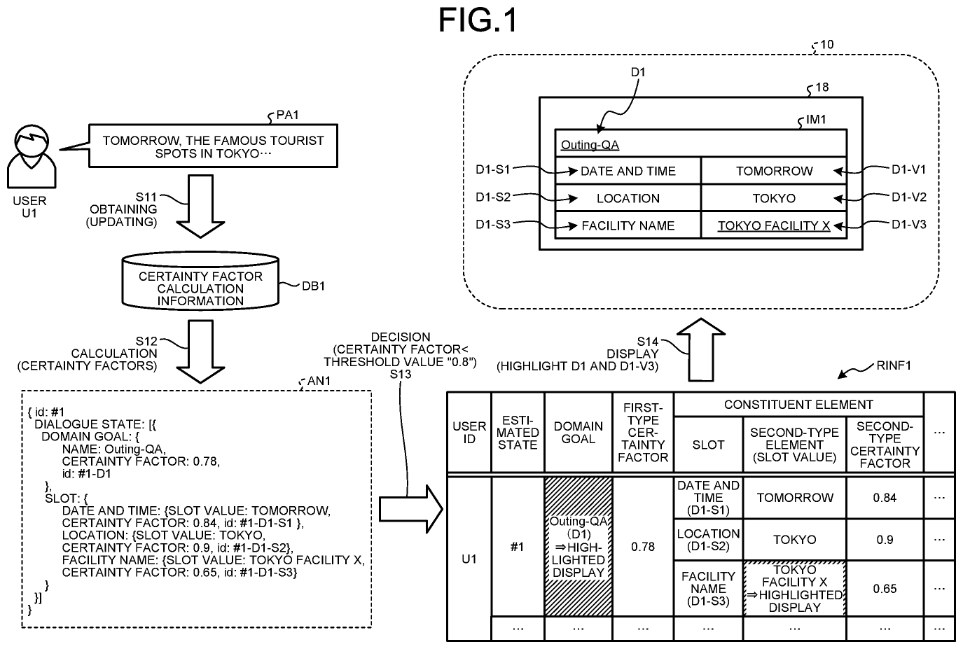

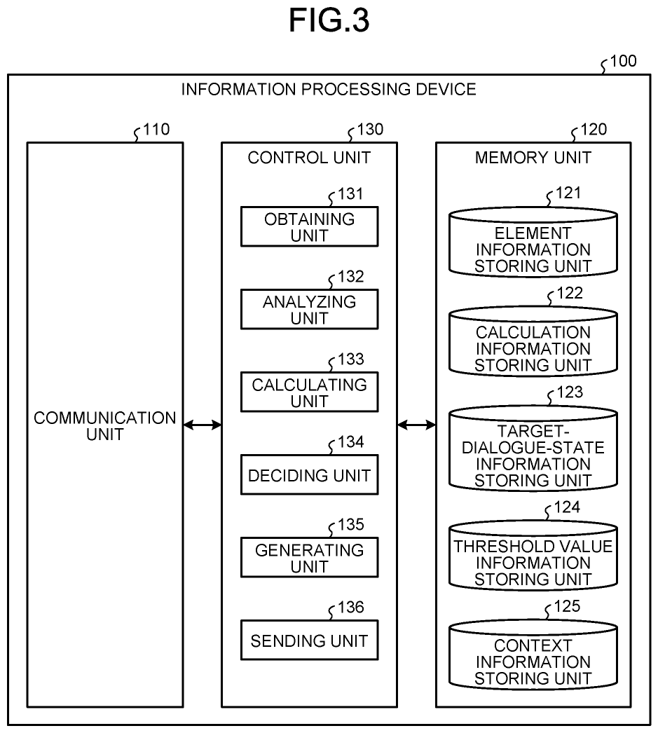

FIG. 1 is a diagram illustrating an example of the information processing performed according to the embodiment of the application concerned. The information processing according to the embodiment of the application concerned is performed by an information processing device 100 (see FIG. 3).

The information processing device 100 is an information processing device that performs information processing according to the embodiment. The information processing device 100 decides on the elements that, from among the elements related to the dialogue state of the user of a dialogue system, are to be treated as the targets for highlighted display. A display device 10 used by the user receives, from the information processing device 100, an image in which elements are displayed in a highlighted manner; and displays the image having the highlighted elements in a display unit 18. Although explained later in detail, the highlighted display illustrated in FIG. 1 is only exemplary and, as long as the target elements for highlighted display can be displayed in a highlighted manner, any display form can be used.

Explained below with reference to FIG. 1 is a case in which, through a dialogue conducted with a user U1, the elements corresponding to the dialogue state of the user U1 are displayed in a highlighted manner according to their certainty factors.

Firstly, with reference to FIG. 1, the user U1 makes an utterance. For example, around the display device 10 used by the user U1, the user U1 makes an utterance PA1 saying “tomorrow, the famous tourist spots in Tokyo . . . ”. Then, the display device 10 uses a sound sensor and detects voice information of the utterance PA1 (also simply referred to as the “utterance PA1”) indicating “tomorrow, the famous tourist spots in Tokyo . . . ”. Thus, the display device 10 detects the utterance PA1, which indicates “tomorrow, the famous tourist spots in Tokyo . . . ”, as the input. Moreover, the display device 10 sends detected sensor information to the information processing device 100. For example, the display device 10 sends, to the information processing device 100, sensor information corresponding to the point of time of the utterance PA1. For example, to the information processing device 100, the display device 10 sends, in a corresponding manner to the utterance PA1, a variety of sensor information such as position information, acceleration information, and image information detected within the period of time corresponding to the point of time of the utterance PA1 (for example, within one minute from the point of time of the utterance PA1). For example, the display device 10 sends, to the information processing device 100, sensor information corresponding to the point of time of the utterance PA1 (also called “corresponding sensor information”), along with the utterance PA1.

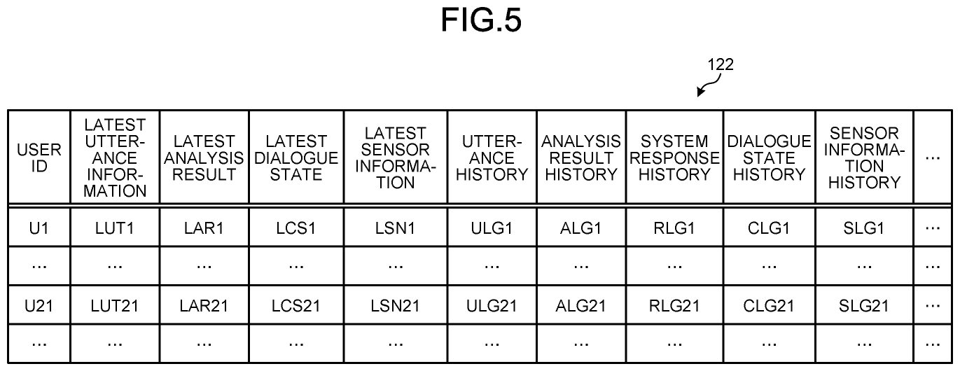

As a result, the information processing device 100 obtains the utterance PA1 and the corresponding sensor information from the display device 10 (Step S11). Then, the information processing device 100 updates certainty factor calculation information DB1 with the obtained utterance PA1 and the obtained corresponding sensor information. The certainty factor calculation information DB1 illustrated in FIG. 1 is used to store, in an identical manner to a calculation information storing unit 122 illustrated in FIG. 5, a variety of information to be used in calculating the certainty factors of the elements related to the dialogue state of the user of the dialogue system. In an identical manner to the calculation information storing unit 122 illustrated in FIG. 5, the certainty factor calculation information DB1 illustrated in FIG. 1 is used to store the following information in a corresponding manner to “user ID”: “latest utterance information”, “latest analysis result”, “latest dialogue state”, “latest sensor information”, “utterance history”, “analysis result history”, “system response history”, “dialogue state history”, and “sensor information history”.

Meanwhile, alternatively, the display device 10 can send the voice information of the utterance PA1 to a voice recognition server; obtain character information of the utterance PA1 from the voice recognition server; and then send the character information to the information processing device 100. If the display device 10 itself is equipped with the voice recognition function, then it can send, to the information processing device 100, only that information which needs to be sent to the information processing device 100. Moreover, either the information processing device 100 can obtain character information of voice information (such as the utterance PA1) from a voice recognition server; or the information processing device 100 itself can function as a voice recognition server. Alternatively, the information processing device 100 can implement a natural language processing technology such as morphological analysis with respect to the character information obtained by converting the voice information of the utterance PA1, and can estimate (identify) the contents of the utterance and the situation of the user.

As a result of analyzing the utterance PA1 and the corresponding sensor information, the information processing device 100 estimates the dialogue state of the user U1 who is associated to the utterance PA1. The information processing device 100 implements various types of conventional technologies and estimates the dialogue state of the user U1 who is associated to the utterance PA1. For example, the information processing device 100 analyzes the utterance PA1 using various types of conventional technologies, and estimates the contents of the utterance PA1 made by the user U1. For example, the information processing device 100 can implement various types of conventional technologies, such as parsing, to analyze the character information that is obtained by conversion of the utterance PA1 made by the user U1, and can estimate the contents of the utterance PA1 made by the user U1. For example, the information processing device 100 can implement a natural language processing technique such as morphological analysis with respect to the character information that is obtained by conversion of the utterance PA1 made by the user U1; extract important keywords from the character information of the utterance PA1 of the user U1; and, based on the keywords obtained by extraction (also called the “extracted keywords”), estimate the contents of the utterance PA1 made by the user U1.

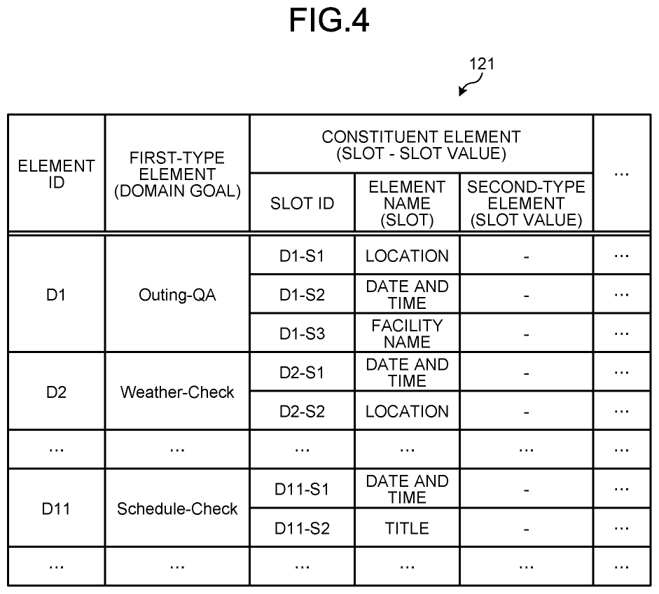

In the example illustrated in FIG. 1, the information processing device 100 analyzes the utterance PA1, and identifies that the utterance PA1 of the user U1 has the contents related to the outing destination on the next day. Then, based on the analysis result indicating that the utterance PA1 has the contents related to the outing destination on the next day, the information processing device 100 estimates that the dialogue state of the user U1 is related to the outing destination. As a result, the information processing device 100 estimates that “Outing-QA” related to the outing destination represents the domain goal indicating the dialogue state of the user U1. For example, the information processing device 100 can compare the contents of the utterance PA1 with the determination condition of each domain goal stored in an element information storing unit 121 (see FIG. 4), and can determine the domain goal indicating the dialogue state of the user U1. Meanwhile, as long as the domain goal indicating the dialogue state of the user U1 can be estimated, the information processing device 100 can implement any method for estimating the domain goal.

Moreover, the information processing device 100 analyzes the utterance PA1 and the corresponding sensor information, and estimates the slot value of each slot included in the domain goal “Outing-QA”. Thus, based on the analysis result indicating that the utterance PA1 has the contents related to the outing destination on the next day, the information processing device 100 estimates that a slot “date and time” has the slot value “tomorrow”, estimates that a slot “location” has the slot value “Tokyo”, and estimates that a slot “facility name” has the slot value “Tokyo facility X”. For example, the information processing device 100 can compare the extracted keywords, which are extracted from the utterance PA1 of the user U1, with each slot; and accordingly identify, as extracted keywords, the slot values of the slots corresponding to the extracted keywords. Meanwhile, as long as the slot values of the slots included in the domain goal can be identified, the information processing device 100 can implement any method for identifying the slot values.

Alternatively, the information processing device 100 can send the utterance PA1 and the corresponding sensor information to an external information processing device (an analysis device) that provides a voice analysis service, and can obtain the domain goal and the slot values from the analysis result. For example, the information processing device 100 sends the utterance PA1 and the corresponding sensor information to an analysis device; and can obtain, from the analysis device, the analysis result indicating that the dialogue state of the user U1 is represented by the domain goal “Outing-QA” and indicating the slot values of the domain goal “Outing-QA”.

Subsequently, the information processing device 100 calculates the certainty factors of the elements (also simply referred to as the “certainty factors”) related to the dialogue state of the user U1 of the dialogue system (Step S12). The information processing device 100 calculates the certainty factor of first-type elements indicating the dialogue state (also called “first-type certainty factors”), and calculates the certainty factors of second-type elements that correspond to the constituent elements of a first-type element (also called “second-type certainty factors”). In the example illustrated in FIG. 1, the information processing device 100 calculates the certainty factor of the domain goal “Outing-QA” that is the first-type element indicating the dialogue state of the user U1 (i.e., calculates the first-type certainty factor). Moreover, the information processing device 100 calculates the certainty factors of the slot values “tomorrow”, “Tokyo”, and “Tokyo facility X” that are the constituent elements belonging to the lower hierarchy of the first-type element represented by the domain goal “Outing-QA” (i.e., calculates second-type certainty factors).

For example, the information processing device 100 calculates the certainty factors of the domain goal and the slot values using Equation (1) given below.

y=f (x₁,x₂,x₃,x₄,x₅,x₆,x₇,x₈,x₉,x₁₀,x₁₁) (1)

On the left-hand side in Equation (1), “y” represents the certainty factor that gets calculated. On the right-hand side in Equation (1), “x₁” is assigned with information indicating the target for estimation of the certainty factor. For example, “x₁” is assigned with information indicating the domain goal or a slot value that represents the target for estimation of the certainty factor. More particularly, “x₁” is either assigned with information enabling identification of the domain goal (i.e., assigned with an element ID) or assigned with information enabling identification of a slot value (i.e., assigned with a slot ID), which represents the target for estimation of the certainty factor. That is, the value of the certainty factor “y” indicates the certainty factor corresponding to the estimation target assigned to “x₁”. On the right-hand side in Equation (1), “f” represents a function having “x₁” to “x₁₁” as the input. For example, the function “f” is a function which, when values are assigned to “x₁” to “x₁₁”, calculates the certainty factor “y” corresponding to the element specified in “x₁”. As long as the function “f” outputs the certainty factor, it can be any type of function such as a linear function or a nonlinear function.

Moreover, on the right-hand side in Equation (1), “x₂” is assigned with information corresponding to the latest utterance of the user. For example, “x₂” is assigned with information corresponding to the “latest utterance information” illustrated in FIG. 5. In the example illustrated in FIG. 1, “x₂” is assigned with information corresponding to the utterance PA1. Furthermore, on the right-hand side in Equation (1), “x₃” is assigned with information corresponding to the analysis result about the latest utterance of the user. For example, “x₃” is assigned with information corresponding to the “latest analysis result” illustrated in FIG. 5. In the example illustrated in FIG. 1, “x₃” is assigned with information corresponding to the latest analysis result about the utterance PA1.

Moreover, on the right-hand side in Equation (1), “x₄” is assigned with information corresponding to the latest dialogue state of the user. For example, “x₄” is assigned with information corresponding to the “latest dialogue state” illustrated in FIG. 5. In the example illustrated in FIG. 1, “x₄” is assigned with information corresponding to the domain goal “Outing-QA” that indicates the dialogue state. Furthermore, on the right-hand side in Equation (1), “x₅” is assigned with sensor information detected during the period of time corresponding to the point of time of the latest utterance made by the user. For example, “x₅” is assigned with information corresponding to the “latest sensor information” illustrated in FIG. 5. In the example illustrated in FIG. 1, “x₅” is assigned with information corresponding to the corresponding sensor information of the utterance PA1.

Moreover, on the right-hand side in Equation (1), “x₆” is assigned with information corresponding to the past utterances of the user. For example, “x₆” is assigned with information corresponding to the “utterance history” illustrated in FIG. 5. In the example illustrated in FIG. 1, “x₆” is assigned with information corresponding to an utterance history ULG1 of the user U1 as illustrated in FIG. 5. Furthermore, on the right-hand side in Equation (1), “x₇” is assigned with information corresponding to the analysis result of the past utterances of the user. For example, “x₇” is assigned with information corresponding to the “analysis result history” illustrated in FIG. 5. In the example illustrated in FIG. 1, “x₇” is assigned with information corresponding to an analysis result history ALG1 regarding the user U1 as illustrated in FIG. 5.

Moreover, on the right-hand side in Equation (1), “x₈” is assigned with information corresponding to the past response history of the dialogue system. For example, “x₈” is assigned with information corresponding to the “system response history” illustrated in FIG. 5. In the example illustrated in FIG. 1, “x₈” is assigned with information corresponding to a system response history RLG1 regarding the user U1 as illustrated in FIG. 5. Furthermore, on the right-hand side in Equation (1), “x₉” is assigned with information corresponding to the past dialogue states of the user. For example, “x₉” is assigned with information corresponding to the “dialogue state history” illustrated in FIG. 5. In the example illustrated in FIG. 1, “x₉” is assigned with information corresponding to a dialogue state history CLG1 regarding the user U1 as illustrated in FIG. 5.

Moreover, on the right-hand side in Equation (1), “x₁₀” is assigned with sensor information detected during the period of time corresponding to the point of time of each past utterance of the user. For example, “x₁₀” is assigned with information corresponding to the “sensor information history” illustrated in FIG. 5. In the example illustrated in FIG. 1, “x₁₀” is assigned with information corresponding to a sensor information history SLG1 regarding the user U1 as illustrated in FIG. 5. Furthermore, on the right-hand side in Equation (1), “x₁₁” is assigned with information corresponding to a variety of knowledge. For example, “x₁₁” can be assigned with any type of information that contributes in the enhancement of the calculation accuracy of the certainty factor, Thus, “x₁₁” can be assigned with information obtained from a knowledge base. Meanwhile, Equation (1) given above is only exemplary, and the function “f” is not limited to include “x₁” to “x₁₁” as the input; and can also include various other inputs such as “x₁₂” and “x₁₃”.

Using Equation (1) given above, the information processing device 100 calculates the certainty factor of each element. For example, in a function (a model, a function program) corresponding to Equation (1) given above, the information processing device 100 inputs the information corresponding to each of “x₁” to “x₁₁” on the right-hand side in Equation (1) and calculates the certainty factor.

The information processing device 100 assigns an element ID “D1”, which enables identification of the domain goal “Outing-QA”, to “x₁” in Equation (1) given earlier; assigns information corresponding to each of “x2” to “x11” in Equation (1) given earlier; and calculates the certainty factor of the domain goal “Outing-QA”. As illustrated in an analysis result AN1 in FIG. 1, the information processing device 100 calculates the certainty factor of the domain goal “Outing-QA” representing the first-type element (i.e., calculates the first-type certainty factor) to be equal to “0.78”.

Moreover, the information processing device 100 assigns identification information of the slot value “tomorrow” (i.e., assigns a slot ID “D1-S1” or a slot ID “D1-V1”) to “x₁” in Equation (1) given earlier; assigns information corresponding to each of “x₂” to “x₁₁” in Equation (1) given earlier; and calculates the certainty factor of the slot value “tomorrow”. As illustrated in the analysis result AN1 in FIG. 1, the information processing device 100 calculates the certainty factor of the slot value “tomorrow” representing a second-type element (i.e., calculates a second-type certainty factor) to be equal to “0.84”.

Moreover, the information processing device 100 assigns identification information of the slot value “Tokyo” (i.e., assigns a slot ID “D1-S2” or a slot ID “D1-V2”) to “x₁” in Equation (1) given earlier; assigns information corresponding to each of “x₂” to “x₁₁” in Equation (1) given earlier; and calculates the certainty factor of the slot value “Tokyo”. As illustrated in the analysis result AN1 in FIG. 1, the information processing device 100 calculates the certainty factor of the slot value “Tokyo” representing a second-type element (i.e., calculates a second-type certainty factor) to be equal to “0.9”.

Furthermore, the information processing device 100 assigns identification information of the slot value “Tokyo facility X” (i.e., assigns a slot ID “D1-S3” or a slot ID “D1-V3”) to “x₁” in Equation (1) given earlier; assigns information corresponding to each of “x₂” to “x₁₁” in Equation (1) given earlier; and calculates the certainty factor of the slot value “Tokyo facility X”. As illustrated in the analysis result AN1 in FIG. 1, the information processing device 100 calculates the certainty factor of the slot value “Tokyo facility X” representing a second-type element (i.e., calculates a second-type certainty factor) to be equal to “0.65”.

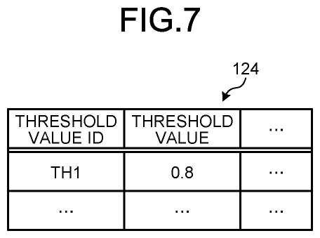

Then, based on the calculated certainty factors of the elements, the information processing device 100 decides on the targets for highlighted display (also called the “highlighting targets”) (Step S13). The information processing device 100 compares the certainty factor of each element with a threshold value and accordingly decides whether or not to treat that element as the highlighting target. If the certainty factor of an element is smaller than a threshold value “0.8”, then the information processing device 100 decides to treat that element as the highlighting target. For example, the information processing device 100 obtains the threshold value “0.8” from a threshold value information storing unit 124 (see FIG. 7).

Based on the comparison between the certainty factor “0.78” of the domain goal “Outing-QA” and the threshold value “0.8”, the information processing device 100 decides on whether or not to treat the domain goal “Outing-QA” as the highlighting target. Since the certainty factor “0.78” of the domain goal “Outing-QA” is smaller than the threshold value “0.8”, the information processing device 100 decides to treat the domain goal “Outing-QA” as the highlighting target, as illustrated in decision result information RINF1 in FIG. 1.

Moreover, based on the comparison between the certainty factor “0.84” of the slot value “tomorrow” and the threshold value “0.8”, the information processing device 100 decides on whether or not to treat the slot value “tomorrow” as the highlighting target. Since the certainty factor “0.84” of the slot value “tomorrow” is equal to or greater than the threshold value “0.8”, the information processing device 100 decides not to treat the slot value “tomorrow” as the highlighting target.

Furthermore, based on the comparison between the certainty factor “0.9” of the slot value “Tokyo” and the threshold value “0.8”, the information processing device 100 decides on whether or not to treat the slot value “Tokyo” as the highlighting target. Since the certainty factor “0.9” of the slot value “Tokyo” is equal to or greater than the threshold value “0.8”, the information processing device 100 decides not to treat the slot value “Tokyo” as the highlighting target.

Moreover, based on the comparison between the certainty factor “0.65” of the slot value “Tokyo facility X” and the threshold value “0.8”, the information processing device 100 decides on whether or not to treat the slot value “Tokyo facility X” as the highlighting target. Since the certainty factor “0.65” of the slot value “Tokyo facility X” is smaller than the threshold value “0.8”, the information processing device 100 decides to treat the slot value “Tokyo facility X” as the highlighting target, as illustrated in the decision result information RINF1 in FIG. 1.

In this way, the information processing device 100 decides to treat two elements having low certainty factors, namely, the domain goal “Outing-QA” and the slot value “Tokyo facility X” as the highlighting targets.

Subsequently, the information processing device 100 displays the domain goal “Outing-QA” and the slot value “Tokyo facility X” in a highlighted manner (Step S14). For example, the information processing device 100 generates an image IM1 in which a domain goal D1, which represents the domain goal “Outing-QA”, and the slot value D1-V3, which represents the slot value “Tokyo facility X”, are highlighted. The information processing device 100 generates the image IM1 that includes the domain goal D1, the slot D1-S1 representing the slot “date and time”, the slot D1-S2 representing the slot “location”, and the slot D1-S3 representing the slot “facility name”. Moreover, the information processing device 100 generates the image IM1 that includes the slot value D1-V1 representing the slot value “tomorrow”, the slot value D1-V2 representing the slot value “Tokyo”, and the slot value D1-V3.

In the example illustrated in FIG. 1, the information processing device 100 generates the image IM1 in which the character string “Outing-QA” of the domain goal D1 and the character string “Tokyo Facility X” of the slot value D1-V3 are underlined. However, the highlighting of the highlighting targets is not limited to underlining. That is, as long as the highlighting targets have a different display form than the elements not to be highlighted, the highlighting can be performed in any manner. For example, the highlighting of the highlighting targets can be in the form of displaying them with a larger font size than the font size of the elements not to be highlighted, or can be in the form of displaying them with a different color than the color of the elements not to be highlighted. Alternatively, the highlighting of the highlighting targets can be in the form of displaying them in a blinking manner.

Meanwhile, the information processing device 100 can generate the image IM1 in which the character string “Outing-QA” of the domain goal D1 and the character string “Tokyo Facility X” of the slot value D1-V3 are correctible by the user. For example, when the user specifies the area in which the character string “Outing-QA” of the domain goal D1 or the character string “Tokyo Facility X” of the slot value D1-V3 is displayed, the information processing device 100 generates the image IM1 that enables input of a new domain goal or a new slot value. Moreover, the information processing device 100 can generate the image IM1 in which the elements not to be highlighted, such as the character string “tomorrow” of the slot value D1-V1 and the character string “Tokyo” of the slot value

D1-V2, are correctible by the user. Meanwhile, in the case in which the corrections are received only via the voice of the user, the information processing device 100 need not generate an image that is correctible by the user.

Herein, as long as screens (image information) to be provided to external information processing devices can be generated, the information processing device 100 can perform any type of processing for generating screens (image information). For example, the information processing device 100 implements various technologies related to image generation and image processing, and generates screens (image information) to be provided to the display device 10. For example, based on the format of the CSS (Cascading Style Sheets), or JavaScript (registered trademark), or HTML (HyperText Markup Language); the information processing device 100 can generate screens (image information) to be provided to the display device 10.

Subsequently, the information processing device 100 sends the image IM1, in which the character string “Outing-QA” of the domain goal D1 and the character string “Tokyo Facility X” of the slot value D1-V3 are underlined, to the display device 10. Upon receiving the image IM1 in which the character string “Outing-QA” of the domain goal D1 and the character string “Tokyo Facility X” of the slot value D1-V3 are underlined, the display device 10 displays the image IM1 in the display unit 18.

As explained above, the information processing device 100 calculates the certainty factor of each element, and decides to highlight the elements having low certainty factors. Then, the information processing device 100 generates an image in which the elements having low certainty factors are highlighted, and displays the image in the display device 10 used by the user U1. As a result, the user U1 of the display device 10 becomes able to view, without fail, the elements having low certainty factors, such as the domain goal “Outing-QA” and the slot value “Tokyo facility X”. Meanwhile, in the example explained above, the information processing device 100 generates an image in which the highlighting targets are highlighted, and provides the image to the display device 10. Alternatively, the information processing device 100 can provide the display device 10 with the information indicating which elements are to be highlighted (highlighting/no highlighting information). Then, based on the received highlighting/no highlighting information, the display device 10 highlights the elements to be highlighted. With reference to FIG. 1, the information processing device 100 sends, to the display device 10, highlighting/no highlighting information indicating that the character string “Outing-QA” of the domain goal D1 and the character string “Tokyo Facility X” of the slot value D1-V3 are the highlighting targets (highlighting/no highlighting information EINF). Based on the received highlighting/no highlighting information EINF, the display device 10 displays the character string “Outing-QA” of the domain goal D1 and the character string “Tokyo Facility X” of the slot value D1-V3 in a highlighted manner.

Moreover, with respect to the domain goal “Outing-QA” and the slot value “Tokyo facility X” that are highlighted, the display device 10 can receive corrections from the user U1. For example, according to a touch by the user U1 in the area in which a highlighting target (element) such as the domain goal “Outing-QA” or the slot value “Tokyo facility X” is displayed, the display device 10 receives input of the user regarding the touched element. Subsequently, when a correction operation of the user U1 is received with respect to the domain goal “Outing-QA” or the slot value “Tokyo Facility X”, the display device 10 sends that information (correction information) to the information processing device 100. Based on the correction information obtained from the display device 10, the information processing device 100 makes changes in the element corresponding to the correction information. In the example illustrated in FIG. 1, upon obtaining correction information indicating that the user U1 has corrected the slot value “Tokyo facility X” to a slot value “Tokyo facility Y”, the information processing device 100 changes the slot value of the slot “facility name” to “Tokyo facility Y” in the domain goal “Outing-QA” corresponding to the dialogue state of the user U1 (an estimated state #1).

Regarding the voice recognition result, a conventional technology has been proposed in which an UI (User Interface) based feedback is given to the user, so as to prompt the user to make corrections. In recent years, the dialogue technology of an agent is not limited to voice recognition and is often configured with the stack of a plurality of modules such as semantic analysis and context-based intention estimation. For that reason, the eventual response of the dialogue system is likely to potentially include a combined error of the modules, and there may be times when the system response is incomprehensible to the user.

For that reason, also in order to enable the dialogue system and the user to share the context of the dialogue, it is important to provide a function enabling visualization of the analysis result obtained by the dialogue system about the utterances and the context of the user and enabling the user to easily make corrections in case there are differences between the analysis result and the user perception. An information processing system 1 in which the abovementioned dialogue system is implemented highlights the elements that are highly likely to be corrected by the user, so that the user can visually check those elements and correct them in case there are any differences between the elements and the user perception. Thus, the information processing system 1 provides a function that enables the user to easily make corrections.

The information processing system 1 visualizes the dialogue state of the user based on information such as the context collected during the dialogue with the user. The information processing device 100 calculates the certainty factors of the elements such as the domain goal and the track values of the dialogue state and, if any certainty factor is low, decides to highlight that element in view of the high likelihood that the element would be changed by the user. As a result, the information processing device 100 highlights the elements that are highly likely to be changed by the user, so that the user can visually check those elements and correct them in case there are any differences between the elements and the user perception. Thus, the information processing device 100 can provide a function that enables the user to easily make corrections.

[1-2. Configuration of Information Processing System According to Embodiment]

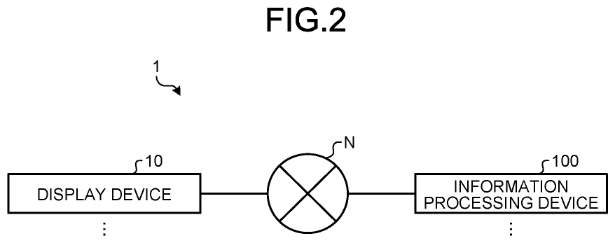

The following explanation is given about the information processing system 1 illustrated in FIG. 2. As illustrated in FIG. 2, the information processing system 1 includes the display device 10 and the information processing device 100. The display device 10 and the information processing device 100 are communicably connected to each other, in a wired manner or a wireless manner, via a predetermined communication network (a network N). FIG. 2 is a diagram illustrating an exemplary configuration of the information processing system according to the embodiment. The information processing system 1 illustrated in FIG. 2 can include a plurality of display devices 10 and a plurality of information processing devices 100. For example, the information processing system 1 implements the dialogue system explained above.

The display device 10 is an information processing device used by the user. The display device 10 is used to provide a dialogue service for responding to the utterances of the user. The display device 10 includes a sound sensor that detects the sounds from a microphone. For example, using the sound sensor, the display device 10 detects the utterances made by the user around the display device 10. For example, the display device 10 can be a device that detects the surrounding sounds and performs various operations according to the detected sounds (i.e., can be a voice assistance terminal). The display device 10 is a terminal device that performs operations with respect to the utterances made by the user.

Herein, as long as the operations according to the embodiment can be performed, the display device 10 can be any type of device. Thus, as long as the display device 10 provides a dialogue service to the user and is configured to include a display (the display unit 18) for displaying information, it can be any type of device. For example, the display device 10 can be a robot, such as what is called a smart speaker, or an entertainment robot, or a domestic robot, that is capable of having a dialogue with a person (user). Alternatively, for example, the display device 10 can be a 0smartphone, a tablet terminal, a notebook PC (Personal Computer), a desktop PC, a cellular phone, or a PDA (Personal Digital Assistant).

The display device 10 includes a sound sensor (a microphone) for detecting sounds. For example, using the sound sensor, the display device 10 detects the utterances made by the user. However, the display device 10 not only collects the utterances made by the user, but also collects the environmental sounds generated around the display device 10. Moreover, the display device 10 not only includes the sound sensor but also includes various types of other sensors. For example, the display device 10 can include sensors for detecting a variety of information such as images, acceleration, temperature, humidity, position, pressure, light, gyro, and distance. Thus, besides including the sound sensor, the display device 10 can include various sensors such as an image sensor (camera) for detecting images, an acceleration sensor, a temperature sensor, a humidity sensor, a positioning sensor such as a GPS sensor, a pressure sensor, a light sensor, a gyro sensor, and a distance sensor. Moreover, besides including the sensors mentioned above, the display device 10 can also include various other sensors such as an illumination sensor, a proximity sensor, and a sensor for obtaining biological information such as body odor, sweating, heart rate, pulse, and brain waves. The display device 10 can send, to the information processing device 100, a variety of sensor information detected by the various sensors. Meanwhile, the display device 10 can have a driving mechanism such as an actuator or an encoder-equipped motor. The display device 10 can send, to the information processing device 100, sensor information containing information detected in regard to the driving state of the driving mechanism such as an actuator or an encoder-equipped motor. The display device 10 can include a software module for performing voice signal processing, voice recognition, utterance semantic analysis, dialogue control, and behavior output.

The information processing device 100 is used for providing services regarding a dialogue system to the user. The information processing device 100 performs a variety of information processing regarding the dialogue system. The information processing device 100 is an information processing device that decides, according to the certainty factor of each element related to the dialogue state of the user of the dialogue system, whether or not to treat that element as the target for highlighted display. The information processing device 100 calculates the certainty factors of the elements based on the information regarding the dialogue system. Alternatively, the information processing device 100 can obtain the certainty factors of the elements from an external device that calculates the certainty factors of elements; and, according to the obtained certainty factors, can decide on whether or not to treat an element as the target for highlighted display.

Moreover, the information processing device 100 can include a software module for performing voice signal processing, voice recognition, utterance semantic analysis, and dialogue control. Furthermore, the information processing device 100 can be equipped with the voice recognition function. Alternatively, the information processing device 100 can obtain information from a voice recognition server that provides the voice recognition service. In that case, the voice recognition server can be included in the decision system 1. In the example illustrated in FIG. 1, the information processing device 100 or the voice recognition server implements various conventional technologies to recognize the utterances made by users and to identify the user who made an utterance.

Moreover, in the information processing system 1, an information providing device can also be included that provides a variety of information to the information processing device 100. For example, the information providing device sends, to the information processing device 100, a variety of utterance history and past context information of the user. Moreover, the information providing device sends, to the information processing device 100, the information regarding the analysis result and the dialogue state of the past utterances of the user. Furthermore, the information providing device sends, to the information processing device 100, the response history of the dialogue system.

[1-3. Configuration of Information Processing Device According to Embodiment]

Given below is the explanation of a configuration of the information processing device 100 that represents an example of the information processing device meant for performing the information processing according to the embodiment. FIG. 3 is a diagram illustrating an exemplary configuration of the information processing device 100 according to the embodiment of the application concerned.

As illustrated in FIG. 3, the information processing device 100 includes a communication unit 110, a memory unit 120, and a control unit 130. Moreover, the information processing device 100 can also include an input unit (for example, a keyboard or a mouse) for receiving various operations from the administrator of the information processing device 100, and a display unit (for example, a liquid crystal display) that displays a variety of information.

The communication unit 110 is implemented using, for example, an NIC (Network Interface Card). The communication unit 110 is connected to the network N (see FIG. 2) in a wired manner or a wireless manner, and sends information to and receives information from other information processing devices such as the display device 10 and the voice recognition server. Moreover, the communication unit 110 can send information to and receive information from the user terminal (not illustrated) of the user.

The memory unit 120 is implemented using, for example, a semiconductor memory such as a RAM (Random Access Memory) or a flash memory, or a memory device such as a hard disk or an optical disk. As illustrated in FIG. 3, the memory unit 120 according to the embodiment includes the element information storing unit 121, the calculation information storing unit 122, a target-dialogue-state information storing unit 123, the threshold value information storing unit 124, and a context information storing unit 125.

The element information storing unit 121 according to the embodiment is used to store a variety of information regarding the elements. The element information storing unit 121 is used to store a variety of information about the elements related to the dialogue state of the user. Thus, the element information storing unit 121 is used to store a variety of information such as the first-type elements (the domain goals) that indicate the dialogue states of the user, and the second-type elements (slot values) corresponding to the elements (slots) that belong to the first-type elements. FIG. 4 is a diagram illustrating an example of the element information storing unit according to the embodiment. In the element information storing unit 121 illustrated in FIG. 4, the following items are included: “element ID”, “first-type element (domain goal)”, and “constituent element (slot-slot value)”. In the item “constituent element (slot-slot value)”, the following items are included: “slot ID”, “element name (slot)”, and “second-type element (slot value)”.

The item “element ID” represents the identification information for enabling identification of an element. The item “element ID” represents identification information for enabling identification of the domain goal representing a first-type element. The item “first-type element (domain goal)” represents the first-type element (the domain goal) that is identified by the element ID. The item “first-type element (domain goal)” indicates the specific name of the first-type element (the domain goal) that is identified by the element ID.

In the item “constituent element (slot-slot value)”, a variety of information regarding the constituent elements of the concerned first-type element (the domain goal) is stored. For example, the item “constituent element (slot-slot value)” is used to store a variety of information such as the second-type elements in the form of the slots included in the concerned domain goal and the values of those slots (i.e., the slot values). The item “slot ID” represents identification information for enabling identification of each constituent element (slot). The item “element name (slot)” represents the specific name of the constituent element that is identified by the concerned slot ID. The item “second-type element (slot value)” represents the second-type element that is the slot value of the slot identified by the concerned slot ID. Meanwhile, regarding the item “second-type element (slot value)” in the element information storing unit 121, “- (hyphen)” indicates that no value is stored in the item “second-type element (slot value)”. In the item “second-type element (slot value)”, a specific value (information) is stored when a domain goal is actually associated to the user.

In the example illustrated in FIG. 4, the first-type element identified by the element ID “D1” (corresponding to the item “domain goal D1” illustrated in FIG. 1) is “Outing-QA” representing the domain goal corresponding to the dialogue about the outing destination. Moreover, it is illustrated that the domain goal D1 has three slot IDs, namely, the slot IDs “D1-S1”, “D1-S2”, and “D1-S3” associated thereto.

The slot identified by the slot ID “D1-S1” (corresponding to the slot D1-S1 illustrated in FIG. 1) corresponds to “date and time”. The slot identified by the slot ID “D1-S2” (corresponding to the slot D1-S2 illustrated in FIG. 1) corresponds to “location”. The slot identified by the slot ID “D1-S3” (corresponding to the slot D1-S3 illustrated in FIG. 1) corresponds to “facility name”.

Meanwhile, the element information storing unit 121 is not limited to store the information explained above, and can be used to store a variety of other information depending on the objective. For example, the element information storing unit 121 can be used to store, in a corresponding manner to the element ID, information indicating conditions by which the dialogue state of the user is determined to correspond to the domain goal.

The calculation information storing unit 122 according to the embodiment is used to store a variety of information to be used in calculating the certainty factors. Thus, the calculation information storing unit 122 according to the embodiment is used to store a variety of information to be used in calculating the first-type certainty factors, which represent the certainty factors of the first-type elements, and the second-type certainty factors, which represent the certainty factors of the second-type elements. FIG. 5 is a diagram illustrating an example of the calculation information storing unit according to the embodiment. In the calculation information storing unit 122, the following items are included: “user ID”, “latest utterance information”, “latest analysis result”, “latest dialogue state”, “latest sensor information”, “utterance history”, “analysis result history”, “system response history”, “dialogue state history”, and “sensor information history”.

The item “user ID” represents identification information for enabling identification of the user. Thus, the item “user ID” represents identification information for enabling identification of the user for whom the certainty factors are to be calculated. For example, the item “user ID” represents identification information for enabling identification of the user. The item “user ID” represents identification information for enabling identification of the user who is having the dialogue for which the certainty factors are to be calculated.

The item “latest utterance information” represents information related to the latest utterance made by the user who is identified by the concerned user ID. Thus, the item “latest utterance information” represents utterance information of the last detected utterance made by the user. Meanwhile, in the example illustrated in FIG. 5, the item “latest utterance information” is illustrated using an abstract reference numeral “LUT1”. Alternatively, in the item “latest utterance information”, a specific voice such as “tomorrow, the famous tourist spots in Tokyo . . . ” can be included, or character information corresponding to that voice can be included.

The item “latest analysis result” represents information related to the analysis result about the latest utterance made by the user who is identified by the concerned user ID. Thus, the item “latest analysis result” indicates the result of semantic analysis of the utterance information of the last detected utterance made by that user. In the example illustrated in FIG. 5, The item “latest analysis result” is illustrated using an abstract reference numeral “LAR1”. Alternatively, in the item “latest analysis result”, information extracted from an utterance such as “tomorrow” or “Tokyo” can be included, or the information on the result of the semantic analysis based on the extracted information can be included.

The item “latest dialogue state” represents information related to the latest dialogue state of the user who is identified by the concerned user ID. The item “latest dialogue state” indicates the dialogue state selected based on the result of semantic analysis of the utterance information of the last detected utterance made by that user. In the example illustrated in FIG. 5, the item “latest dialogue state” is illustrated using an abstract reference numeral “LCS1”. Alternatively, in the item “latest dialogue state”, for example, information such as the domain goal or the element ID that enables identification of the dialogue state can be included.

The item “latest sensor information” represents the information related to the sensor information detected during the period of time corresponding to the point of time of the latest utterance made by the user who is identified by the concerned user ID. Thus, the item “latest sensor information” represents the sensor information detected at the date and time corresponding to the last utterance made by that user. In the example illustrated in FIG. 5, the item “latest sensor information” is illustrated using an abstract reference numeral “LSN1”. Alternatively, in the item “latest sensor information”, for example, sensor information such as acceleration information, temperature information, humidity information, position information, and pressure information detected by various sensors can be included.

The item “utterance history” represents information related to the utterance history of the user who is identified by the concerned user ID. The item “utterance history” represents history information of the utterances that were detected before the latest utterance information regarding that user. In the example illustrated in FIG. 5, the item “utterance history” is illustrated using an abstract reference numeral “ULG1”. Alternatively, in the item “utterance history”, a specific voice such as “if I can take some time off . . . ” or “tomorrow . . . ” can be included, or character information corresponding to that voice can be included.

The item “analysis result history” represents information related to the analysis result of the past utterances of the user who is identified by the concerned user ID. The item “analysis result history” indicates the history of the results of semantic analysis of the utterance information detected before the latest utterance information regarding that user. In the example illustrated in FIG. 5, the item “analysis result history” is illustrated using an abstract reference numeral “ALG1”. Alternatively, in the item “analysis result history”, history information extracted from an utterance such as “time off” can be included, or result history information of the past semantic analysis based on that history information can be included.

The item “system response history” represents information related to the response history of the dialogue system. The item “system response history” represents history information of the responses given by the dialogue system before the latest utterance information regarding the concerned user. In the example illustrated in FIG. 5, the item “system response history” is illustrated using an abstract reference numeral “RLG1”. Alternatively, in the item “system response history”, character information corresponding to a specific system response such as “tomorrow's weather . . . ” or “recommended spots around Tokyo railway station . . . ” can be included.

The item “dialogue state history” represents information related to the past dialogue states of the user who is identified by the concerned user ID. The item “dialogue state history” indicates the history of dialogue states selected based on the semantic analysis result of the past utterance information detected before the latest utterance information regarding that user. In the example illustrated in FIG. 5, the item “dialogue state history” is illustrated using an abstract reference numeral “CLG1”. Alternatively, in the item “dialogue state history”, for example, history information such as the domain goal name or the element ID that enables identification of the past dialogue states can be included.

The item “sensor information history” represents information related to the sensor information detected during the period of time corresponding to the point of time of each past utterance of the user who is identified by the concerned user ID. The item “sensor information history” indicates the sensor information detected at the date and time corresponding to each utterance made before the latest utterance information regarding that user. In the example illustrated in FIG. 5, the item “sensor information history” is illustrated using an abstract reference numeral “SLG1”. Alternatively, in the item “sensor information history”, for example, the history of sensor information such as acceleration information, temperature information, humidity information, position information, and pressure information detected in the past by various sensors can be included.

In the example illustrated in FIG. 5, in the calculation information used for the user identified by the user ID “U1” (corresponding to the “user U1” illustrated in FIG. 1), “LUT1” represents the latest utterance information. Moreover, in the calculation information used for the user U1, “LAR1” represents the latest analysis result Furthermore, in the calculation information used for the user U1, “LCS1” represents the latest dialogue state. Moreover, in the calculation information used for the user U1, “LSN1” represents the latest sensor information. Furthermore, in the calculation information used for the user U1, “ULG1” represents the utterance history. Moreover, in the calculation information used for the user U1,

“ALG1” represents the analysis result history. Furthermore, in the calculation information used for the user U1, “RLG1” represents the system response history. Moreover, in the calculation information used for the user U1, “CLG1” represents the dialogue state history. Furthermore, in the calculation information used for the user U1, “SLG1” represents the sensor information history.

Meanwhile, the information explained above is only exemplary. Thus, the calculation information storing unit 122 is not limited to store that information, and can be used to store a variety of information according to the objective. When any information other than the information explained above is to be used in calculating the certainty factors, the calculation information storing unit 122 can be used to store the other information. For example, in the case of using attribute information of the user in calculating the certainty factors, the calculation information storing unit 122 can be used to store information related to the demographic attributes of that user or information related to the psychographic attributes of that user, in a corresponding manner to the user ID. For example, the calculation information storing unit 122 can be used to store information such as the age, the gender, the interest, the family structure, the income, and the lifestyle, in a corresponding manner to the user ID.

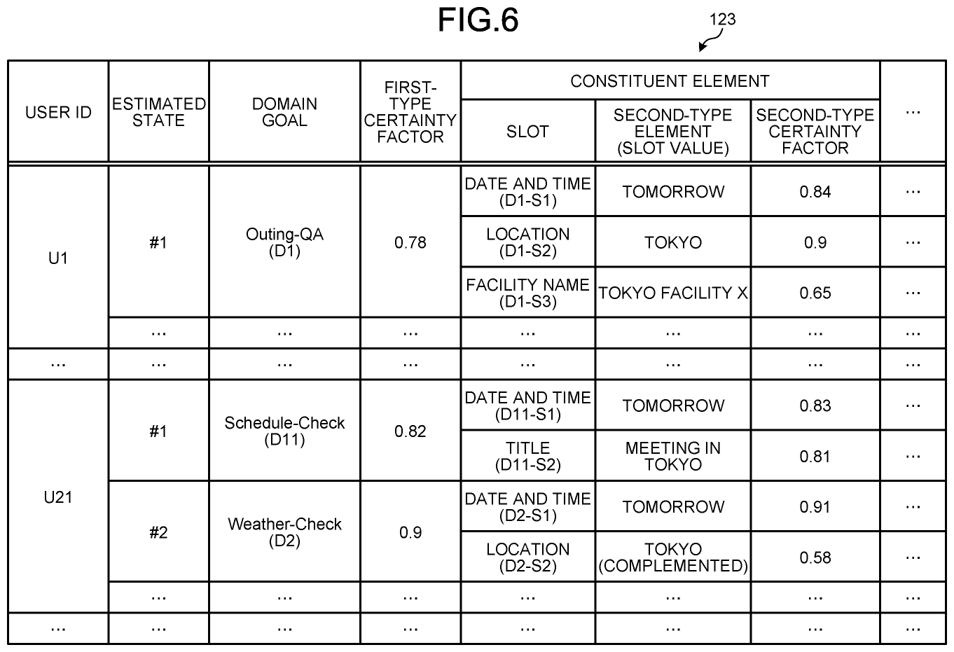

The target-dialogue-state information storing unit 123 according to the embodiment is used to store the information corresponding to the estimated dialogue state. For example, the target-dialogue-state information storing unit 123 is used to store the information corresponding to the dialogue state estimated for each user. FIG. 6 is a diagram illustrating an example of the target-dialogue-state information storing unit according to the embodiment. In the target-dialogue-state information storing unit 123 illustrated in FIG. 6, the following items are included: “user ID”, “estimated state”, “domain goal”, “first-type certainty factor”, and “constituent element”. Moreover, in the item “constituent element”, the following items are included: “slot”, “second-type element (slot value)”, and “second-type certainty factor”.

The item “user ID” represents identification information enabling identification of the user. The item “user ID” represents identification information enabling identification of the target user for processing. Thus, the item “user ID” represents identification information enabling identification of the dialogue state and identification of the user for whom the certainty factors are to be calculated. The item “estimated state” represents information enabling identification of the dialogue state of the concerned user. When a plurality of dialogue states is identified regarding a user, the item “estimated state” for that user includes a plurality of sets of information such as “#1”, “#2”, and so on. For example, when it is identified that the user is having dialogues in parallel in a plurality of dialogue states, a plurality of dialogue states such as “#1”, “#2”, and so on is associated to that user.

The item “domain goal” represents information enabling identification of the domain goal (the first-type element) of the concerned estimated state. In the item “domain goal”, information enabling identification of the domain goal, such as the specific name of the domain goal, is stored. For example, in the item “domain goal”, information (the element ID) enabling identification of the domain goal can be stored. The item “first-type certainty factor” indicates the certainty factor calculated for the concerned domain goal (the first-type element). Thus, the item “first-type certainty factor” indicates the certainty factor of the domain goal (the first-type element) of the concerned estimated state.

In the item “constituent element”, a variety of information related to the constituent elements of the concerned domain goal (the first-type element) is stored. For example, the item “constituent element” is used to store a variety of information such as the slots included in the concerned domain goal, the respective slot values (the second-type elements), and the respective second-type certainty factors.

The item “slot” represents information enabling identification of the constituent elements (slots) of the domain goal (the first-type element) of the concerned estimated state. In the item “slot”, the information enabling identification of the constituent elements, such as the specific names of the constituent elements, of the concerned domain goal (the first-type element) is stored. For example, in the item “slot”, information (slot IDs) enabling identification of the constituent elements (slots) can be stored. The item “second-type element (slot value)” indicates the slot value (the second-type element) of the concerned slot. The item “second-type element (slot value)” indicates the slot value identified by the concerned estimated state. For example, in the item “second-type element (slot value)”, the specific value (character string) for the concerned slot is stored. The item “second-type certainty factor” indicates the certainty factor calculated for the concerned slot value (the second-type element). Thus, the item “second-type certainty factor” indicates the certainty factor of the slot value (the second-type element) of the concerned estimated state.

In the example illustrated in FIG. 6, regarding the user identified by the user ID “U1” (corresponding to the “user U1” illustrated in FIG. 1), it is indicated that the dialogue state identified by “#1” (i.e., a dialogue state #1) is included as the estimated dialogue state. The dialogue state #1 of the user U1 represents the first-type element identified by the element ID “D1”, that is, the domain goal “Outing-QA”. Moreover, the dialogue state #1 of the user U1 indicates that the domain goal “Outing-QA” has the certainty factor “0.78”.

Furthermore, the dialogue state #1 of the user U1 indicates that the slot “date and time” of the domain goal “Outing-QA” has the slot value “tomorrow”. Moreover, the dialogue state #1 of the user U1 indicates that the slot value “tomorrow” of the slot “date and time” has the certainty factor “0.84”.

Furthermore, the dialogue state #1 of the user U1 indicates that the slot “location” of the domain goal “Outing-QA” has the slot value “Tokyo”. Moreover, the dialogue state #1 of the user U1 indicates that the slot value “Tokyo” of the slot “location” has the certainty factor “0.9”.

Furthermore, the dialogue state #1 of the user U1 indicates that the slot “facility name” of the domain goal “Outing-QA” has the slot value “Tokyo facility X”. Moreover, the dialogue state #1 of the user U1 indicates that the slot value “Tokyo facility X” of the slot “facility name” has the certainty factor “0.65”. Meanwhile, although the slot “facility name” is represented by a character string “Tokyo facility X” including an abstract reference numeral, it is assumed that “Tokyo facility X” is the facility name of a specific sightseeing spot in Tokyo.

Meanwhile, the target-dialogue-state information storing unit 123 is not limited to store the information explained above, and can be used to store a variety of other information depending on the objective. In the target-dialogue-state information storing unit 123, information (a flag) indicating whether or not an element is the target for highlighted display can be stored in a corresponding manner to the domain goal or the slot value.

The threshold value information storing unit 124 is used to store a variety of information regarding threshold values. The threshold value information storing unit 124 is used to store a variety of information regarding a threshold value to be used in deciding whether or not an element is the target for highlighted display. FIG. 7 is a diagram illustrating an example of the threshold value information storing unit according to the embodiment. In the threshold value information storing unit 124 illustrated in FIG. 7, items such as “threshold value ID” and “threshold value” are included.

The item “threshold value ID” represents identification information enabling identification of the threshold value. The item “threshold value” indicates the specific threshold value that is identified by the concerned threshold value ID.

In the example illustrated in FIG. 7, a threshold value TH1 identified by a threshold value ID “TH1” is equal to “0.8”.

Meanwhile, the threshold value information storing unit 124 is not limited to store the information explained above, and can be used to store a variety of other information according to the objective. For example, the threshold value information storing unit 124 can be used to store the intended usage of a threshold value in a corresponding manner to the threshold value ID. For example, the threshold value information storing unit 124 can be used to store the intended usage such as “target for highlighted display” in a corresponding manner to the threshold value ID “TH1”. For example, if the threshold value used for the first-type certainty factors is different than the threshold value used for the second-type certainty factors, then the threshold value information storing unit 124 can be used to store the threshold values corresponding to each type of certainty factor. In that case, the threshold value information storing unit 124 can be used to store a first threshold value corresponding to the first-type certainty factors and a second threshold value corresponding to the second-type certainty factors.

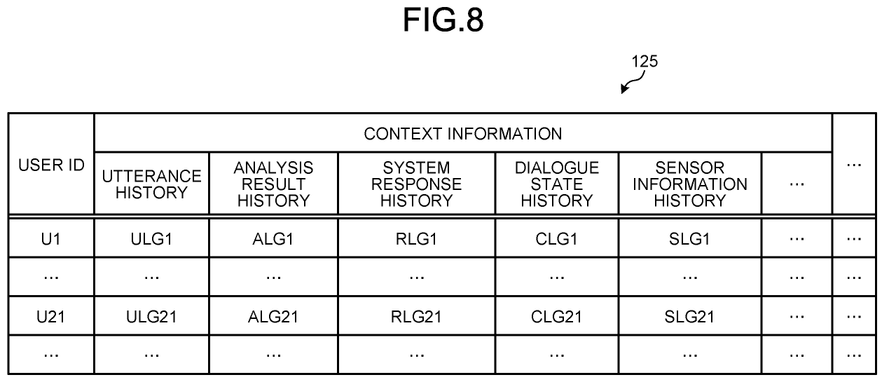

The context information storing unit 125 is used to store a variety of information regarding the context. The context information storing unit 125 is used to store a variety of information regarding the context corresponding to each user. Thus, the context information storing unit 125 is used to store a variety of information regarding the context collected for each user. FIG. 8 is a diagram illustrating an example of the context information storing unit according to the embodiment. In the context information storing unit 125 illustrated in FIG. 8, items such as “user ID” and “context information” are included. In the item “context information”, the following items are included: “utterance history”, “analysis result history”, “system response history”, “dialogue state history”, and “sensor information history”.

The item “user ID” represents identification information for enabling identification of the user. The item “user ID” represents identification information for enabling identification of the user for whom the context information is to be collected. For example, the item “user ID” represents identification information enabling identification of the user. In the item “context information”, a variety of context information to be used in calculating the certainty factors for each user is included.

The item “utterance history” indicates the information regarding the utterance history of the user who is identified by the concerned user ID. The item “utterance history” indicates the history information of the utterances that were detected before the latest utterance information regarding that user. Meanwhile, in the example illustrated in FIG. 8, the item “utterance history” is illustrated using the abstract reference numeral “ULG1”. Alternatively, in the item “utterance history”, a specific voice such as “if I can take some time off . . . ” or “tomorrow . . . ” can be included, or character information corresponding to that voice can be included.

The item “analysis result history” represents information related to the analysis result of the past utterances of the user who is identified by the concerned user ID. The item “analysis result history” indicates the history of the results of semantic analysis of the utterance information detected before the latest utterance information regarding that user. In the example illustrated in FIG. 8, the item “analysis result history” is illustrated using the abstract reference numeral “ALG1”. Alternatively, in the item “analysis result history”, history information extracted from an utterance such as “time off” can be included, or result history information of the past semantic analysis based on that history information can be included.

The item “system response history” represents information related to the response history of the dialogue system. The item “system response history” represents history information of the responses given by the dialogue system before the latest utterance information regarding the concerned user. In the example illustrated in FIG. 8, the item “system response history” is illustrated using the abstract reference numeral “RLG1”. Alternatively, in the item “system response history”, character information corresponding to a specific system response such as “tomorrow's weather . . . ” or “recommended spots around Tokyo railway station . . . ” can be included.

The item “dialogue state history” represents information related to the past dialogue states of the user who is identified by the concerned user ID. The item “dialogue state history” indicates the history of dialogue states selected based on the semantic analysis result of the past utterance information detected before the latest utterance information regarding that user. In the example illustrated in FIG. 8, the item “dialogue state history” is illustrated using the abstract reference numeral “CLG1”. Alternatively, in the item “dialogue state history”, for example, history information such as the domain goal name or the element ID that enables identification of a past dialogue state can be included.

The item “sensor information history” represents information related to the sensor information detected during the period of time corresponding to the point of time of each past utterance of the user who is identified by the concerned user ID. The item “sensor information history” indicates the sensor information detected at the date and time corresponding to each utterance made before the latest utterance information regarding that user. In the example illustrated in FIG. 8, the item “sensor information history” is illustrated using the abstract reference numeral “SLG1”. Alternatively, in the item “sensor information history”, for example, the history of sensor information such as acceleration information, temperature information, humidity information, position information, and pressure information detected in the past by various sensors can be included.

In the example illustrated in FIG. 8, in the context information collected for the user identified by the user ID “U1” (corresponding to the “user U1” illustrated in FIG. 1),

“ULG1” represents the utterance history. Moreover, in the context information collected for the user U1, “ALG1” represents the analysis result history. Furthermore, in the context information collected for the user U1, “RLG1” represents the system response history. Moreover, in the context information collected for the user U1, “CLG1” represents the dialogue state history. Furthermore, in the context information collected for the user U1, “SLG1” represents the sensor information history.

Meanwhile, the context information storing unit 125 is not limited to store the information explained above, and can be used to store a variety of other information according to the objective.

Returning to the explanation with reference to FIG. 3, the control unit 130 is implemented when a CPU (Central Processing Unit) or an MPU (Micro Processing Unit) executes programs stored in the information processing device 100 (for example, a decision program representing an information processing program according to the application concerned), using a RAM (Random Access Memory) as the work area.

Alternatively, the control unit 130 is a controller implemented using an integrated circuit such as an ASIC (Application Specific Integrated Circuit) or an FPGA (Field Programmable Gate Array).

As illustrated in FIG. 3, the control unit 130 includes an obtaining unit 131, an analyzing unit 132, a calculating unit 133, a deciding unit 134, a generating unit 135, and a sending unit 136; and implements or executes the functions and the actions of information processing explained below. However, the internal configuration of the control unit 130 is not limited to the configuration illustrated in FIG. 3, and it is possible to have some other configuration as long as the information processing explained below can be performed.

Moreover, the connection relationship among the processing units of the control unit 130 is not limited to the connection relationship illustrated in FIG. 3, and it is possible to have some other connection relationship.

The obtaining unit 131 obtains a variety of information. The obtaining unit 131 obtains a variety of information from external information processing devices. Thus, the obtaining unit 131 obtains a variety of information from the display device 10. Moreover, the obtaining unit 131 obtains a variety of information from other information processing devices such as a voice recognition server.

Furthermore, the obtaining unit 131 obtains a variety of information from the memory unit 120. Thus, the obtaining unit 131 obtains a variety of information from the element information storing unit 121, the calculation information storing unit 122, the target-dialogue-state information storing unit 123, the threshold value information storing unit 124, and the context information storing unit 125.

Moreover, the obtaining unit 131 obtains a variety of information analyzed by the analyzing unit 132. Furthermore, the obtaining unit 131 obtains a variety of information generated by the generating unit 135. Moreover, the obtaining unit 131 obtains a variety of information calculated by the calculating unit 133. Furthermore, the obtaining unit 131 obtains a variety of information decided by the deciding unit 134. Moreover, the obtaining unit 131 obtains a variety of information generated by the generating unit 135.

Furthermore, the obtaining unit 131 obtains the elements related to the dialogue state of the user of the dialogue system, and obtains the certainty factors of the elements. Moreover, the obtaining unit 131 obtains the threshold values to be used in deciding whether or not to treat the elements as the targets for highlighted display.

Furthermore, the obtaining unit 131 obtains correction information indicating the corrections made by the user with respect to the elements.

Moreover, the obtaining unit 131 obtains the certainty factors calculated by the calculating unit 133. Furthermore, the obtaining unit 131 obtains the first-type element indicating the dialogue state of the user, and obtains the first-type certainty factor indicating the certainty factor of the first-type element. Moreover, the obtaining unit 131 obtains the second-type elements representing the constituent elements of the first-type element, and obtains the second-type certainty factors indicating the certainty factors of the second-type elements. Thus, the obtaining unit 131 obtains the second-type elements belonging to the lower hierarchy of the first-type element, and obtains the second-type certainty factors.

Furthermore, the obtaining unit 131 obtains first-type correction information indicating the correction made by the user with respect to the first-type element. Then, the obtaining unit 131 obtains a new first-type certainty factor indicating the certainty factor of the new first-type element, and obtains new second-type certainty factors indicating the certainty factors of the new second-type elements. Moreover, the obtaining unit 131 obtains second-type correction information indicating the correction made by the user with respect to the second-type elements. Thus, the obtaining unit 131 obtains a particular element and obtains second-type elements including lower level elements belonging to the lower hierarchy of that particular element.

In the example illustrated in FIG. 1, the obtaining unit 131 obtains the utterance PA1 and the corresponding sensor information from the display device 10. Moreover, the obtaining unit 131 obtains the threshold value “0.8” from the threshold value information storing unit 124. Furthermore, the obtaining unit 131 obtains correction information indicating that the user U1 has corrected the slot value “Tokyo facility X” to the slot value “Tokyo facility Y”.

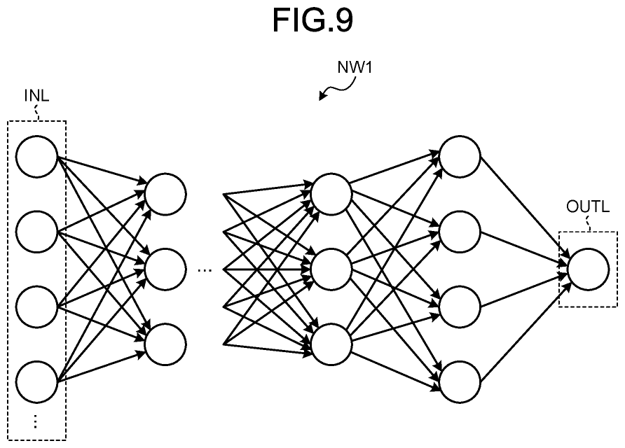

For example, the obtaining unit 131 can obtain a function meant for calculating the certainty factors. The obtaining unit 131 obtains a function meant for calculating the certainty factors either from an external information processing device that provides the function meant for calculating the certainty factors or from the memory unit 120. For example, the obtaining unit 131 obtains a model meant for calculating the certainty factors. For example, the obtaining unit 131 can obtain a function corresponding to Equation (1) given earlier. For example, the obtaining unit 131 obtains a certainty factor model (a certainty factor function) corresponding to a network NW1 illustrated in FIG. 9.

The analyzing unit 132 analyzes a variety of information. The analyzing unit 132 analyzes a variety of information based on the information that is received from external information processing devices and the information that is stored in the memory unit 120. The analyzing unit 132 analyzes a variety of information based on the information stored in the memory unit 120. Thus, the analyzing unit 132 analyzes a variety of information based on the information stored in the element information storing unit 121, the calculation information storing unit 122, the target-dialogue-state information storing unit 123, the threshold value information storing unit 124, and the context information storing unit 125. Moreover, the analyzing unit 132 identifies a variety of information. Furthermore, the analyzing unit 132 estimates a variety of information.

Moreover, the analyzing unit 132 extracts a variety of information. Furthermore, the analyzing unit 132 selects a variety of information. The analyzing unit 132 extracts a variety of information based on the information received from external information processing devices and the information stored in the memory unit 120. The analyzing unit 132 extracts a variety of information from the memory unit 120. The analyzing unit 132 extracts a variety of information from the element information storing unit 121, the calculation information storing unit 122, the target-dialogue-state information storing unit 123, the threshold value information storing unit 124, and the context information storing unit 125.

Moreover, the analyzing unit 132 extracts a variety of information based on a variety of information obtained by the obtaining unit 131. Furthermore, the analyzing unit 132 extracts a variety of information based on a variety of information calculated by the calculating unit 133. Moreover, the analyzing unit 132 extracts a variety of information based on a variety of information decided by the deciding unit 134. Furthermore, the analyzing unit 132 extracts a variety of information based on the information generated by the generating unit 135.

In the example illustrated in FIG. 1, the analyzing unit 132 implements a natural language processing technology such as morphological analysis to analyze the character information obtained by conversion of the voice information of the utterance PA1, and estimates (identifies) the contents of the utterance and the situation of the user. The analyzing unit 132 analyzes the utterance PA1 and the corresponding sensor information, and estimates the dialogue state of the user U1 corresponding to the utterance PA1. The analyzing unit 132 implements various conventional technologies and estimates the dialogue state of the user U1 corresponding to the utterance PA1. Moreover, the analyzing unit 132 analyzes the utterance PA1 by implementing various conventional technologies, and estimates the contents of the utterance PA1 of the user U1. For example, the analyzing unit 132 implements various conventional technologies to analyze the character information obtained by conversion of the utterance PA1 of the user U1, and estimates the contents of the utterance PA1 of the user U1. Moreover, the analyzing unit 132 extracts important keywords from the character information of the utterance PA1 of the user U1, and estimates the contents of the utterance PA1 of the user U1 based on the extracted keywords.

Thus, the analyzing unit 132 analyzes the utterance PA1, and identifies that the utterance PA1 of the user U1 is related to the outing destination on the next day. Then, based on the analysis result indicating that the utterance PA1 is related to the outing destination on the next day, the analyzing unit 132 estimates that dialogue state of the user U1 is related to the outing destination. Thus, the analyzing unit 132 estimates that “Outing-QA” related to the outing destination represents the domain goal indicating the dialogue state of the user U1. For example, the analyzing unit 132 compares the contents of the utterance PA1 and the determination condition of each domain goal stored in the element information storing unit 121, and determines the domain goal indicating the dialogue state of the user U1.

Moreover, the analyzing unit 132 analyzes the utterance PA1 and the corresponding sensor information, and estimates the slot value of each slot included in the domain goal “Outing-QA”. Then, based on the analysis result indicating that the utterance PA1 is related to the outing destination on the next day, the analyzing unit 132 estimates that the slot “date and time” has the slot value “tomorrow”; estimates that the slot “location” has the slot value “Tokyo”; and estimates that the slot “facility name” has the slot value “Tokyo facility X”. For example, based on the comparison of the extracted keywords extracted from the utterance PA1 of the user U1 with the slots; the analyzing unit 132 identifies, as the extracted keywords, the slot values of the slots corresponding to the extracted keywords.

The calculating unit 133 calculates a variety of information. For example, the calculating unit 133 calculates a variety of information based on the information received from external information processing devices and the information stored in the memory unit 120. Thus, the calculating unit 133 calculates a variety of information based on the information received from other information processing devices such as the display device 10 and a voice recognition server. The calculating unit 133 calculates a variety of information based on the information stored in the element information storing unit 121, the calculation information storing unit 122, the target-dialogue-state information storing unit 123, the threshold value information storing unit 124, and the context information storing unit 125.

Moreover, the calculating unit 133 calculates a variety of information based on a variety of information obtained by the obtaining unit 131. Furthermore, the calculating unit 133 calculates a variety of information based on a variety of information analyzed by the analyzing unit 132. Moreover, the calculating unit 133 calculates a variety of information based on a variety of information decided by the deciding unit 134. Furthermore, the calculating unit 133 calculates a variety of information based on a variety of information generated by the generating unit 135.

The calculating unit 133 calculates the certainty factors based on the information related to the dialogue system. Moreover, the calculating unit 133 calculates the certainty factors based on the information related to the user.

Furthermore, the calculating unit 133 calculates the certainty factors based on the utterance information of the user. Moreover, the calculating unit 133 calculates the certainty factors based on sensor information detected by predetermined sensors. The calculating unit 133 calculates the first-type certainty factor based on the first-type element. The calculating unit 133 calculates the second-type certainty factors of the second-type elements.

In the example illustrated in FIG. 1, the calculating unit 133 calculates the certainty factors of the elements related to the dialogue state of the user of the dialogue system. The calculating unit 133 calculates the certainty factor of the domain goal “Outing-QA” representing the dialogue state of the user U1 (i.e., calculates the first-type certainty factor). Moreover, the calculating unit 133 calculates the certainty factors of the slot values “tomorrow”, “Tokyo”, and “Tokyo facility X” that represent the second-type elements belonging to the lower hierarchy of the first-type element represented by the domain goal “Outing-QA” (i.e., calculates second-type certainty factors).

For example, the calculating unit 133 calculates the certainty factors of the domain goal and the slot values using Equation (1) given earlier. The calculating unit 133 calculates the certainty factor of the domain goal “Outing-QA” representing the first-type element (i.e., calculates the first-type certainty factor) to be equal to “0.78”. Moreover, the calculating unit 133 calculates the certainty factor of the slot value “tomorrow” representing a second-type element (i.e., calculates a second-type certainty factor) to be equal to “0.84”. Furthermore, the calculating unit 133 calculates the certainty factor of the slot value “Tokyo” representing a second-type element (i.e., calculates a second-type certainty factor) to be equal to “0.9”. Moreover, the calculating unit 133 calculates the certainty factor of the slot value “Tokyo facility X” representing a second-type element (i.e., calculates a second-type certainty factor) to be equal to “0.65”.

The deciding unit 134 decides on a variety of information. For example, the deciding unit 134 decides on a variety of information based on the information received from external information processing devices and the information stored in the memory unit 120. Moreover, the deciding unit 134 decides on a variety of information based on the information received from other information processing devices such as the display device 10 and the voice recognition server. The deciding unit 134 decides on a variety of information based on the information stored in the element information storing unit 121, the calculation information storing unit 122, the target-dialogue-state information storing unit 123, the threshold value information storing unit 124, and the context information storing unit 125.

Moreover, the deciding unit 134 decides on a variety of information based on a variety of information obtained by the obtaining unit 131. Furthermore, the deciding unit 134 decides on a variety of information based on a variety of information analyzed by the analyzing unit 132. Moreover, the deciding unit 134 decides on a variety of information based on a variety of information calculated by the calculating unit 133.

Furthermore, the deciding unit 134 decides on a variety of information based on a variety of information generated by the generating unit 135. Moreover, the deciding unit 134 changes a variety of information based on the taken decisions.

Furthermore, the deciding unit 134 updates a variety of information based on the information obtained by the obtaining unit 131.

According to the certainty factors obtained by the obtaining unit 131, the deciding unit 134 decides on whether or not to treat an element as the target for highlighted display. Based on the comparison between the certainty factor and the threshold value, the deciding unit 134 decides on whether or not to treat the concerned element as the target for highlighted display. If the certainty factor is smaller than the threshold value, then the deciding unit 134 decides to treat the concerned element as the target for highlighted display.

The deciding unit 134 changes a particular element to a new element based on the correction information obtained by the obtaining unit 131. Thus, based on the correction information obtained by the obtaining unit 131, the deciding unit 134 decides on the modification target from among the other elements other than the particular element.

According to the first-type certainty factor, the deciding unit 134 decides on whether or not to treat the first-type element as the target for highlighted display. Moreover, according to each second-type certainty factor, the deciding unit 134 decides on whether or not to treat the concerned second-type element as the target for highlighted display.

The deciding unit 134 changes the first-type element to a new first-type element based on the first-type correction information obtained by the obtaining unit 131, and changes the second-type elements to new second-type elements that correspond to the new first-type element. According to the new first-type certainty factor, the deciding unit 134 decides on whether or not to treat the first-type element as the target for highlighted display. Similarly, according to each new second-type certainty factor, the deciding unit 134 decides on whether or not to treat the corresponding second-type element as the target for highlighted display. Moreover, the deciding unit 134 modifies the second-type elements to new second-type elements based on the second-type correction information obtained by the obtaining unit 131. Thus, according to the change of a particular element, the deciding unit 134 decides on whether or not to change the lower-level elements.

In the example illustrated in FIG. 1, the deciding unit 134 decides on the targets for highlighted display (also called the “highlighting targets”) based on the calculated certainty factors of the elements. Since the certainty factor of “0.78” of the domain goal “Outing-QA” is smaller than the threshold value “0.8”, the deciding unit 134 decides to treat the domain goal “Outing-QA” as the highlighting target. However, since the certainty factor “0.84” of the slot value “tomorrow” is equal to or greater than the threshold value “0.8”, the deciding unit 134 decides not to treat the slot value “tomorrow” as the highlighting target. Moreover, since the certainty factor “0.9” of the slot value “Tokyo” is equal to or greater than the threshold value “0.8”, the deciding unit 134 decides not to treat the slot value “Tokyo” as the highlighting target. On the other hand, since the certainty factor of “0.65” of the slot value “Tokyo facility X” is smaller than the threshold value “0.8”, the deciding unit 134 decides to treat the slot value “Tokyo facility X” as the highlighting target. Thus, the deciding unit 134 decides to treat the two elements having low certainty factors, namely, the domain goal “Outing-QA” and the slot value “Tokyo facility X” as the highlighting targets.

Meanwhile, if the correction information indicating that the user U1 has corrected the slot value “Tokyo facility X” to the slot value “Tokyo facility Y” is obtained by the obtaining unit 131; then the deciding unit 134 changes the slot value of the slot “facility name” of the domain goal “Outing-QA”, which corresponds to the dialogue state of the user U1 (the dialogue state #1), to the slot value “Tokyo facility Y”.

The generating unit 135 generates a variety of information. The generating unit 135 generates a variety of information based on the information received from external information processing devices and the information stored in the memory unit 120. Thus, the generating unit 135 generates a variety of information based on the information received from other information processing devices such as the display device 10 and a voice recognition server. Moreover, the generating unit 135 generates a variety of information based on the information stored in the element information storing unit 121, the calculation information storing unit 122, the target-dialogue-state information storing unit 123, the threshold value information storing unit 124, and the context information storing unit 125.

Furthermore, the generating unit 135 generates a variety of information based on a variety of information obtained by the obtaining unit 131. Moreover, the generating unit 135 generates a variety of information based on a variety of information analyzed by the analyzing unit 132. Furthermore, the generating unit 135 generates a variety of information based on a variety of information calculated by the calculating unit 133. Moreover, the generating unit 135 generates a variety of information based on a variety of information decided by the deciding unit 134.

The generating unit 135 implements various technologies and generates a variety of information such as screens (image information) to be provided to external information processing devices. Thus, the generating unit 135 generates screens (image information) to be provided to the display device 10. For example, based on the information stored in the memory unit 120, the generating unit 135 generates screens (image information) to be provided to the display device 10.

As long as it is possible to generate screens (image information) to be provided to external information processing devices, the generating unit 135 can perform any type of operations for generating screens (image information). For example, the generating unit 135 implements various technologies related to image generation and image processing, and generates screens (image information) to be provided to the display device 10. For example, the generating unit 135 uses various technologies such as Java (registered trademark), and generates screens (image information) to be provided to the display device 10. Meanwhile, the generating unit 135 can generate screens (image information), which are to be provided to the display device 10, based on the CSS format, or the JavaScript (registered trademark) format, or the HTML format. Moreover, for example, the generating unit 135 can generate screens (image information), which are to be provided to the display device 10, in various formats such as the JPEG (Joint Photographic Experts Group) format, or the GIF (Graphics Interchange Format), or the PNG (Portable Network Graphics) format.

In the example illustrated in FIG. 1, the generating unit 135 generates the image IM1 in which the domain goal D1, which represents the domain goal “Outing-QA”, and the slot value D1-V3, which represents the slot value “Tokyo facility X” are highlighted. Herein, the generating unit 135 generates the image IM1 that includes the domain goal D1, the slot D1-S1 representing the slot “tomorrow”, the slot D1-S2 representing the slot “location”, and the slot D1-S3 representing the slot “facility name”. Moreover, the generating unit 135 generates the image IM1 that includes the slot value D1-V1 representing the slot value “tomorrow”, the slot value D1-V2 representing the slot value “Tokyo”, and the slot value D1-V3.

The generating unit 135 generates the image IM1 in which the character string “Outing-QA” of the domain goal D1 and the character string “Tokyo Facility X” of the slot value D1-V3 are underlined. Moreover, the generating unit 135 generates the image IM1 in which the character string “Outing-QA” of the domain goal D1 and the character string “Tokyo Facility X” of the slot value D1-V3 are correctible by the user. For example, when the user specifies the area in which the character string “Outing-QA” of the domain goal D1 or the character string “Tokyo Facility X” of the slot value D1-V3 is displayed, the generating unit 135 generates the image IM1 in which a new domain goal or a new slot value can be input.

For example, the generating unit 135 can generate a function meant for calculating the certainty factors. For example, the generating unit 135 generates a model meant for calculating the certainty factors. For example, the generating unit 135 can generate a function corresponding to Equation (1) given earlier. For example, the generating unit 135 generates a certainty factor model (a certainty factor function) corresponding to the network NW1 illustrated in FIG. 9.

The sending unit 136 provides a variety of information to external information processing devices. Thus, the sending unit 136 sends a variety of information to external information processing devices. For example, the sensing unit 136 sends a variety of information to other information processing devices such as the display device 10 and a voice recognition server.

The sending unit 136 provides the information stored in the memory unit 120. Thus, the sending unit 136 sends the information stored in the memory unit 120.

The sending unit 136 provides a variety of information based on the information received from other information processing devices such as the display device 10 and a voice recognition server. Moreover, the sending unit 136 provides a variety of information based on the information stored in the memory unit 120. Thus, the sending unit 136 provides a variety of information based on the information stored in the element information storing unit 121, the calculation information storing unit 122, the target-dialogue-state information storing unit 123, the threshold value information storing unit 124, and the context information storing unit 125.

In the example illustrated in FIG. 1, the sending unit 136 sends, to the display device 10, the image IM1 in which the character string “Outing-QA” of the domain goal D1 and the character string “Tokyo Facility X” of the slot value D1-V3 are underlined.

[1-4. Certainty Factor, Complementation]

Given below is the detailed explanation about the certainty factors and complementation of information. The information processing device 100 calculates the certainty factor of each element using a variety of information such as Equation (1) given earlier.

For example, the information that has been complemented by the dialogue system is estimated to have a low certainty factor. On the other hand, for example, the information coming from (included in) an utterance of the user is estimated to have a high certainty factor on account of the fact that the information was spoken directly by the user. Moreover, the information at the latest timing is estimated to have a higher certainty factor than older information. On the other hand, the information that is estimated by the system from the sensor information and the context is estimated to have a low certainty factor.

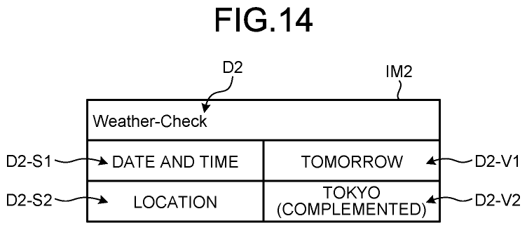

For that reason, the information processing device 100 calculates the certainty factors in such a way that the information complemented by the dialogue system has a low certainty factor. For example, the information processing device 100 calculates the certainty factors in such a way that the elements complemented by the dialogue system, such as the slot value “Tokyo” represented by a slot value D2-V2 in FIG. 14, has a low certainty factor.

Meanwhile, among the information included in the user utterance, the words having polysemy are estimated to have a low certainty factor. For example, among the information included in the user utterance, the words having a low certainty factor are highlighted. For example, the information processing device 100 calculates the certainty factors in such a way that, from among the elements including the domain goal and the slot values, the elements having polysemy have low certainty factors. For example, if the user utters “show me the XXX” and if the word “XXX” covers a plurality of targets, then it is difficult to determine the target for which the utterance was made. For example, if the user utters “show me the XXX” and if the word “XXX” indicates a song as well as a food item, then it is not possible to determine whether the user is talking about music or recipe. In such a case, the information processing device 100 performs certainty factor calculation in such a way that the domain goal and the slot values have low certainty factors.

Meanwhile, in response to an output of “which movie would you watch?” from the dialogue system, if the user utters “YYY” and if the word “YYY” covers a plurality of targets, then it is difficult to determine the target for which the utterance was made. If the user utters “YYY” and if the word “YYY” points to a facility or a place as well as points to a movie, then it is not possible to determine whether the user is talking about the outing destination or the movie. In such a case, the information processing device 100 performs certainty factor calculation in such a way that the domain goal and the slot values have low certainty factors.

In the information processing device 100, the information that cannot be complemented without user utterance is visualized as a blank space, and the user can be prompted to perform an input (correction) or make an utterance. For example, in order to perform a particular task, if the types of the required slots are set in advance, then the information processing device 100 can visualize such information as blank spaces and can prompt the user to make an utterance.

Meanwhile, the information processing device 100 is not limited to use only Equation (1) given above, and can use various functions meant for calculating the certainty factors. For example, the information processing device 100 can use a model (a certainty factor calculation function) of an arbitrary format such as a regression model, such as an SVM (Support Vector Machine), or a neural network. Alternatively, the information processing device 100 can use various types of regression models such as a nonlinear regression model or a linear regression model.

Regarding this point, an example of the function for certainty factor calculation is explained with reference to FIG. 9. FIG. 9 is a diagram illustrating an exemplary network corresponding to a certainty factor calculation function. Thus, FIG. 9 is a conceptual diagram illustrating an example of the certainty factor calculation function. The network NW1 represents a neural network that includes a plurality of (multiple) intermediate layers between an input layer INL and an output layer OUTL. For example, the information processing device 100 can calculate the certainty factor of each element using a function corresponding to the network NW1 illustrated in FIG. 9.

The network NW1 illustrated in FIG. 9 corresponds to a function for calculating the certainty factors and is a conceptual rendering in which the function for calculating the certainty factors is expressed as a neural network (model). For example, the input layer INL of the network NW1 includes network elements (neurons) corresponding to “x₁” to “x₁₁” in Equation (1) given earlier. For example, the input layer INL includes 11 neurons. The output layer OUTL of the network NW1 includes a network element (neuron) corresponding to “y” in Equation (1) given above. For example, the output layer OUTL includes a single neuron.

In the case of calculating a certainty factor using a function such as the network NW1, the information processing device 100 inputs information in the input layer INL of the network NW1, so that the certainty factor corresponding to the input is output from the output layer OUTL. Using the network NW1, the information processing device 100 can calculate the certainty factor for the element input to the neuron corresponding to “x₁” in Equation (1) given earlier. Thus, for example, the information processing device 100 performs a predetermined input to the function corresponding to the network NW1, and calculates the certainty factor for a predetermined element.

Meanwhile, Equation (1) given earlier or the network NW1 illustrated in FIG. 9 are only examples of the certainty factor calculation function. That is, when information related to a dialogue system corresponding to a particular dialogue state is input, as long as the certainty factor of each element of that dialogue state can be calculated, any function can be used. For example, in the example illustrated in FIG. 9, for ease of explanation, only one certainty factor is output. However, the certainty factor calculation function can output the certainty factors for a plurality of elements.

Meanwhile, the information processing device 100 can perform a learning operation based on various learning methods, and can generate a certainty factor model (a certainty factor function) corresponding to the network NW1 illustrated in FIG. 9. The information processing device 100 can perform a learning operation based on a method related to machine learning, and can generate a certainty factor model (a certainty factor function). Meanwhile, the explanation given above is only exemplary and, as long as a certainty factor model (a certainty factor function) corresponding to the network NW1 illustrated in FIG. 9 can be generated, the information processing device 100 can implement any learning method for generating a certainty factor model (a certainty factor function).

[1-5. Configuration of Display Device According to Embodiment]

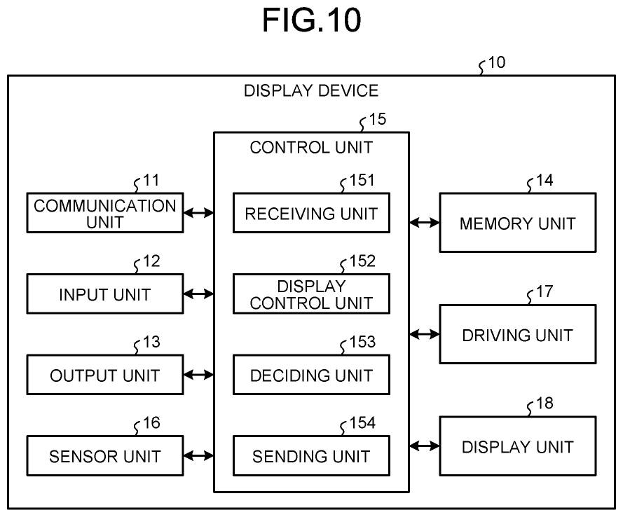

Given below is the explanation of a configuration of the display device 10 representing an example of the information processing device that performs information processing according to the embodiment. FIG. 10 is a diagram illustrating an exemplary configuration of the display device according to the embodiment of the application concerned.

As illustrated in FIG. 10, the display device 10 includes a communication unit 11, an input unit 12, an output unit 13, a memory unit 14, a control unit 15, a sensor unit 16, a driving unit 17, and the display unit 18.

The communication unit 11 is implemented using, for example, an NIC or a communication circuit. The communication unit 11 is connected to the network N (such as the Internet) in a wired manner or a wireless manner, and sends information to and receives information from other devices such as the information processing device 100.

The input unit 12 receives input of various operations from the user. Thus, the input unit 12 receives the user input. Moreover, the input unit 12 receives corrections made by the user. That is, the input unit 12 receives corrections made by the user with respect to the information displayed in the display unit 18. The input unit 12 has the function of detecting sounds. For example, the input unit 12 includes a microphone for detecting sounds. Hence, the input unit 12 receives a user utterance as the input. In the example illustrated in FIG. 1, the input unit 12 receives the utterance PA1 of the user U1. The input unit 12 receives the utterance PA1 of the user U1 according to the detection performed by the sensor unit 16 that includes a sound sensor.

The input unit 12 receives corrections made by the user. In the example illustrated in FIG. 1, the input unit 12 receives a correction made by the user U1 with respect to the domain goal “Outing-QA” or the slot value “Tokyo facility X” displayed in a highlighted manner in the display unit 18. For example, in response to a touch by the user U1 in the area in which a highlighting target (element) such as the domain goal “Outing-QA” or the slot value “Tokyo facility X” is displayed, the input unit 12 receives input of the user regarding the touched element.

For example, on account of the functions of a touch-sensitive panel that is implemented using the various sensors included in the sensor unit 16, the input unit 12 receives various operations from the user via a display screen. That is, the input unit 12 receives various operations from the user via the display unit 18 of the display device 10. For example, the input unit 12 receives operations such as a specification operation from the user via the display unit 18 of the display device 10. In other words, the input unit 12 functions as a receiving unit for receiving operations from the user on account of the functions of the touch-sensitive panel. Meanwhile, as the detection method by which the input unit 12 detects the user operations, mainly the static capacitance method is used in a tablet terminal. However, alternatively, as long as the user operations can be detected and the functions of a touch-sensitive panel can be implemented, any other detection method such as a resistance film method, a surface elastic wave method, an infrared method, or an electromagnetic induction method can be used. If the display device 10 has buttons installed thereon or has a keyboard or a mouse connected thereto, then the display device 10 can include an input unit that also receives operations performed using the buttons.

The output unit 13 outputs a variety of information. The output unit 13 has the function of outputting sounds. For example, the output unit 13 includes a speaker for outputting sounds. The output unit 13 outputs responses to the utterances made by the user. Moreover, the output unit 13 outputs questions. The output unit 13 outputs questions when a user is detected by the sensor unit 16. Furthermore, the output unit 13 outputs responses that are decided by a deciding unit 153. Moreover, the output unit 13 outputs a sound to request the user to make an utterance. In the example illustrated in FIG. 1, the output unit 13 outputs a response to the utterance PA1 of the user U1. The output unit 13 outputs the response that is decided by the deciding unit 153.

The memory unit 14 is implemented using a semiconductor a memory device such as a RAM or a flash memory, or using a memory device such as a hard disk or an optical disk. The memory unit 14 is used to store a variety of information that is used in displaying information.

Returning to the explanation with reference to FIG. 10, the control unit 15 is implemented when a CPU or an MPU executes programs stored in the display device 10 (for example, a display program representing an information processing program according to the application concerned), using the RAM as the work area. Alternatively, the control unit 15 is a controller implemented using an integrated circuit such as an ASIC or an FPGA.

As illustrated in FIG. 10, the control unit 15 includes a receiving unit 151, a display control unit 152, the deciding unit 153, and a sending unit 154; and implements or executes the functions and the actions of information processing explained below. The internal configuration of the control unit 15 is not limited to the configuration illustrated in FIG. 10, and can have some other configuration as long as the information processing explained below can be performed.

The receiving unit 151 receives a variety of information. The receiving unit 151 receives a variety of information from external information processing devices. Thus, the receiving unit 151 receives a variety of information from other information processing devices such as the information processing device 100 and a voice recognition server.

The receiving unit 151 receives the highlighting/no highlighting information indicating whether or not the elements related to the contents of an utterance of the user of the dialogue system are the targets for highlighted display. In the example illustrated in FIG. 1, the receiving unit 151 receives the image IM1 in which the character string “Outing-QA” of the domain goal D1 and the character string “Tokyo Facility X” of the slot value D1-V3 are underlined. Thus, for example, the receiving unit 151 can receive the highlighting/no highlighting information indicating that the domain goal D1 and the slot value D1-V3 are the targets for highlighted display. In this case, the receiving unit 151 receives an image (also called a “no-highlighting screen”) that includes the domain goal D1, the slots D1-S1 to D1-S3, and the slot values D1-V1 to D1-V3 in a non-highlighted form.

The display control unit 152 controls a variety of display. The display control unit 152 controls the display in the display unit 18. The display control unit 152 controls the display in the display unit 18 according to the reception in the receiving unit 151. Thus, the display control unit 152 controls the display in the display unit 18 based on the information received by the receiving unit 151. Moreover, the display control unit 152 controls the display in the display unit 18 based on the information decided by the deciding unit 153. Thus, the display control unit 152 controls the display in the display unit 18 according to the decisions made by the deciding unit 153. The display control unit 152 controls the display in the display unit 18 in such a way that the image IM1 is displayed therein.

The deciding unit 153 decides on a variety of information. For example, the deciding unit 153 decides on a variety of information based on the information received from external information processing devices and the information stored in the memory unit 14. Thus, the deciding unit 153 decides on a variety of information based on the information received from other information processing devices such as the information processing device 100 and a voice recognition server. Moreover, the deciding unit 153 decides on a variety of information based on the information received by the receiving unit 151. In response to the reception of the image IM1 by the receiving unit 151, the deciding unit 153 decides to display the image IM1 in the display unit 18. Moreover, the deciding unit 153 decides on responses. Thus, the deciding unit 153 decides on a response to the utterance PA1 of the user U1.

The sending unit 154 sends a variety of information to external information processing devices. For example, the sending unit 154 sends a variety of information to other information processing devices such as the display device 10 and a voice recognition server. Moreover, the sending unit 154 sends the information stored in the memory unit 14.

Furthermore, the sending unit 154 sends a variety of information based on the information received from other information processing devices such as the display device 10 and a voice recognition server. Moreover, the sending unit 154 sends a variety of information based on the information stored in the memory unit 14.

The sending unit 154 sends the detected sensor information to the information processing device 100. In the example illustrated in FIG. 1, the sending unit 154 sends the sensor information corresponding to the point of time of the utterance PA1 to the information processing device 100. For example, to the information processing device 100, the sending unit 154 sends, in a corresponding manner to the utterance PA1, a variety of sensor information such as position information, acceleration information, and image information detected within the period of time corresponding to the point of time of the utterance PA1 (for example, within one minute from the point of time of the utterance PA1). For example, the sending unit 154 sends, to the information processing device 100, sensor information corresponding to the point of time of the utterance PA1, along with the utterance PA1.

The sensor unit 16 detects a variety of sensor information. The sensor unit 16 has the function of an imaging unit for taking images. Moreover, the sensor unit 16 has the function of an image sensor, and detects image information. Furthermore, the sensor unit 16 functions as an image input unit that receives images as input. Meanwhile, the sensor unit 16 is not limited to the explanation given above, and can include various types of sensors. The sensor unit 16 can include various types of sensors such as a position sensor, an acceleration sensor, a gyro sensor, a temperature sensor, a humidity sensor, an illumination sensor, a proximity sensor, and a sensor for obtaining biological information such as body odor, sweating, heart rate, pulse, and brain waves. In the sensor unit 16, the sensors for detecting the abovementioned variety of information can be implemented either using a common sensor or using different sensors.

The driving unit 17 has the function of driving the physical configuration in the display device 10. For example, if the display device 10 is a robot, then the driving unit 17 has the function of driving the joints such as the neck, the arms, and the legs of the display device 10. The driving unit 17 is, for example, an actuator or an encoder-equipped motor. As long as the desired actions of the display device 10 can be implemented, the driving unit 17 can have any configuration. Moreover, as long as the joints of the display device 10 can be driven and the display device 10 can be moved, the driving unit 17 can have any configuration. If the display device 10 has a movement mechanism such as a caterpillar or tires, then the driving unit 17 drives the caterpillar or the tires. The driving unit 17 drives the neck joint of the display device 10 and changes the viewpoint of the camera installed in the head region of the display device 10. For example, in order to take images in the direction decided by the deciding unit 153, the driving unit 17 can drive the neck joint of the display device 10 and change the viewpoint of the camera installed in the head region of the display device 10. Alternatively, the driving unit 17 can be configured to change only the camera orientation and the imaging range. Still alternatively, the driving unit 17 can be configured to change the viewpoint of the camera.

Meanwhile, the display device 10 need not include the driving unit 17. For example, if the display device 10 is a mobile terminal such as a smartphone in possession of the user, it need not include the driving unit 17.

The display unit 18 is installed in the display device 10 and displays a variety of information. The display unit 18 is implemented using, for example, a liquid crystal display or an organic EL (Electro-Luminescence) display. As long as the information provided from the information processing device 100 can be displayed, the display unit 18 can be implemented according to any method. The display unit 18 displays a variety of information under the control of the display control unit 152.

Based on the highlighting/no highlighting information received from the receiving unit 151, if an element is the target for highlighted display, then that element is displayed in a highlighted manner in the display unit 18. In the display unit 18, the image IM1 is displayed in which the character string “Outing-QA” of the domain goal D1 and the character string “Tokyo Facility X” of the slot value D1-V3 are underlined. Herein, based on the highlighting/no highlighting information that is received by the receiving unit 151 and that indicates the domain goal D1 and the slot value D1-V3 to be the targets for highlighted display, the display unit 18 can be used to display the domain goal D1 and the slot value D1-V3 in a highlighted manner in a no-highlighting screen.

[1-6. Sequence of Information Processing According to Embodiment]

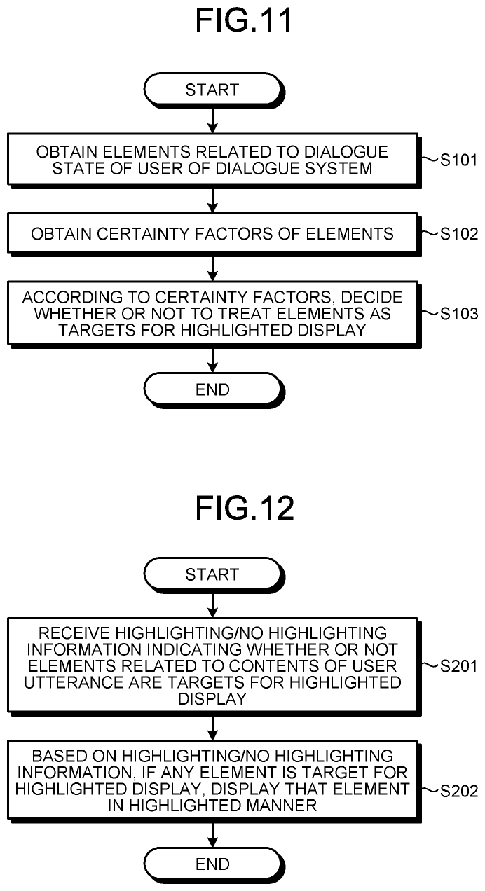

Explained below with reference to FIGS. 11 to 13 is the sequence of a variety of information processing performed according to the embodiment.

[1-6-1. Sequence of Decision Operation According to Embodiment]

Firstly, explained below with reference to FIG. 11 is the flow of the decision operation performed according to the embodiment of the application concerned. FIG. 11 is a flowchart for explaining the sequence of information processing performed according to the embodiment of the application concerned. More particularly, FIG. 11 is a flowchart for explaining the sequence of the decision operation performed by the information processing device 100.

As illustrated in FIG. 11, the information processing device 100 obtains the elements related to the dialogue state of the user of a dialogue system (Step S101). For example, the information processing device 100 obtains information indicating the domain goal and the slot values.

Then, the information processing device 100 obtains the certainty factors of the elements (Step S102). For example, the information processing device 100 calculates the certainty factors of the elements.

Subsequently, according to each certainty factor, the information processing device 100 decides whether or not to treat the corresponding element as the target for highlighted display (Step S103). For example, the information processing device 100 compares the certainty factor of each element with a threshold value, and determines whether or not to treat that element as the target for highlighted display.

[1-6-2. Sequence of Display Operation According to Embodiment]

Explained below with reference to FIG. 12 is the flow of the decision operation performed according to the embodiment of the application concerned. FIG. 12 is a flowchart for explaining the sequence of information processing performed according to the embodiment of the application concerned. More particularly, FIG. 12 is a flowchart for explaining the sequence of the display operation performed by the display device 10.

As illustrated in FIG. 12, the display device 10 receives the highlighting/no highlighting information indicating whether or not an element related to the contents of a user utterance is the target for highlighted display (Step S201). For example, the display device 10 receives a screen in which the targets for highlighted display are highlighted.

Based on the highlighting/no highlighting information, if an element is the target for highlighted display, then the display device 10 displays that element in a highlighted manner (Step S202). For example, the display device 10 displays a screen in which the targets for highlighted display are highlighted.

[1-6-3. Sequence of Processing of Dialogue with User According to Embodiment]

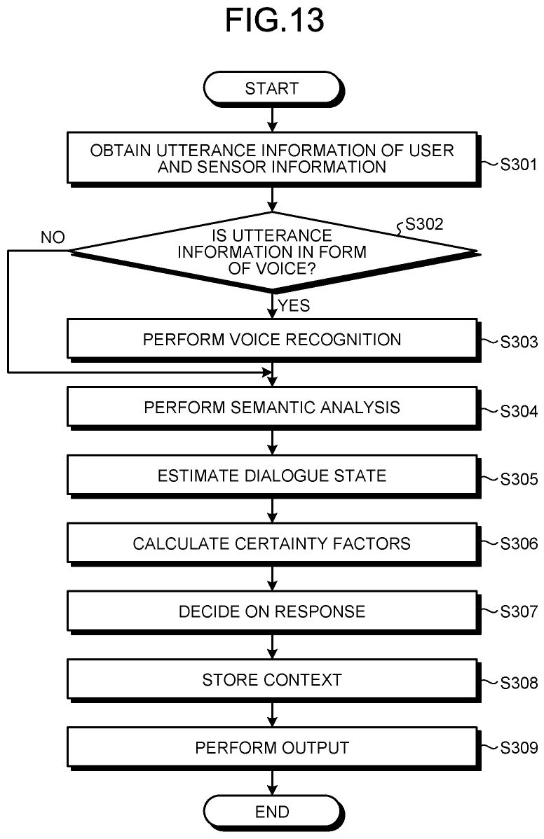

Explained below with reference to FIG. 13 is a detailed flow of the processing of a dialogue with the user according to the embodiment of the application concerned. FIG. 13 is a flowchart for explaining the sequence of a dialogue with the user according to the embodiment of the application concerned. More particularly, FIG. 13 is a flowchart for explaining the sequence of a dialogue made by the information processing system 1 with the user. Herein, the operation performed at each step can be performed by any device included in the information processing system 1, such as either by the information processing device 100 or by the display device 10.

As illustrated in FIG. 13, the information processing system 1 obtains utterance information of the user and sensor information (Step S301). Then, the information processing system 1 determines whether or not the utterance information is in the form of a voice (Step S302). If it is determined that the utterance information is not in the form of a voice (No at Step S302), then the information processing system 1 skips the operation at Step S303 and performs the operation at Step S304.

On the other hand, if it is determined that the utterance information is in the form of a voice (Yes at Step S302), then the information processing system 1 performs a voice recognition operation (Step S303).

Subsequently, the information processing system 1 performs semantic analysis (Step S304). The information processing system 1 performs semantic analysis by analyzing the utterance information and the voice recognition result. For example, the information processing system 1 performs semantic analysis of the utterance information and estimates the contents of the utterance. For example, the information processing system 1 extracts candidates having interpretable meaning from the uttered sentence (utterance information) obtained at Step S301. For example, the information processing system 1 extracts N number of candidates for the domain goal (where N is an arbitrary value) and extracts a list of slots of each candidate for the domain goal.

Then, the information processing system 1 estimates the dialogue state (Step S305). For example, from among the candidates for the domain goal that are extracted at Step S304, the information processing system 1 selects one domain goal by taking into account the context. Moreover, for example, the information processing system 1 estimates the value of the selected domain goal and the slot values of the slots included in that domain goal. Then, the information processing system 1 calculates the certainty factors (Step S306). For example, the information processing system calculates the certainty factors of the domain goal and the slot values corresponding to the estimated dialogue state.

Then, the information processing system 1 decides on the response (Step S307). For example, the information processing system 1 decides on the response (utterance) to be output with respect to the user utterance. Moreover, for example, the information processing system 1 decides on the highlighting targets from among the targets to be displayed, and decides on the screen display.

Furthermore, the information processing system 1 stores the context (Step S308). For example, the information processing system 1 stores context information in the context information storing unit 125 (see FIG. 8). For example, the information processing system 1 stores, in the context information storing unit 125 (see FIG. 8), the context information in a corresponding manner to the user from which the context is obtained. For example, the information processing system 1 stores a variety of information such as the user utterance, the semantic analysis result, the sensor information, the system response information as the context information.

Subsequently, the information processing system 1 performs the output (Step S309). For example, the information processing system 1 outputs the response decided at Step S307. The information processing system 1 outputs the response in the form of a voice to the user. Alternatively, for example, the information processing system 1 displays a screen in which the decided highlighting targets are highlighted.

[1-7. Display of Information of Dialogue State]

In the example illustrated in FIG. 1, the image IM1 is only exemplary. That is, the information displayed in the display unit 18 is not limited to the image IM1, and can be displayed in various forms. For example, the information complemented by the dialogue system can be displayed in a distinguishable manner from the other information.

That point is explained below with reference to FIG. 14. FIG. 14 is a diagram illustrating an example of the display of information.

In the example illustrated in FIG. 14, the information processing device 100 estimates that “Weather-Check” related to the confirmation of the weather represents the domain goal indicating the dialogue state of the user. For example, according to a character string “tomorrow” included in the user utterance, the information processing device 100 estimates “tomorrow” as the slot value of the slot “date and time” corresponding to the domain goal “Weather-Check”. Moreover, if the character string “Tokyo” is not included in the user utterance, the information processing device 100 uses the context information of the user and, according to the slot value “Tokyo” predicted for the slot “location”, complements the slot value with “Tokyo”.

Then, the information processing device 100 generates an image IM2 that includes a domain goal D2 representing the domain goal “Weather-Check”, a slot D2-S1 representing the slot “date and time”, and a slot D2-S2 representing the slot “location”. Thus, the information processing device 100 generates the image IM2 that includes a slot value D2-V1 representing the slot value “tomorrow” and includes the slot value D2-V2 representing the slot value “Tokyo”. Moreover, the information processing device 100 generates the image IM2 in which information indicating that the slot value “Tokyo” represents the complemented information is assigned to the slot value D2-V2. Thus, the information processing device 100 adds a character string “(complemented)” to the character string “Tokyo”, and generates the image IM2 that explicitly indicates that the slot value “Tokyo” represents the complemented information.

The information processing device 100 sends the image IM2 to the display device 10. Upon receiving it, the display device 10 displays the image IM2. Thus, the display device 10 displays the image IM2 in which the slot value “Tokyo”, which represents the complemented information, is illustrated in a distinguishable manner from the other information.

[1-8. Information Correction Operation]

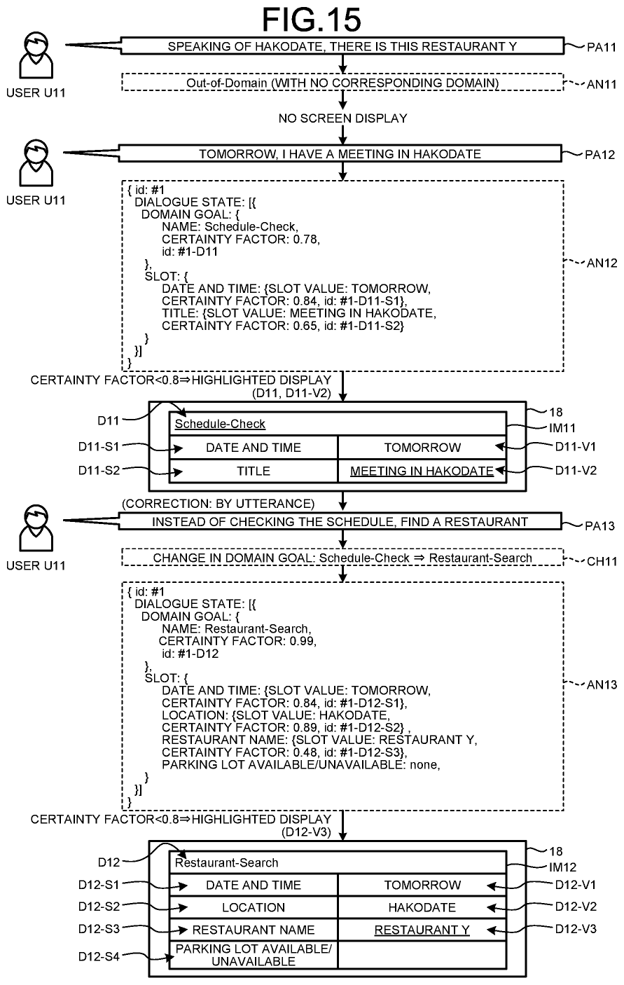

Given below is the detailed explanation about the operations related to the correction of information. Firstly, explained below with reference to FIG. 15 are the operations performed in the information processing device 100 based on the corrections made by the user. FIG. 15 is a diagram illustrating an example of the correction operation performed according to the embodiment of the application concerned.

Firstly, with reference to FIG. 15, a user U11 makes an utterance. For example, around the display device 10 used by the user U11, the user U11 makes an utterance PA11 saying “speaking of Hakodate, there is this restaurant Y”. Then, the display device 10 uses a sound sensor and detects voice information of the utterance PA11 (also simply referred to as the “utterance PA11”) indicating “speaking of Hakodate, there is this restaurant Y”. As a result, the display device 10 detects the utterance PA11, which indicates “speaking of Hakodate, there is this restaurant Y”, as the input. Moreover, the display device 10 detects a variety of sensor information such as position information, acceleration information, and image information. Then, the display device 10 sends, to the information processing device 100, the corresponding sensor information, which corresponds to the point of time of the utterance PA11, along with the utterance PA11.

Thus, the information processing device 100 obtains the utterance PA11 and the corresponding sensor information from the display device 10. Then, the information processing device 100 analyzes the utterance PA11 and the corresponding sensor information, and estimates the dialogue state of the user U11 corresponding to the utterance PA11. The information processing device 100 implements various conventional technologies and estimates the dialogue state of the user U11 corresponding to the utterance PA11. As a result of analyzing the utterance PA11, as illustrated in an analysis result AN11 in FIG. 15, the information processing device 100 estimates that there is no domain goal corresponding to the dialogue state of the user U11 (i.e., there is no corresponding domain). Thus, the information processing device 100 estimates that the dialogue state of the user U11 is Out-of-Domain (i.e., with no corresponding domain).

In this way, since the dialogue state of the user U11 is Out-of-Domain (i.e., with no corresponding domain) and since there is no target for calculating the certainty factor, the information processing device 100 decides that no screen would be displayed.

Subsequently, with reference to FIG. 15, the user U11 follows the utterance PA11 with another utterance. For example, around the display device 10 used by the user U11, the user U11 makes an utterance PA12 saying “tomorrow, I have a meeting in Hakodate”. Then, the display device 10 uses a sound sensor and detects voice information of the utterance PA12 (also simply referred to as the “utterance PA12”) indicating “tomorrow, I have a meeting in Hakodate”. As a result, the display device 10 detects the utterance PA12, which indicates “tomorrow, I have a meeting in Hakodate”, as the input. Moreover, the display device 10 detects a variety of sensor information such as position information, acceleration information, and image information. Then, the display device 10 sends, to the information processing device 100, the corresponding sensor information, which corresponds to the point of time of the utterance PA12, along with the utterance PA12.

Thus, the information processing device 100 obtains the utterance PA12 and the corresponding sensor information from the display device 10. Then, the information processing device 100 analyzes the utterance PA12 and the corresponding sensor information, and estimates the dialogue state of the user U11 corresponding to the utterance PA12. In the example illustrated in FIG. 15, a result of analyzing the utterance PA12, the information processing device 100 identifies that the utterance PA12 of the user U11 has contents related to the schedule on the next day. Then, based on the analysis result indicating that the utterance PA12 has contents related to a meeting in Hakodate on the next day, the information processing device 100 estimates that the dialogue state of the user U11 is related to the confirmation of the schedule. Hence, the information processing device 100 estimates that “Schedule-Check” related to the confirmation of the schedule represents the domain goal indicating the dialogue state of the user U11.

Moreover, the information processing device 100 analyzes the utterance PA12 and the corresponding sensor information, and estimates the slot value of each slot included in the domain goal “Schedule-Check”. Based on the analysis result indicating that the utterance PA12 has contents related to the schedule on the next day, the information processing device 100 estimates “tomorrow” as the slot value of the slot “date and time”, and estimates “meeting in Hakodate” as the slot value of a slot “title”. For example, the information processing device 100 can compare the extracted keywords, which are extracted from the utterance PA12 of the user U11, with each slot; and accordingly identify, as extracted keywords, the slot values of the slots corresponding to the extracted keywords.

Then, the information processing device 100 calculates the certainty factors of the elements related to the dialogue state of the user U11 of the dialogue system. In the example illustrated in FIG. 15, the information processing device 100 calculates the certainty factor of the domain goal “Schedule-Check” that represents the first-type element indicating the dialogue state of the user U11 (i.e., calculates the first-type certainty factor). Moreover, the information processing device 100 calculates the certainty factors of the slot values “tomorrow” and “meeting in Hakodate” that represent the second-type elements belonging to the lower hierarchy of the first-type element represented by the domain goal “Schedule-Check” (i.e., calculates second-type certainty factors).

For example, using Equation (1) given earlier, the information processing device 100 calculates the certainty factors of the domain goal and the slot values.

The information processing device 100 assigns an element ID “D11”, which enables identification of the domain goal “Schedule-Check”, to “x₁” in Equation (1) given earlier; assigns corresponding information to each of “x₂” to “x₁₁”; and calculates the certainty factor of the domain goal “Schedule-Check”. As illustrated in an analysis result AN12 in FIG. 15, the information processing device 100 calculates the certainty factor of the domain goal “Schedule-Check” representing the first-type element (i.e., calculates the first-type certainty factor) to be equal to “0.78”.

Moreover, the information processing device 100 assigns identification information of the slot value “tomorrow” (i.e., assigns a slot ID “D11-S1” or a slot ID “D11-V1”) to “x₁” in Equation (1) given earlier; assigns corresponding information to each of “x₂” and “x₁₁”; and calculates the certainty factor of the slot value “tomorrow”. As illustrated in the analysis result AN12 in FIG. 15, the information processing device 100 calculates the certainty factor of the slot value “tomorrow” representing a second-type element (i.e., calculates a second-type certainty factor) to be equal to “0.84”.

Furthermore, the information processing device 100 assigns identification information of the slot value “meeting in Hakodate” (i.e., assigns a slot ID “D11-S2” or a slot ID “D11-V2”) to “x₁” in Equation (1) given earlier; assigns corresponding information to each of “x₂” and “x₁₁”; and calculates the certainty factor of the slot value “meeting in Hakodate”. As illustrated in the analysis result AN12 in FIG. 15, the information processing device 100 calculates the certainty factor of the slot value “meeting in Hakodate” representing a second-type element (i.e., calculates a second-type certainty factor) to be equal to “0.65”.

Then, based on the calculated certainty factors of the elements, the information processing device 100 decides on the targets for highlighted display (the highlighting targets). If an element has the certainty factor to be smaller than the threshold value “0.8”, then the information processing device 100 decides to treat that element as the highlighting target.

Since the certainty factor “0.78” of the domain goal “Schedule-Check” is smaller than the threshold value “0.8”, the information processing device 100 decides to treat the domain goal “Schedule-Check” as the highlighting target.

On the other hand, since the certainty factor “0.84” of the slot value “tomorrow” is equal to or greater than the threshold value “0.8”, the information processing device 100 decides not to treat the slot value “tomorrow” as the highlighting target. However, since the certainty factor “0.65” of the slot value “meeting in Hakodate” is smaller than the threshold value “0.8”, the information processing device 100 decides to treat the slot value “meeting in Hakodate” as the highlighting target.

In this way, the information processing device 100 decides to treat two elements having low certainty factors, namely, the domain goal “Schedule-Check” and the slot value “meeting in Hakodate” as the highlighting targets.

Then, the information processing device 100 highlights the domain goal “Schedule-Check” and the slot value “meeting in Hakodate”. In the example illustrated in FIG. 15, the information processing device 100 generates an image IM11 in which the character string “Schedule-Check” of the domain goal D11 and the character string “meeting in Hakodate” of the slot value D11-V2 are underlined. Thus, the information processing device 100 generates the image IM11 that includes the domain goal D11 representing the domain goal “Schedule-Check”, the slot D11-S1 representing the slot “date and time”, and the slot D11-S2 representing the slot “title”. Moreover, the information processing device 100 generates the image IM11 that includes the slot value D11-V1 representing the slot value “tomorrow” and includes the slot value D11-V2 representing the slot value “meeting in Hakodate”.

Then, the information processing device 100 sends, to the display device 10, the image IM11 in which the character string “Schedule-Check” of the domain goal D11 and the character string “meeting in Hakodate” of the slot value D11-V2 are underlined. Upon receiving the image IM11 in which the character string “Schedule-Check” of the domain goal D11 and the character string “meeting in Hakodate” of the slot value D11-V2 are underlined, the display device 10 displays the image IM11 in the display unit 18.

After displaying the image IM11, the display device 10 receives a correction made by the user U11 with respect to the highlighted domain goal “Schedule-Check”. With reference to FIG. 15, around the display device 10 used by the user U11, the user U11 makes an utterance PA13 saying “instead of checking the schedule, find a restaurant”. Then, the display device 10 uses a sound sensor and detects voice information of the utterance PA13 (also simply referred to as the item “utterance PA13”) indicating “instead of checking the schedule, find a restaurant”. As a result, the display device 10 detects the utterance PA13, which indicates “instead of checking the schedule, find a restaurant”, as the input. Moreover, the display device 10 detects a variety of sensor information such as position information, acceleration information, and image information. Then, the display device 10 sends, to the information processing device 100, the corresponding sensor information, which corresponds to the point of time of the utterance PA13, along with the utterance PA13.

Thus, the information processing device 100 obtains the utterance PA13 and the corresponding sensor information from the display device 10. Then, the information processing device 100 analyzes the utterance PA13 and the corresponding sensor information, and estimates that the utterance PA13 was made by the user for requesting a correction. In the example illustrated in FIG. 15, the information processing device 100 analyzes the utterance PA13, and identifies that the user U11 is requesting to change the domain goal from the domain goal related to the confirmation of the schedule to the domain goal related to a restaurant search. Hence, the information processing device 100 identifies that, as illustrated in correction information CH11, the utterance PA13 of the user U11 represents information for requesting correction of the domain goal “Schedule-check” to a domain goal “Restaurant-Search”.

Moreover, based on the analysis result of the utterance PA13, based on the past utterances PA11 and PA12, and based on the past analysis result AN12; the information processing device 100 estimates the slot value of each slot included in the domain goal “Restaurant-Search”. From among the slot values of the domain goal “Schedule-Check” before it was changed to the domain goal “Restaurant-Search”; the information processing device 100 keeps, in the post-change domain goal “Restaurant-Search”, such information which can be carried over as the slot values in the domain goal “Restaurant-Search”.

In the example illustrated in FIG. 15, the slot “date and time” of the post-change domain goal “Schedule-Check” corresponds to the slot “date and time” of the pre-change domain goal “Restaurant-Search”. Hence, the information processing device 100 uses the slot value “tomorrow” of the slot “date and time” of the domain goal “Schedule-Check” as the slot “date and time” of the post-change domain goal “Restaurant-Search”. For example, the information processing device 100 can compare the slot “date and time” of the domain goal “Schedule-Check” with slot “date and time” of the post-change domain goal “Restaurant-Search”, and identify that the slot “date and time” is identical. Then, the information processing device 100 uses the slot value “tomorrow” of the slot “date and time” of the domain goal “Schedule-Check” as the slot value of the slot “date and time” of the post-change domain goal “Restaurant-Search”.

Regarding the pre-change domain goal “Restaurant-Search”, the slot “title” has the slot value “meeting in Hakodate” that includes the information corresponding to the slot “location” of the post-change domain goal “Schedule-Check”. Hence, the information processing device 100 uses the slot value “meeting in Hakodate” of the slot “title” of the domain goal “Schedule-Check” as the slot value of the slot “location” of the post-change domain goal “Restaurant-Search”. More particularly, of the slot value “meeting in Hakodate” of the slot “title” of the domain goal “Schedule-Check”, the information processing device 100 uses the word “Hakodate” as the slot value of the slot “location” of the post-change domain goal “Restaurant-Search”. For example, based on the information stored in a database such as, what is called, a knowledge base, the information processing device 100 can identify that “Hakodate” is equivalent to the information indicating a place-name corresponding to the slot “location”.

Moreover, based on the utterance PA11 made before the utterance PA13, the information processing device 100 estimates that a slot “restaurant name” has the slot value “restaurant Y”. Based on the analysis result indicating that the utterance PA11 is “speaking of Hakodate, there is this restaurant Y” having contents about the restaurant Y in Hakodate, the information processing device 100 estimates that the slot “restaurant name” has the slot value “restaurant Y”.

Thus, as illustrated in an analysis result AN13, the information processing device 100 estimates that the domain goal “Restaurant-Search” has the following slots and slot values: the slot “date and time” has the slot value “tomorrow”, the slot “location” has the slot value “Hakodate”, and the slot “restaurant name” has the slot value “restaurant Y”.

Then, the information processing device 100 calculates the certainty factors of the elements related to the dialogue state of the user U11 of the dialogue system. In the example illustrated in FIG. 15, the information processing device 100 calculates the certainty factor of the domain goal “Restaurant-Search” representing the first-type element indicating the dialogue state of the user U11 (i.e., calculates the first-type certainty factor). Moreover, the information processing device 100 calculates the certainty factors of the slots “tomorrow”, “Hakodate”, and “restaurant Y” that represent the second-type elements belonging to the lower hierarchy of the first-type element represented by the domain goal “Restaurant-Search” (i.e., calculates second-type certainty factors).

For example, using Equation (1) given earlier, the information processing device 100 calculates the certainty factors of the domain goal and the slot values.

The information processing device 100 assigns an element ID “D12”, which enables identification of the domain goal “Restaurant-Search”, to “x₁” in Equation (1) given earlier; assigns corresponding information to each of “x₂” and “x₁₁”; and calculates the certainty factor of the domain goal “Restaurant-Search”. As illustrated in the analysis result AN13 in FIG. 15, the information processing device 100 calculates the certainty factor of the domain goal “Restaurant-Search” representing the first-type element (i.e., calculates the first-type element) to be equal to “0.99”. Since the domain goal “Restaurant-Search” represents the information specified by the user U11 as a correction, the information processing device 100 calculates the certainty factor of the domain goal “Restaurant-Search” (i.e., calculates the first-type element) to be equal to a high value of “0.99”.

Moreover, the information processing device 100 assigns identification information enabling identification of the slot value “tomorrow” (i.e., assigns a slot ID “D12-S1” or “D12-V1”) to “x₁” in Equation (1) given earlier; assigns corresponding information to each of “x₂” to “x₁₁”; and calculates the certainty factor of the slot value “tomorrow”. As illustrated in the analysis result AN13 in FIG. 15, the information processing device 100 calculates the certainty factor of the slot value “tomorrow” representing a second-type element (i.e., calculates a second-type certainty factor) to be equal to “0.84”.

Furthermore, the information processing device 100 assigns identification information enabling identification of the slot value “Hakodate” (i.e., assigns a slot ID “D12-S2” or “D12-V2”) to “x₁” in Equation (1) given earlier; assigns corresponding information to each of “x₂” to “x₁₁”; and calculates the certainty factor of the slot value “Hakodate”. As illustrated in the analysis result AN13 in FIG. 15, the information processing device 100 calculates the certainty factor of the slot value “Hakodate” representing a second-type element (i.e., calculates a second-type certainty factor) to be equal to “0.89”.

Moreover, the information processing device 100 assigns identification information enabling identification of the slot value “restaurant Y” (i.e., assigns a slot ID “D12-S3” or “D12-V3”) to “x₁” in Equation (1) given earlier; assigns corresponding information to each of “x₂” to “x₁₁”; and calculates the certainty factor of the slot value “restaurant Y”. As illustrated in the analysis result AN13 in FIG. 15, the information processing device 100 calculates the certainty factor of the slot value “restaurant Y” representing a second-type element (i.e., calculates a second-type certainty factor) to be equal to “0.48”.

Then, based on the calculated certainty factors of the elements, the information processing device 100 decides on the targets for highlighted display (the highlighting targets). If an element has the certainty factor to be smaller than the threshold value “0.8”, then the information processing device 100 decides to treat that element as the highlighting target.

Since the certainty factor “0.99” of the domain goal “Restaurant-Search” is equal to or greater than the threshold value “0.8”, the information processing device 100 decides not to treat the domain goal “Restaurant-Search” as the highlighting target.

Moreover, since the certainty factor “0.84” of the slot value “tomorrow” is equal to or greater than the threshold value “0.8”, the information processing device 100 decides not to treat the slot value “tomorrow” as the highlighting target. Furthermore, since the certainty factor “0.89” of the slot value “Hakodate” is equal to or greater than the threshold value “0.8”, the information processing device 100 decides not to treat the slot value “Hakodate” as the highlighting target. On the other hand, since the certainty factor “0.48” of the slot value “restaurant Y” is smaller than the threshold value “0.8”, the information processing device 100 decides to treat the slot value “restaurant Y” as the highlighting target, as illustrated in the decision result information RINF1 in FIG. 15.

In this way, the information processing device 100 decides to treat the slot value “restaurant Y” having a low certainty factor as the highlighting target.

Then, the information processing device 100 highlights the slot value “restaurant Y”. In the example illustrated in FIG. 15, the information processing device 100 generates an image IM12 in which the character string “restaurant Y” of the slot value D2-V3 is underlined. Thus, the information processing device 100 generates the image IM12 that includes the domain goal D12 representing the domain goal “Restaurant-Search”. Moreover, the information processing device 100 generates the image IM12 that includes the slot D12-D1 representing the slot “date and time”, the slot D12-S2 representing the slot “location”, the slot D12-D3 representing the slot “restaurant”, and a slot D12-S4 representing a slot “parking lot available/unavailable”. Furthermore, the information processing device 100 generates the image IM12 that includes the slot value D12-V1 representing the slot value “tomorrow”, the slot value D12-V2 representing the slot value “Hakodate”, and the slot value D12-V3 representing the slot value “restaurant Y”. Meanwhile, as a result of not being able to estimate the slot value corresponding to the slot “parking lot available/unavailable”, the information processing device 100 generates the image IM12 that does not include the slot value of the slot “parking lot available/unavailable”.

Then, the information processing device 100 sends, to the display device 10, the image IM12 in which the character string “restaurant Y” of the slot value D12-V3 is underlined. Upon receiving the image IM12 in which the character string “restaurant Y” of the slot value D12-V3 is underlined, the display device 10 displays the image IM12 in the display unit 18.

As explained above, when the user makes a correction, there are times when not only the information about the corrected element needs to be updated but the information about the items (slots and slot values) affected by the correction also needs to be updated. In that case, if the user is also asked to re-input the items affected by the correction, it becomes a cumbersome task for the user. Hence, the information processing device 100 automatically performs the updating (changes) using information such as the context, the data structure, and the knowledge. As a result, the information processing device 100 enables achieving further enhancement in the user-friendliness.

[1-9. Sequence of Information Processing According to First Modification Example]

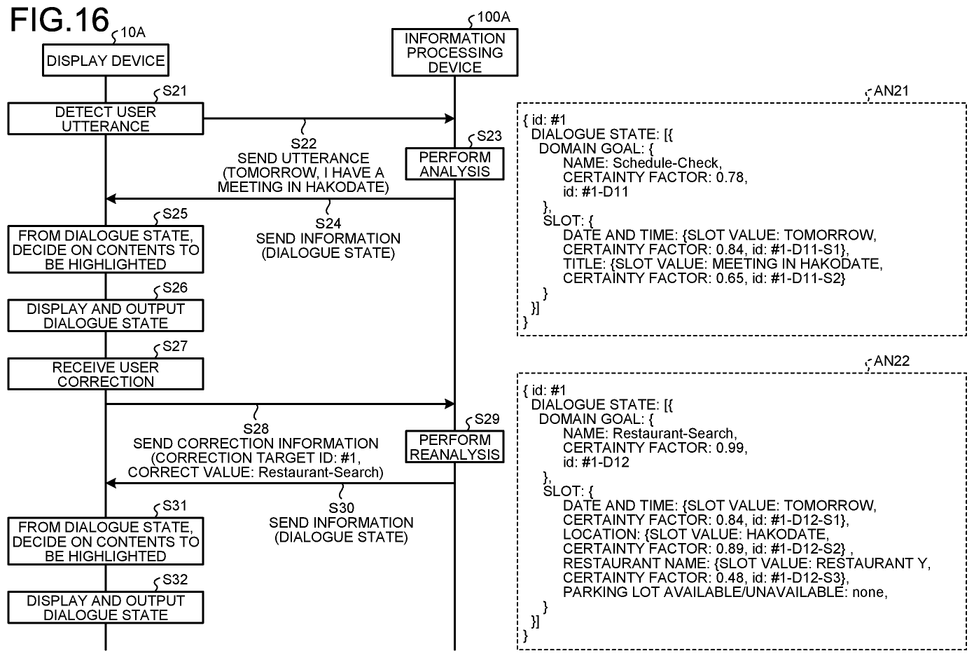

Explained below with reference to FIG. 16 are the operations performed based on a user correction in the case of deciding the highlighting targets in the display device. FIG. 16 is a diagram illustrating an example of a correction operation performed according to a first modification example of the application concerned. A display device 10A according to the first modification example has the function of deciding on the highlighting targets. Thus, the display device 10A is configured when the function of deciding on the highlighting targets is added to the display device 10 according to the embodiment. For example, in the display device 10A, the deciding unit 153 has the function of deciding on the highlighting targets that is provided in the deciding unit 134 of the information processing device 100. For example, a display device 100A according to the first modification example is an information processing device configured by excluding the function of deciding on the highlighting targets from the information processing device 100 according to the embodiment. Meanwhile, with reference to FIG. 16, the explanation is given for an example in which it is the user U11 who makes utterances in an identical manner to the explanation given with reference to FIG. 15. Herein, regarding the identical points to the example illustrated in FIG. 15, the explanation is not given again.

Firstly, with reference to FIG. 16, the user U11 makes an utterance. For example, around the display device 10A used by the user U11, the user U11 makes an utterance saying “tomorrow, I have a meeting in Hakodate” (hereinafter, referred to as “utterance PA21”). In response, the display device 10A detects the user utterance (Step S21). More particularly, the display device 10A uses a sound sensor and detects voice information of the utterance PA21 (also simply referred to as the “utterance PA21”) indicating “tomorrow, I have a meeting in Hakodate”. That is, the display device 10A detects the utterance PA21, which indicates “tomorrow, I have a meeting in Hakodate”, as the input. Moreover, the display device 10A detects a variety of sensor information such as position information, acceleration information, and image information.

Then, the display device 10A sends the utterance PA21 to the information processing device 100A (Step S22). The display device 10A detects a variety of sensor information such as position information, acceleration information, and image information. Thus, the display device 10A sends, to the information processing device 100A, the corresponding sensor information at the point of time of the utterance PA21, along with the utterance PA21.

As a result, the information processing device 100A obtains the utterance PA21 and the corresponding sensor information from the display device 10A. Then, the information processing device 100A analyzes the utterance PA21 and the corresponding sensor information (Step S23). As a result of analyzing the utterance PA21 and the corresponding sensor information, the information processing device 100A estimates the dialogue state of the user U11 corresponding to the utterance PA21. In the example illustrated in FIG. 16, as a result of analyzing the utterance PA21, the information processing device 100A identifies that the utterance PA21 of the user U11 has contents related to the schedule on the next day.

Then, based on the analysis result indicating that the utterance PA21 has contents related to a meeting in Hakodate on the next day, the information processing device 100A estimates that the dialogue state of the user U11 is related to the confirmation of the schedule. Hence, the information processing device 100A estimates that “Schedule-Check” related to the confirmation of the schedule represents the domain goal indicating the dialogue state of the user U11.

Moreover, the information processing device 100A analyzes the utterance PA21 and the corresponding sensor information, and estimates the slot value of each slot included in the domain goal “Schedule-Check”. Based on the analysis result indicating that the utterance PA21 has contents related to the schedule on the next day, the information processing device 100A estimates “tomorrow” as the slot value of the slot “date and time”, and estimates “meeting in Hakodate” as the slot value of the slot “title”. For example, the information processing device 100A can compare the extracted keywords, which are extracted from the utterance PA21 of the user U11, with each slot; and accordingly identify, as extracted keywords, the slot values of the slots corresponding to the extracted keywords.

Then, the information processing device 100A calculates the certainty factors of the elements related to the dialogue state of the user U11 of the dialogue system. In the example illustrated in FIG. 16, the information processing device 100A calculates the certainty factor of the domain goal “Schedule-Check” representing the first-type element indicating the dialogue state of the user U11 (i.e., calculates the first-type certainty factor). Moreover, the information processing device 100A calculates the certainty factors of the slot values “tomorrow” and “meeting in Hakodate” that represent the second-type elements belonging to the lower hierarchy of the first-type element represented by the domain goal “Schedule-Check” (i.e., calculates second-type certainty factors).

For example, using Equation (1) given earlier, the information processing device 100A calculates the certainty factors of the domain value and the slot values. Using Equation (1) given earlier, as illustrated in an analysis result AN21 in FIG. 16, the information processing device 100A calculates the certainty factor of the domain goal “Schedule-Check” representing the first-type element (i.e., calculates the first-type certainty factor) to be equal to “0.78”. Moreover, using Equation (1) given earlier, as illustrated in the analysis result AN21 in FIG. 16, the information processing device 100A calculates the certainty factor of the slot value “tomorrow” representing a second-type element (i.e., calculates a second-type certainty factor) to be equal to “0.84”. Furthermore, using Equation (1) given earlier, as illustrated in the analysis result AN21 in FIG. 16, the information processing device 100A calculates the certainty factor of the slot value “meeting in Hakodate” representing a second-type element (i.e., calculates a second-type certainty factor) to be equal to “0.65”.

Then, the information processing device 100A sends the information related to the dialogue state to the display device 10A (Step S24). For example, the information processing device 100A sends the analysis result AN21 to the display device 10A. Thus, the information processing device 100A sends, to the display device 10A, the information indicating that the domain goal “Schedule-Check” is the estimated domain goal for the user U11. Moreover, the information processing device 100A sends, to the display device 10A, the information indicating the certainty factor of the estimated domain goal “Schedule-Check” of the user U11 and certainty factors of the slot values of the slots of the domain goal “Schedule-Check”.

Then, the display device 10A decides on the contents to be highlighted from the dialogue state (Step S25). For example, based on the received certainty factors of the elements, the display device 10A decides on the targets for highlighted display (the highlighting targets). If an element has the certainty factor equal to or greater than the threshold value “0.8”, then the display device 10A decides to treat that element as the highlighting target.

Since the certainty factor “0.78” of the domain goal “Schedule-Check” is smaller than the threshold value “0.8”, the display device 10A decides to treat the domain goal “Schedule-Check” as the highlighting target. On the other hand, since the certainty factor “0.84” of the slot value “tomorrow” is equal to or greater than the threshold value “0.8”, the display device 10A decides not to treat the slot value “tomorrow” as the highlighting target. However, since the certainty factor “0.65” of the slot value “meeting in Hakodate” is equal to or greater than the threshold value “0.8”, the display device 10A decides to treat the slot value “meeting in Hakodate” as the highlighting target. In this way, the display device 10A treats two elements having low certainty factors, namely, the domain goal “Schedule Check” and the slot value “meeting in Hakodate” as the highlighting targets.

Then, the display device 10A displays and outputs the dialogue state (Step S26). For example, the display device 10A displays an image that includes the domain goal “Schedule-Check” and the slots and their slot values. Moreover, the display device 10A highlights the domain goal “Schedule-Check” and the slot “meeting in Hakodate”. For example, the display device 10A generates an image in which the character string “Schedule-Check” of the domain goal D11 and the character string “meeting in Hakodate” of the slot value D11-V2 are underlined (i.e., an image corresponding to the image IM11 illustrated in FIG. 15); and displays that image in the display unit 18.

Then, the display device 10A receives a correction from the user (Step S27). With reference to FIG. 16, the display device 10A receives a correction of changing the domain goal from “Schedule-Check” to “Restaurant-Search” from the user U11.

Subsequently, the display device 10A sends the correction information received from the user to the information processing device 100A (Step S28). For example, the display device 10A sends the correction information, which indicates the details of the correction made by the user U11, to the information processing device 100A. Herein, the display device 10A sends an ID representing the correction target (for example, an ID representing the estimated state) and a correct value indicating the post-correction answer to the information processing device 100A. In the example illustrated in FIG. 16, to the information processing device 100A, the display device 10A sends correction information that includes a correction target ID indicating that the correction target has the estimated state “#1” and an outcome value indicating that the post-correction domain goal is “Restaurant-Search”.

Thus, the information processing device 100A obtains the correction information from the display device 10A. Then, the information processing device 100A performs reanalysis based on the obtained correction information (Step S29). In the example illustrated in FIG. 16, the information processing device 100A analyzes the correction information and identifies that the user U11 is requesting to change the domain goal from the domain goal related to the confirmation of the schedule to the domain goal related to a restaurant search. Hence, the information processing device 100A identifies that the correction details of the user U11 represent information for requesting correction of the domain goal from “Schedule-Check” to “Restaurant-Search”.

Moreover, based on the past utterances such as the utterance PA21 and based on the past utterance analysis results such as the analysis result AN21, the information processing device 100A estimates the slot values of the slots included in the domain goal “Restaurant-Search”. The information processing device 100A uses the slot value “tomorrow” of the slot “date and time” of the domain goal “Schedule-Check” as the slot value of the slot “date and time” of the post-change domain goal “Restaurant-Search”. Moreover, of the slot value “meeting in Hakodate” of the slot “title” of the domain goal “Schedule-Check”, the information processing device 100A uses the word “Hakodate” as the slot value of the slot “location” of the post-change “Restaurant-Search”. Furthermore, based on the past utterances such as the utterance PA21 and based on the past analysis results such as the analysis result AN21, the information processing device 100A estimates that the slot “restaurant name” has the slot value “restaurant Y”.

In this way, as illustrated in an analysis result AN22, the information processing device 100A estimates that the domain goal “Restaurant-Search” has the following slots and slot values: the slot “date and time” has the slot value “tomorrow”, the slot “location” has the slot value “Hakodate”, and the slot “restaurant name” has the slot value “restaurant Y”.

Then, the information processing device 100A calculates the certainty factors related to the dialogue state of the user U11 of the dialogue system. In the example illustrated in FIG. 16, the information processing device 100A calculates the certainty factor of the domain goal “Restaurant-Search” representing the first-type element indicating the dialogue state of the user U11 (i.e., calculates the first-type certainty factor). Moreover, the information processing device 100A calculates the certainty factors of the slots “tomorrow”, “Hakodate”, and “restaurant Y” that represent the second-type elements belonging to the lower hierarchy of the first-type element represented by the domain goal “Restaurant-Search” (i.e., calculates second-type certainty factors).

For example, using Equation (1) given earlier, the information processing device 100A calculates the certainty factors of the domain goal and the slot values. Using Equation (1) given earlier, as illustrated in the analysis result AN22 in FIG. 16, the information processing device 100A calculates the certainty factor of the domain goal “Restaurant-Search” representing the first-type element (i.e., calculates the first-type element) to be equal to “0.99”. Moreover, using Equation (1) given earlier, as illustrated in the analysis result AN22 in FIG. 16, the information processing device 100A calculates the certainty factor of the slot value “tomorrow” representing a second-type element (i.e., calculates a second-type certainty factor) to be equal to “0.84”. Furthermore, using Equation (1) given earlier, as illustrated in the analysis result AN22 in FIG. 16, the information processing device 100A calculates the certainty factor of the slot value “Hakodate” representing a second-type element (i.e., calculates a second-type certainty factor) to be equal to “0.89”. Moreover, using Equation (1) given earlier, as illustrated in the analysis result AN22 in FIG. 16, the information processing device 100A calculates the certainty factor of the slot value “restaurant Y” representing a second-type element (i.e., calculates a second-type certainty factor) to be equal to “0.48”.

Then, the information processing device 100A sends the information related to the dialogue state to the display device 10A (Step S30). For example, the information processing device 100A sends the analysis result AN22 to the display device 10A. Thus, the information processing device 100A sends, to the display device 10A, the information indicating that the domain goal “Restaurant-Search” is the post-correction domain goal of the user U11. Moreover, the information processing device 100A sends, to the display device 10A, the information indicating the certainty factor of the post-correction domain goal “Restaurant-Search” of the user U11 and the certainty factors of the slot values of the slots of the domain goal “Restaurant-Search”.

Then, the display device 10A decides on the contents to be highlighted from the dialogue state (Step S31). For example, based on the received certainty factors of the elements, the display device 10A decides on the targets for highlighted display (the highlighting targets). If an element has the certainty factor equal to or greater than the threshold value “0.8”, then the display device 10A decides to treat that element as the highlighting target.

Since the certainty factor “0.99” of the domain goal “Restaurant-Search” is equal to or greater than the threshold value “0.8”, the display device 10A decides not to treat the domain goal “Restaurant-Search” as the highlighting target. Moreover, since the certainty factor “0.84” of the slot value “tomorrow” is equal to or greater than the threshold value “0.8”, the display device 10A decides not to treat the slot value “tomorrow” as the highlighting target. Furthermore, Since the certainty factor “0.89” of the slot value “Hakodate” is equal to or greater than the threshold value “0.8”, the display device 10A decides not to treat the slot value “Hakodate” as the highlighting target. On the other hand, since the certainty factor “0.48” of the slot value “restaurant Y” is smaller than the threshold value “0.8”, the display device 10A decides to treat the slot value “restaurant Y” as the highlighting target, as illustrated in the decision result information RINF1 in FIG. 16. In this way, the display device 10A decides to treat the slot value “restaurant Y” having a low certainty factor as the highlighting target.

Then, the display device 10A displays and outputs the dialogue state (Step S32). For example, the display device 10A displays an image that includes the domain goal “Restaurant-Search” and the slots and their slot values. Moreover, the display device 10A highlights the slot value “restaurant Y”. For example, the display device 10A generates an image in which the character string “restaurant Y” of the slot value D12-V3 is underlined (i.e., an image corresponding to the image IM12 illustrated in FIG. 15); and displays that image in the display unit 18.

[1-10. Domain Goal, Highlighting Target]

Given below is the explanation of various forms (variations) of estimating the dialogue state (the domain goal) and deciding on the highlighting targets.

[1-10-1. Plurality of Domain Goals]

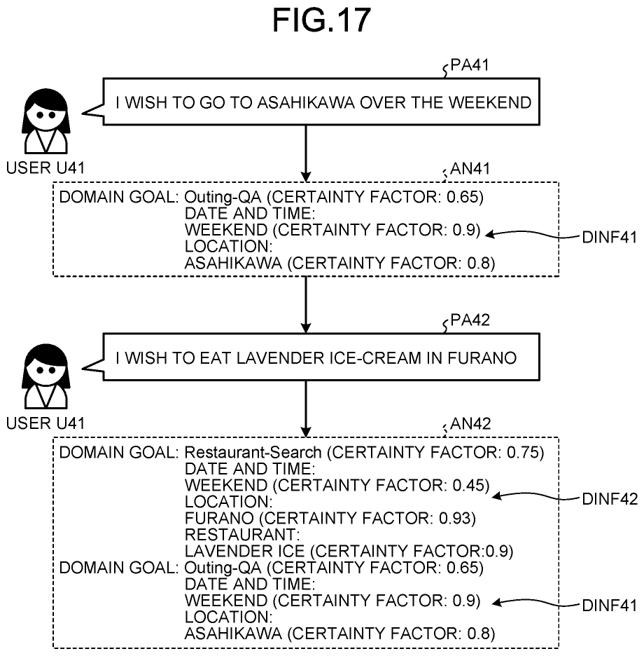

Firstly, explained below with reference to FIG. 17 is the basic estimation of the dialogue state. FIG. 17 is a diagram illustrating an example of the estimation of the dialogue state corresponding to a user utterance. More particularly, FIG. 17 is a diagram illustrating the estimation of a plurality of domain goals by the information processing system 1 according to the dialogue with the user. The operations illustrated in FIG. 17 can be performed by any device included in the information processing system 1, such as either by the information processing device 100 or by the display device 10.

With reference to FIG. 17, a user U41 makes an utterance. For example, the user U41 makes an utterance saying

“I wish to go to Asahikawa over the weekend” (hereinafter, referred to as an “utterance PA41”). The information processing system 1 uses a sound sensor and detects voice information of the utterance PA41 (also simply referred to as the “utterance PA41”) indicating “I wish to go to Asahikawa over the weekend”. Thus, the information processing system 1 detects the utterance PA41, which indicates “I wish to go to Asahikawa over the weekend”, as the input. Moreover, the information processing system 1 detects a variety of sensor information such as the position information, the acceleration information, and the image information.

In this way, the information processing system 1 obtains the utterance PA41 and the corresponding sensor information from within. Then, the information processing system 1 analyzes the utterance PA41 and the corresponding sensor information, and estimates the dialogue state of the user U41 corresponding to the utterance PA41. In the example illustrated in FIG. 17, the information processing system 1 analyzes the utterance PA41, and identifies that the utterance PA41 of the user U41 has the contents related to the outing destination. As a result, the information processing system 1 estimates that “Outing-QA” related to the outing destination represents the domain goal indicating the dialogue state of the user U41.

Moreover, the information processing system 1 analyzes the utterance PA41 and the corresponding sensor information, and estimates the slot value of each slot included in the domain goal “Outing-QA”. Thus, based on the analysis result indicating that the utterance PA41 has the contents related to going to Asahikawa over the weekend, the information processing system 1 estimates that the slot “date and time” has the slot value “weekend” and estimates that the slot “location” has the slot value “Asahikawa”.

Then, the information processing system 1 calculates the certainty factors of the elements related to the dialogue state of the user U41 of the dialogue system. In the example illustrated in FIG. 17, the information processing system 1 calculates the certainty factor of the domain goal “Outing-QA” representing a first-type element of the dialogue state of the user U41 (i.e., calculates a first-type certainty factor). Moreover, the information processing system 1 calculates the certainty factors of the slot values “weekend” and “Asahikawa” that represent the second-type elements belonging to the lower hierarchy of the first-type element represented by the domain goal “Outing-QA” (i.e., calculates second-type certainty factors).

For example, using Equation (1) given earlier, the information processing system 1 calculates the certainty factors of the domain goal and the slot values. Thus, using Equation (1) given earlier, as illustrated in an analysis result AN41 in FIG. 17, the information processing system 1 calculates the certainty factor of the domain goal “Outing-QA” representing a first-type element (i.e., calculates a first-type certainty factor) to be equal to “0.65”. Moreover, using Equation (1) given earlier, as illustrated in the analysis result AN41 in FIG. 17, the information processing system 1 calculates the certainty factor of the slot value “weekend” representing a second-type element (i.e., calculates a second-type certainty factor) to be equal to “0.9”. Furthermore, using Equation (1) given earlier, as illustrated in the analysis result AN41 in FIG. 17, the information processing system 1 calculates the certainty factor of the slot value “Asahikawa” representing a second-type element (i.e., calculates a second-type certainty factor) to be equal to “0.8”. The analysis result AN41 illustrated in FIG. 17 includes dialogue state information DINF41 indicating the domain goal “Outing-QA”, the certainty factor of the domain goal “Outing-QA”, the slots, the slot values, and the certainty factors of the slot values.

Subsequently, the information processing system 1 decides to treat the domain goal “Outing-QA”, which has the certainty factor to be smaller than the threshold value “0.8”, as a highlighting target. Accordingly, the information processing system 1 highlights the domain goal “Outing-QA”.

Meanwhile, with reference to FIG. 17, the user U41 follows the utterance PA41 with another utterance. For example, the user U41 makes an utterance saying “I wish to eat lavender ice-cream in Furano” (hereinafter, referred to as an “utterance PA42”). The information processing system 1 uses a sound sensor and detects voice information of the utterance PA42 (also simply referred to as the “utterance PA42”) indicating “I wish to eat lavender ice-cream in Furano”. Thus, the information processing system 1 detects the utterance PA42, which indicates “I wish to eat lavender ice-cream in Furano”, as the input. Moreover, the information processing system 1 detects a variety of sensor information such as the position information, the acceleration information, and the image information.

In this way, the information processing system obtains the utterance PA42 and the corresponding sensor information from within. Then, the information processing system 1 analyzes the utterance PA42 and the corresponding sensor information, and estimates the dialogue state of the user U41 corresponding to the utterance PA42. In the example illustrated in FIG. 17, the information processing system 1 analyzes the utterance PA42, and identifies that the utterance PA42 of the user U41 has the contents related to a restaurant search. As a result, the information processing system 1 estimates that “Restaurant-Search”related to a restaurant search represents the domain goal indicating the dialogue state of the user U41.

Moreover, the information processing system 1 analyzes the utterance PA42 and the corresponding sensor information, and estimates the slot value of each slot included in the domain goal “Restaurant-Search”. The information processing system 1 takes into account a variety of context information such as the contents of the utterance PA41 made before the utterance PA42, and estimates the slot value of each slot included in the domain goal “Restaurant-Search”. Thus, based on the analysis result indicating that the utterance PA42 has the contents related to lavender ice-cream in Furano, the information processing system 1 estimates that the slot “date and time” has the slot value “Furano” and estimates that the slot “restaurant name” has the slot value “lavender ice-cream”. Moreover, since the information indicating the date and time is not included in the utterance PA42, based on the contents of the utterance PA41 made before the utterance PA42, the information processing system 1 estimates that the slot “date and time” has the slot value “weekend”. Meanwhile, the explanation given above is only exemplary, and the information processing system 1 can estimate the slot values “date and time”, “location”, and “restaurant name” using a variety of information. As in the case of the utterance PA42, if the information indicating the date and time is not included, then the information processing system 1 can estimate that the slot “date and time” has a slot value “- (unclear)”.

Subsequently, the information processing system 1 calculates the certainty factors of the elements related to the dialogue state of the user U41 of the dialogue system. In the example illustrated in FIG. 17, the information processing system 1 calculates the certainty factor of the domain goal

“Restaurant-Search” representing a first-type element of the dialogue state of the user U41 (i.e., calculates a first-type certainty factor). Moreover, the information processing system 1 calculates the certainty factors of the slot values “weekend”, “Furano”, and “lavender ice-cream” that represent the second-type elements belonging to the lower hierarchy of the first-type element represented by the domain goal “Restaurant-Search” (i.e., calculates second-type certainty factors).

For example, using Equation (1) given earlier, the information processing system 1 calculates the certainty factors of the domain goal and the slot values. Thus, using Equation (1) given earlier, as illustrated in an analysis result AN42 in FIG. 17, the information processing system 1 calculates the certainty factor of the domain goal “Restaurant-Search” representing a first-type element (i.e., calculates a first-type certainty factor) to be equal to “0.75”. Moreover, using Equation (1) given earlier, as illustrated in the analysis result AN42 in FIG. 17, the information processing system 1 calculates the certainty factor of the slot value “weekend” representing a second-type element (i.e., calculates a second-type certainty factor) to be equal to “0.45”. Herein, since the slot value “weekend” representing a second-type element is the information estimated using the utterance PA41 that was made before the latest utterance PA42, the information processing system 1 calculates the certainty factor of the slot value “weekend” (i.e., calculates a second-type certainty factor” to be equal to a low value of “0.45”.

Furthermore, using Equation (1) given earlier, as illustrated in the analysis result AN42 in FIG. 17, the information processing system 1 calculates the certainty factor of the slot value “Furano” representing a second-type element (i.e., calculates a second-type certainty factor) to be equal to “0.93”. Moreover, using Equation (1) given earlier, as illustrated in the analysis result AN42 in FIG. 17, the information processing system 1 calculates the certainty factor of the slot value “lavender ice-cream” representing a second-type element (i.e., calculates a second-type certainty factor) to be equal to “0.9”. The analysis result AN42 illustrated in FIG. 17 includes dialogue state information DINF42 indicating the domain goal “Restaurant-Search”, the certainty factor of the domain goal “Restaurant-Search”, the slots, the slot values, and the certainty factors of the slot values.

Subsequently, the information processing system 1 decides to treat two elements having the certainty factors to be smaller than the threshold value “0.8”, namely, the domain goal “Restaurant-Search” and the slot value “weekend” as the highlighting targets. Accordingly, the information processing system 1 highlights the domain goal “Restaurant-Search”.

The analysis result AN42 illustrated in FIG. 17 includes the dialogue state information DINF42 along with the dialogue state information DINF41 that was already estimated at the point of time of the utterance PA42. Thus, when each utterance is estimated to have a different domain goal, the information processing system 1 manages a plurality of domain goals on the basis that a plurality of dialogue states is present together. For example, the information processing system 1 manages the domain goal “Outing-QA”, which is indicated by the dialogue state information DINF41, in a corresponding manner to the estimated state #1; and manages the domain goal “Restaurant-Search”, which is indicated by the dialogue state information DINF42, in a corresponding manner to the estimated state #2. Thus, the information processing system 1 processes a plurality of domain goals in parallel.

Moreover, in the example illustrated in FIG. 17, the information processing system 1 updates the information about only the domain goal corresponding to the utterance PA42; and maintains, without modification, the domain goal information estimated in the past. More particularly, the information processing system 1 estimates the information only about the domain goal “Restaurant-Search” corresponding to the utterance PA42; and maintains, without modification, the information about the domain goal “Outing-QA” that was estimated at the point of time of the utterance PA41.

[1-10-2. Updating]

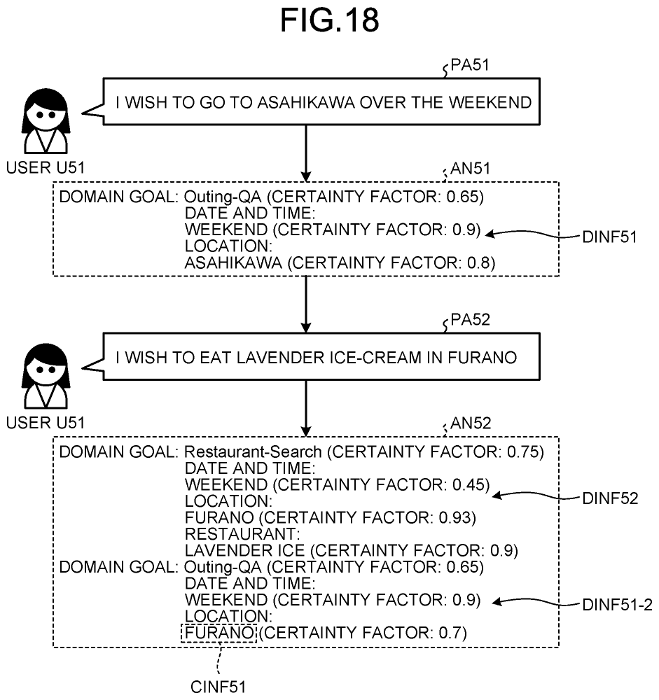

Explained below with reference to FIG. 18 is the use of future information. FIG. 18 is a diagram illustrating an example of updating the information that is estimated according to the utterances of the user. More particularly, FIG. 18 is a diagram illustrating the updating (modification) of the domain goal and the slot values as performed by the information processing system 1 according to the dialogue with the user. The operations illustrated in FIG. 18 can be performed by any device included in the information processing system 1, such as either by the information processing device 100 or by the display device 10. Moreover, with reference to FIG. 18, regarding the identical points to FIG. 17, the explanation is not given again.

With reference to FIG. 18, the operations performed till the calculation of the certainty factors of the domain goal “Restaurant-Search” and the slot values from an utterance PA51 are identical to the operations performed till the calculation of the certainty factors of the domain goal “Restaurant-Search” and the slot values from the utterance PA41 with reference to FIG. 17. Hence, that explanation is not given again.

In the example illustrated in FIG. 18, at an analysis timing or a reanalysis timing, the information processing system 1 constantly updates the information about all domain goals. Based on an utterance PA52 indicating “I wish to eat lavender ice-cream in Furano”, the information processing system 1 estimates the information about the domain goal “Restaurant-Search”. Moreover, based on the utterance PA52 indicating “I wish to eat lavender ice-cream in Furano”, the information processing system 1 updates the domain goal “Outing-QA” that was estimated at the point of time of the utterance PA51, and updates the slots and the slot values of the domain goal “Outing-QA”. In this way, the information processing system 1 treats also the domain goal “Outing-QA”, which was estimated in the past, and its slots and slot values as the targets for updating (modification).

For example, since the place-name “Furano” indicating the location is included in the utterance PA52, the information processing system 1 updates the slot value of the slot “location”. As illustrated in modification information CINF51 in dialogue state information DINF51-1, the information processing system 1 updates the slot value of the slot “location” from “Asahikawa” to “Furano” in the domain goal “Outing-QA”. An analysis result AN52 illustrated in FIG. 18 includes the dialogue state information DINF52 corresponding to the domain goal “Restaurant-Search”, and includes the dialogue state information DINF51-1 about the domain goal “Outing-QA” updated according to the utterance PA51.

Then, using Equation (1) given earlier, the information processing system 1 calculates the certainty factors of the updated domain goal “Outing-QA” and the slot values. Thus, using Equation (1) given earlier, as illustrated in the analysis result AN52 in FIG. 18, the information processing system 1 calculates the certainty factor of the domain goal “Outing-QA” representing a first-type element (i.e., calculates a first-type certainty factor) to be equal to “0.65”. Moreover, using Equation (1) given earlier, as illustrated in the analysis result AN52 in FIG. 18, the information processing system 1 calculates the certainty factor of the slot value “weekend” representing a second-type element (i.e., calculates a second-type certainty factor) to be equal to “0.9”. Furthermore, using Equation (1) given earlier, as illustrated in the analysis result AN52 in FIG. 18, the information processing system 1 calculates the certainty factor of the slot value “Furano” representing a second-type element (i.e., calculates a second-type certainty factor) to be equal to “0.7”. Meanwhile, alternatively, the information processing system 1 can calculate the certainty factors of only the updated elements.

Then, the information processing system 1 decides to treat the domain goal “Outing-QA” and the slot value “Furano”, which have the certainty factors smaller than the threshold value “0.8”, as the highlighting targets. Thus, the information processing system 1 displays the domain goal “Outing-QA” and the slot value “Furano” in a highlighted manner.

In this way, in the example illustrated in FIG. 18, at an analysis timing or at a reanalysis timing, the information processing system 1 treats, as the updating targets, the domain goals and the slot values that are estimated in the past. As a result, the information processing system 1 can update the already-estimated domain goals and the already-estimated slot values based on the information that is of the future with reference to the points of time of past estimation. Hence, the information processing system 1 becomes able to estimate the domain goal in a more appropriate manner.

[1-10-3. Constraints attributed to correction]

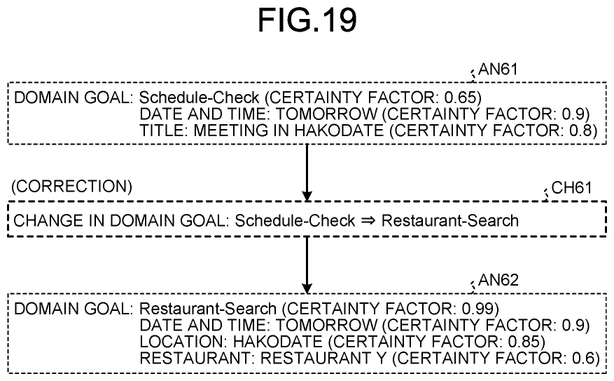

Explained below with reference to FIG. 19 are the constraints attributed to the correction made by the user. FIG. 19 is a diagram illustrating an example of updating the information according to the correction made by the user. More particularly, FIG. 18 is a diagram illustrating updating (modification) of the domain goal and the slot values as performed by the information processing system 1 according to the correction made by the user. The operations illustrated in FIG. 19 can be performed by any device included in the information processing system 1, such as either by the information processing device 100 or by the display device 10.

In the example illustrated in FIG. 19, a user U61 makes an utterance saying “speaking of Hakodate, there is this restaurant Y” (hereinafter, referred to as an “utterance PA61”), and then makes an utterance saying “tomorrow, I have a meeting in Hakodate” (hereinafter, referred to as an “utterance PA62”). Then, the information processing system 1 analyzes the utterance PA62 of the user U61 and the corresponding sensor information, and estimates the dialogue state of the user U61 corresponding to the utterance PA62. Based on the analysis result indicating that the utterance PA62 has contents related to a meeting in Hakodate on the next day, the information processing system 1 estimates that the dialogue state of the user U61 is related to the confirmation of the schedule. Accordingly, the information processing system 1 estimates that the domain goal “Schedule-Check” related to the confirmation of the schedule represents the domain goal indicating the dialogue state of the user U61.

Moreover, the information processing system 1 analyzes the utterance PA62 and the corresponding sensor information, and estimates the slot values of the slots included in the domain goal “Schedule-Check”. Based on the analysis result indicating that the utterance PA62 has contents related to the confirmation of the schedule on the next day, the information processing system 1 estimates that the slot “date and time” has the slot value “tomorrow” and that the slot “title” has the slot value “meeting in Hakodate”.

Then, the information processing system 1 calculates the certainty factors of the elements related to the dialogue state of the user U61 of the dialogue system. In the example illustrated in FIG. 19, the information processing system 1 calculates the certainty factor of the domain goal “Schedule-Check” that represents a first-type element indicating the dialogue state of the user U61 (i.e., calculates a first-type certainty factor). Moreover, the information processing system 1 calculates the certainty factors of the slots “tomorrow” and “meeting in Hakodate” that represent the second-type elements belonging to the lower hierarchy of the first-type element represented by the domain goal “Schedule-Check” (i.e., calculates second-type certainty factors).

For example, using Equation (1) given earlier, the information processing system 1 calculates the certainty factors of the domain goal and the slot values. Thus, using Equation (1) given earlier, as illustrated in an analysis result AN61 in FIG. 19, the information processing system 1 calculates the certainty factor of the domain goal “Schedule-Check” representing a first-type element (i.e., calculates a first-type certainty factor) to be equal to “0.65”. Moreover, using Equation (1) given earlier, as illustrated in the analysis result AN61 in FIG. 19, the information processing system 1 calculates the certainty factor of the slot value “tomorrow” representing a second-type element (i.e., calculates a second-type certainty factor) to be equal to “0.9”. Furthermore, using Equation (1) given earlier, as illustrated in the analysis result AN61 in FIG. 19, the information processing system 1 calculates the certainty factor of the slot value “meeting in Hakodate” representing a second-type element (i.e., calculates a second-type certainty factor) to be equal to “0.8”.

Then, based on the calculated certainty factors of the elements, the information processing system 1 decides on the targets for highlighted display (the highlighting targets). Herein, if an element has the certainty factor smaller than the threshold value “0.8”, then the information processing system 1 decides to treat that element as a highlighting target. Since the certainty factor “0.65” of the domain goal “Schedule-Check” is smaller than the threshold value “0.8”, the information processing system 1 decides to treat the domain goal “Schedule-Check” as the highlighting target. Then, the information processing system 1 highlights the domain goal “Schedule-Check”.

Subsequently, the information processing system 1 receives a correction made by the user U61. With reference to FIG. 19, the user U61 makes an utterance saying “instead of checking the schedule, find a restaurant” (hereinafter, referred to as an “utterance PA63”). Then, the information processing system 1 analyzes the utterance PA63 and the corresponding sensor information, and estimates that the utterance PA63 was made by the user for requesting a correction. In the example illustrated in FIG. 19, the information processing system 1 analyzes the utterance PA63 and identifies that the user U61 is requesting to change the domain goal related to the confirmation of the schedule to the domain goal related to a restaurant search. Hence, the information processing system 1 identifies that, as illustrated in correction information CH61, the utterance PA63 of the user U61 represents information for requesting correction of the domain goal “Schedule-check” to the domain goal “Restaurant-Search”.

Then, with the user-corrected items serving as the constraints, the information processing system 1 reanalyzes the other items. In the example illustrated in FIG. 19, since the user U61 has changed the domain goal from “Schedule-Check” to “Restaurant-Search”, the information processing system 1 performs reanalysis while treating the post-correction domain goal “Restaurant-Search” as the unchangeable item, and estimates the other information. In that case, while treating the post-correction domain goal “Restaurant-Search” as the unchangeable item, the information processing system 1 estimates the slots “date and time”, “location”, and “restaurant name” of the domain goal “Restaurant-Search”.

For example, in the state in which the domain goal has been changed to “Restaurant-Search”, based on the analysis result of the utterance PA63, based on the past utterances PA61 and PA12, and based on the past analysis result AN61; the information processing system 1 estimates the slot values of the slots included in the domain goal “Restaurant-Search”. In an identical manner to the operations illustrated in FIG. 15, the information processing system 1 uses the slot value “tomorrow” of the slot “date and time” of the domain goal “Schedule-Check” as the slot value of the slot “date and time” of the post-change domain goal “Restaurant-Search”. Moreover, of the slot value “meeting in Hakodate” of the slot “title” of the domain goal “Schedule-Check”, the information processing device 100 uses the word “Hakodate” as the slot value of the slot “location” of the post-change “Restaurant-Search”. Furthermore, based on the utterance PA61 that was made before the utterance PA63, the information processing system 1 estimates that the slot “restaurant name” has the slot value “restaurant Y”. Herein, based on the analysis result indicating that the utterance PA61 is “speaking of Hakodate, there is this restaurant Y” having the contents related to the restaurant Y in Hakodate, the information processing system 1 estimates that the slot “restaurant name” has the slot value “restaurant Y”.

In this way, as illustrated in an analysis result AN62, the information processing system 1 estimates that, in the domain goal “Restaurant-Search”, the slot “date and time” has the slot value “tomorrow”, the slot “location” has the slot value “Hakodate”, and the slot “restaurant name” has the slot value “restaurant Y”.

Then, the information processing system 1 calculates the certainty factors of the elements related to the dialogue state of the user U61 of the dialogue system. In the example illustrated in FIG. 19, the information processing system 1 calculates the certainty factor of the domain goal “Restaurant-Search” that represents a first-type certainty factor indicating the dialogue state of the user U61 (i.e., calculates a first-type certainty factor). Moreover, the information processing system 1 calculates the certainty factors of the slot values “tomorrow”, “Hakodate”, and “restaurant Y” that represent the second-type elements belonging to the lower hierarchy of the first-type element represented by the domain goal “Restaurant-Search” (i.e., calculates second-type certainty factors).

For example, using Equation (1) given earlier, the information processing system 1 calculates the certainty factors of the domain goal and the slot values. Thus, using Equation (1) given earlier, as illustrated in the analysis result AN62 in FIG. 19, the information processing system 1 calculates the certainty factor of the domain goal “Restaurant-Search” representing a first-type element (i.e., calculates a first-type certainty factor) to be equal to “0.99”. Herein, regarding a user-corrected element, the information processing system 1 can set the certainty factor to a predetermined value (such as 0.99).

Moreover, using Equation (1) given earlier, as illustrated in the analysis result AN62 in FIG. 19, the information processing system 1 calculates the certainty factor of the slot value “tomorrow” representing a second-type element (i.e., calculates a second-type certainty factor) to be equal to “0.9”. Furthermore, using Equation (1) given earlier, as illustrated in the analysis result AN62 in FIG. 19, the information processing system 1 calculates the certainty factor of the slot value “Hakodate” representing a second-type element (i.e., calculates a second-type certainty factor) to be equal to “0.85”. Moreover, using Equation (1) given earlier, as illustrated in the analysis result AN62 in FIG. 19, the information processing system 1 calculates the certainty factor of the slot value “restaurant Y” representing a second-type element (i.e., calculates a second-type certainty factor) to be equal to “0.6”.

Then, based on the calculated certainty factors of the elements, the information processing system 1 decides on the targets for highlighted display (the highlighting targets). If an element has the certainty factor to be smaller than the threshold value “0.8”, then the information processing system 1 decides to treat that element as the highlighting target.

Since the certainty factor “0.99” of the domain goal “Restaurant-Search” is equal to or greater than the threshold value “0.8”, the information processing system 1 decides not to treat the domain goal “Restaurant-Search” as the highlighting target.

Moreover, since the certainty factor of “0.9” of the slot value “tomorrow” is equal to or greater than the threshold value “0.8”, the information processing system 1 decides not to treat the slot value “tomorrow” as the highlighting target. Furthermore, since the certainty factor of “0.85” of the slot value “Hakodate” is equal to or greater than the threshold value “0.8”, the information processing system 1 decides not to treat the slot value “Hakodate” as the highlighting target. On the other hand, since the certainty factor “0.6” of the slot value “restaurant Y” is smaller than the threshold value “0.8”, as illustrated in the decision result information RINF1 in FIG. 19, the information processing system 1 decides to treat the slot value “restaurant Y” as the highlighting target.

In this way, the information processing system 1 decides to treat the slot value “restaurant Y”, which has a low certainty factor, as the highlighting target. Then, the information processing system 1 highlights the slot value “restaurant Y”.

[1-10-4 Sensor information]

As explained above, the information processing system 1 uses a variety of information and estimates the information related to the dialogue state of the user. Given below is the explanation of an example in which the dialogue state of the user is estimated using the sensor information.

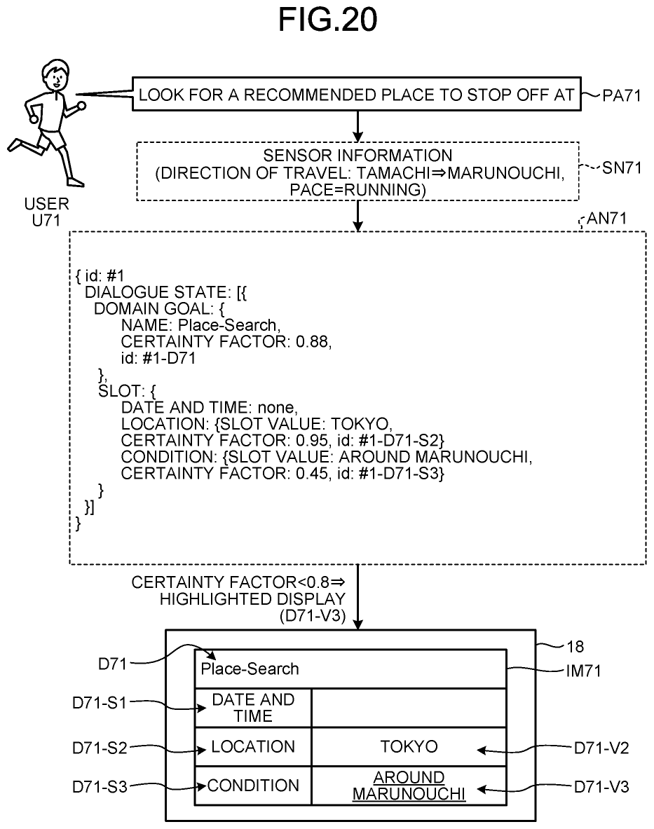

Firstly, explained with reference to FIG. 20 is an example of estimating the dialogue state using the position information (sensor information) that indicates the position of the user. FIG. 20 is a diagram illustrating an example of estimating the dialogue state based on the sensor information. The operations illustrated in FIG. 20 can be performed by any device included in the information processing system 1, such as either by the information processing device 100 or by the display device 10.

With reference to FIG. 20, a user U71 makes an utterance. For example, the user U71 makes an utterance saying “look for a recommended place to stop off at” (hereinafter, referred to as an “utterance PA71”). The information processing system 1 uses a sound sensor and detects the voice information of the utterance PA71 (also simply referred to as the “utterance PA71”) indicating “look for a recommended place to stop off at”. That is, the information processing system 1 detects the utterance PA71, which indicates “look for a recommended place to stop off at”, as the input. Moreover, the information processing system 1 detects a variety of sensor information such as position information, acceleration information, and image information. In the example illustrated in FIG. 20, the information processing system 1 detects corresponding sensor information SN71, such as position information and acceleration information, indicating that the user U71 is headed from Tamachi to Marunouchi at the pace of running.

Thus, the information processing system 1 obtains the utterance PA71 and the corresponding sensor information SN71 from the information processing system 1. Then, the information processing system 1 analyzes the utterance PA71 and the corresponding sensor information SN71, and estimates the dialogue state of the user U71 corresponding to the utterance PA71. In the example illustrated in FIG. 20, the information processing system 1 analyzes the utterance PA71 and the corresponding sensor information SN71, and identifies that the utterance PA71 made by the user U71 has contents related to a search for a stop-off destination (spot). As a result, the information processing system 1 estimates that “Place-Search” related to a search for a stop-off destination represents the domain goal indicating the dialogue state of the user U71.

Moreover, the information processing system 1 analyzes the utterance PA71 and the corresponding sensor information SN71, and estimates the slot values of the slots included in the domain goal “Place-Search”. Based on the analysis result indicating that the utterance PA71 has contents related to the recommendation of a stop-off destination and that the corresponding sensor information indicates the state of running from Tamachi toward Marunouchi, the information processing system 1 estimates that the slot “location” has the slot value “Tokyo” and estimates that a slot “condition” has a slot value “around Marunouchi”. Meanwhile, since information related to the date and time is not included in the utterance PA71, the information processing system 1 estimates that the slot “date and time” has the slot value “- (unclear)”. Alternatively, the information processing system 1 can estimate that the slot “date and time” has the slot value indicating the point of time of detection of the utterance PA71 (i.e., has a slot value “present time”). Meanwhile, in the example illustrated in FIG. 20, although the slot “condition” has only one slot value associated thereto, it can have a plurality of slot values associated thereto. In this way, in slots such as the slot “condition”, a plurality of values can be associated as keywords. Moreover, even if a single slot has a plurality of slot values associated thereto, as long as there is no dependence relationship among the slot values, each slot value can be independently treated as the processing target during corrections.

Then, the information processing system 1 calculates the certainty factors of the elements related to the dialogue state of the user U71 of the dialogue system. In the example illustrated in FIG. 20, the information processing system 1 calculates the certainty factor of the domain goal “Place-Search” that represents a first-type element indicating the dialogue state of the user U71 (i.e., calculates a first-type certainty factor). Moreover, the information processing system 1 calculates the certainty factors of the slot values “Tokyo” and “around Marunouchi” that represent the second-type elements belonging to the lower hierarchy of the first-type element represented by the domain goal “Place-Search” (i.e., calculates second-type certainty factors).

For example, using Equation (1) given earlier, the information processing system 1 calculates the certainty factors of the domain goal and the slot values. Thus, using Equation (1) given earlier, as illustrated in an analysis result AN71 in FIG. 20, the information processing system 1 calculates the certainty factor of the domain goal “Place-Search” representing a first-type element (i.e., calculates a first-type certainty factor) to be equal to “0.88”. Moreover, using Equation (1) given earlier, as illustrated in the analysis result AN71 in FIG. 20, the information processing system 1 calculates the certainty factor of the slot value “Tokyo” representing a second-type element (i.e., calculates a second-type certainty factor) to be equal to “0.95”. Furthermore, using Equation (1) given earlier, as illustrated in the analysis result AN71 in FIG. 20, the information processing system 1 calculates the certainty factor of the slot value “around Marunouchi” representing a second-type element (i.e., calculates a second-type certainty factor) to be equal to “0.45”.

Then, the information processing system 1 decides to treat the slot value “around Marunouchi”, which has the certainty factor smaller than the threshold value “0.8”, as the highlighting target. Thus, the information processing system 1 decides to treat the slot value “around Marunouchi”, which has a low certainty factor, as the highlighting target.

Subsequently, the information processing system 1 highlights the slot value “around Marunouchi”. In the example illustrated in FIG. 20, the information processing system 1 generates an image IM71 in which the character string “around Marunouchi” of a slot value D71-V3 is underlined. The information processing device 100 generates the image IM71 that includes a domain goal D71 representing the domain goal “Place-Search”. Moreover, the information processing device 100 generates the image IM71 that includes a slot D71-S1 representing the slot “date and time”, a slot D71-S2 representing the slot “location”, and a slot D71-S3 representing the slot “condition”. Thus, the information processing device 100 generates the image IM71 that includes the slot value D71-V2 representing the slot value “Tokyo” and includes the slot value D71-V3 representing the slot value “around Marunouchi”. Meanwhile, since the slot value corresponding to the slot “date and time” could not be estimated, the information processing device 100 generates the image IM71 that does not include the slot value of the slot “date and time”.

Then, the information processing system 1 displays the image IM71, in which the character string “around Marunouchi” of the slot value D71-V3 is underlined, in the display unit 18.

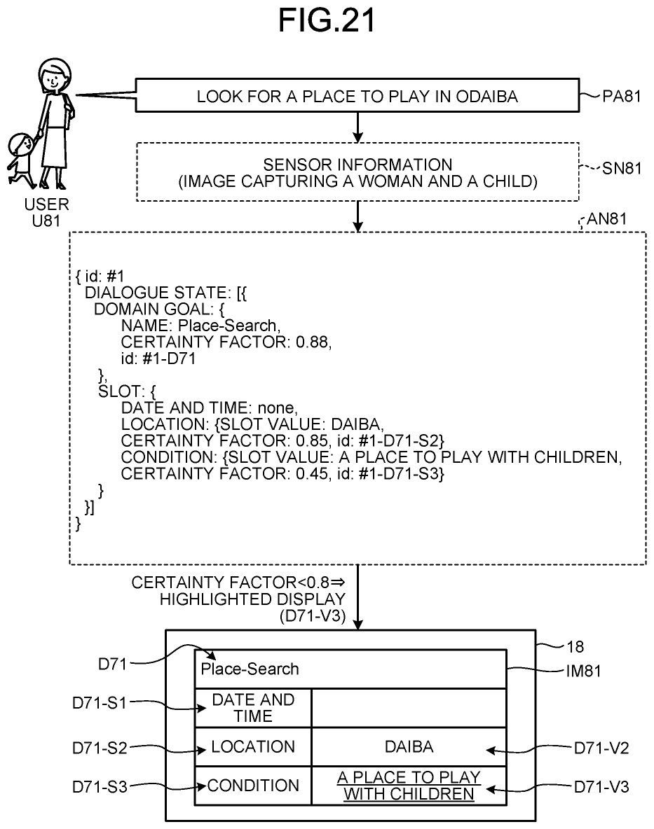

Explained below with reference to FIG. 21 is an example of estimating the dialogue state using image information (sensor information). FIG. 21 is a diagram illustrating an example of estimating the dialogue state based on the sensor information. The operations illustrated in FIG. 21 can be performed by any device included in the information processing system 1, such as either by the information processing device 100 or by the display device 10.

With reference to FIG. 21, a user U81 makes utterances. For example, the user U81 makes an utterance saying “look for a place to play in Odaiba” (hereinafter, referred to as an “utterance PA81”). The information processing system 1 uses a sound sensor and detects voice information of the utterance PA81 (also simply referred to as the “utterance PA81”) indicating “look for a place to play in Odaiba”. Thus, the information processing system 1 detects the utterance PA81, which indicates “look for a place to play in Odaiba”, as the input. Moreover, the information processing system 1 detects a variety of sensor information such as the image information. In the example illustrated in FIG. 21, the information processing system 1 detects corresponding sensor information SN81 such as image information that is obtained as a result of taking an image of a woman, who represents the user U81, and a child.

In this way, the information processing system obtains the utterance PA81 and the corresponding sensor information SN81 from within. Then, the information processing system 1 analyzes the utterance PA81 and the corresponding sensor information SN81, and estimates the dialogue state of the user U81 corresponding to the utterance PA81. In the example illustrated in FIG. 21, the information processing system 1 analyzes the utterance PA81 and the corresponding sensor information SN81, and identifies that the utterance PA81 of the user U81 has the contents related to a search for a stop-off destination (spot). As a result, the information processing system 1 estimates that “Place-Search” related to a search for a stop-off destination represents the domain goal indicating the dialogue state of the user U81.

Moreover, the information processing system 1 analyzes the utterance PA81 and the corresponding sensor information SN81, and estimates the slot values of the slots included in the domain goal “Place-Search”. Based on the analysis result indicating that the utterance PA81 has contents related to the recommendation of a stop-off destination and that the corresponding sensor information SN81 points to the fact that the user U81 is accompanied by a child, the information processing system 1 estimates that the slot “location” has the slot value “Daiba” and estimates that the slot “condition” has a slot value “a place to play with children”. Meanwhile, since information related to the date and time is not included in the utterance PA81, the information processing system 1 estimates that the slot “date and time” has the slot value “- (unclear)”. Alternatively, the information processing system 1 can estimate that the slot “date and time” has the slot value indicating the point of time of detection of the utterance PA81 (i.e., has the slot value “present time”).

Then, the information processing system 1 calculates the certainty factors of the elements related to the dialogue state of the user U81 of the dialogue system. In the example illustrated in FIG. 21, the information processing system 1 calculates the certainty factor of the domain goal “Place-Search” that represents a first-type element indicating the dialogue state of the user U81 (i.e., calculates a first-type certainty factor). Moreover, the information processing system 1 calculates the certainty factors of the slot values “Daiba” and “a place to play with children” that represent the second-type elements belonging to the lower hierarchy of the first-type element represented by the domain goal “Place-Search” (i.e., calculates second-type certainty factors).

For example, using Equation (1) given earlier, the information processing system 1 calculates the certainty factors of the domain goal and the slot values. Thus, using Equation (1) given earlier, as illustrated in an analysis result AN81 in FIG. 21, the information processing system 1 calculates the certainty factor of the domain goal “Place-Search” representing a first-type element (i.e., calculates a first-type certainty factor) to be equal to “0.88”. Moreover, using Equation (1) given earlier, as illustrated in the analysis result AN81 in FIG. 21, the information processing system 1 calculates the certainty factor of the slot value “Daiba” representing a second-type element (i.e., calculates a second-type certainty factor) to be equal to “0.85”. Furthermore, using Equation (1) given earlier, as illustrated in the analysis result AN81 in

FIG. 21, the information processing system 1 calculates the certainty factor of the slot value “a place to play with children” representing a second-type element (i.e., calculates a second-type certainty factor) to be equal to “0.45”.

Then, the information processing system 1 decides to treat the slot value “a place to play with children”, which has the certainty factor smaller than the threshold value “0.8”, as the highlighting target. Thus, the information processing system 1 decides to treat the slot value “a place to play with children”, which has a low certainty factor, as the highlighting target.

Then, the information processing system 1 highlights the slot value “a place to play with children”. In the example illustrated in FIG. 21, the information processing system 1 generates an image IM81 in which the character string “a place to play with children” of the slot value D71-V3 is underlined. The information processing device 100 generates the image IM81 that includes the domain goal D71 representing the domain goal “Place-Search”. Moreover, the information processing device 100 generates the image IM81 that includes the slot D71-S1 representing the slot “date and time”, the slot D71-S2 representing the slot “location”, and the slot D71-S3 representing the slot “condition”. Thus, the information processing device 100 generates the image IM81 that includes the slot value D71-V2 representing the slot value “Daiba” and includes the slot value D71-V3 representing the slot value “a place to play with children”. Meanwhile, since the slot value corresponding to the slot “date and time” could not be estimated, the information processing device 100 generates the image IM81 that does not include the slot value of the slot “date and time”.

Then, the information processing system 1 displays the image IM81, in which the character string “a place to play with children” of the slot value D71-V3 is underlined, in the display unit 18.

[1-11. Hierarchized Slots]

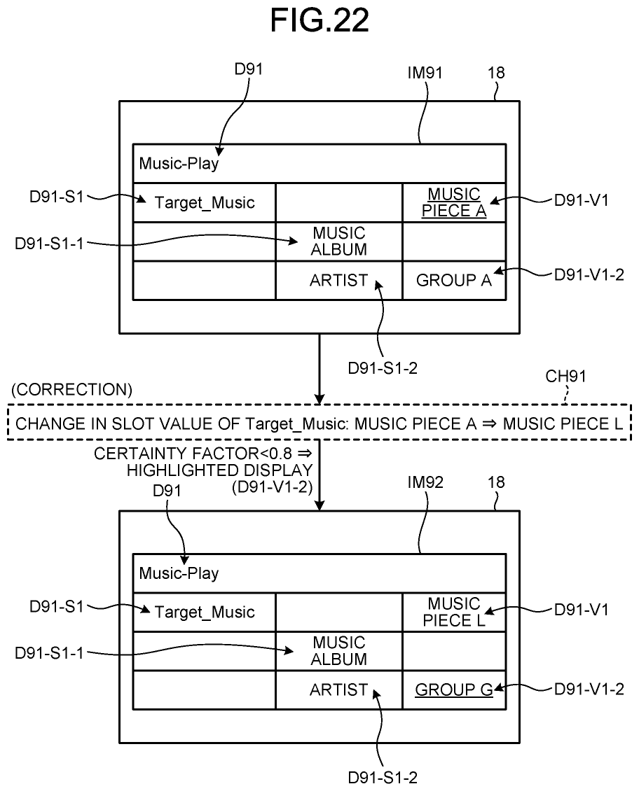

In the examples explained above, the slots belonging to a domain goal did not have a hierarchical relationship among themselves. Alternatively, the slots belonging to a domain goal can have a hierarchical relationship among themselves. That is, each slot belonging to a domain goal can have a relative hierarchical relationship, such as being in an upper level or a lower level, with respect to another slot. In other words, the slot value corresponding to each slot can have a relative hierarchical relationship, such as being in an upper level or a lower level, with respect to another slot value. Thus, when a particular slot value is updated, based on the hierarchical relationship among the slots, the other slot values can also get updated (changed). This point is explained below with reference to FIGS. 22 to 24.

[1-11-1. Correction of Hierarchized Slots]

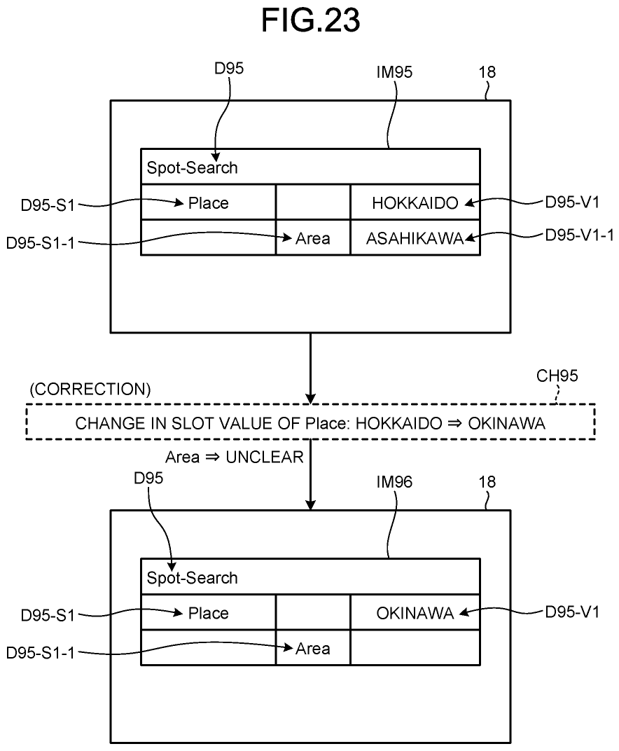

Firstly, explained below with reference to FIGS. 22 and 23 is an example in which, when a slot value is updated, the other slot values get updated. FIGS. 22 and 23 are diagrams illustrating an example in which, in response to the correction of a particular slot value, the other slot values get updated. The operations illustrated in FIGS. 22 and 23 can be performed by any device included in the information processing system 1, such as either by the information processing device 100 or by the display device 10.

Firstly, with reference to FIG. 22, based on an utterance made by a user U91 in regard to music playback (hereinafter, referred to as an “utterance PA91”), the information processing system 1 estimates that “Music-Play” related to music playback represents the domain goal indicating the dialogue state of the user U91. Moreover, the information processing system 1 analyzes the utterance PA91 and the corresponding sensor information, and estimates the slot value of each slot included in the domain goal “Music-Play”.

Herein, among the slots of the domain goal “Music-Play”, a slot “Target_Music” belongs to the slots of the uppermost hierarchy (first-level slots). To the slot “Target_Music” representing a first-level slot, a value enabling identification of the music piece to be played, such as the name of the music piece, is assigned as the slot value.

The slots belonging to the immediate lower hierarchy of the slot “Target_Music” representing a first-level slot (i.e., second-level slots) include slots “music album” and “artist”. Thus, the second-level slots belonging to the lower level of the slot “Target_Music” representing a first-level slot include the slots corresponding to the attributes (properties) related to the slot “Target_Music”. The slot “music album” representing a second-level slot has such a value assigned thereto which enables identification of the music album in which the music piece indicated by the slot value of the upper level slot “Target_Music” is recorded. Moreover, the slot “artist” representing a second-level slot has such a value assigned thereto which enables identification of the artist, such as the singer, who performed the music piece indicated by the slot value of the upper level slot “Target_Music”.

Based on the analysis result indicating that the character string representing a music piece A is included in the utterance PA91, the information processing system 1 estimates that the slot “Target_Music” has a slot value “music piece A”. Then, based on the slot value “music piece A” of the slot “Target_Music” and based on knowledge information obtained from a knowledge base such as a predetermined music database, the information processing system 1 estimates that the slot “artist” has a slot value “music group A”. Moreover, in the example illustrated in FIG. 22, on account of the fact that the slot value “music piece A” of the slot “Target_Music” has been recorded in a plurality of music albums, the information processing system 1 estimates that the slot “music album” has the slot value “- (unclear)”.

Subsequently, the information processing system 1 calculates the certainty factors of the elements related to the dialogue state of the user U91 of the dialogue system. In the example illustrated in FIG. 22, the information processing system 1 calculates the certainty factor of the domain goal “Music-Play” that represents a first-type element indicating the dialogue state of the user U91 (i.e., calculates a first-type certainty factor). Moreover, the information processing system 1 calculates the certainty factor of the slot value “music piece A” of the first-level slot “Target_Music” and the certainty factor of the slot value “music group A” of the second-level slot “artist” of the domain goal “Music-Play” (i.e., calculates second-type certainty factors).

For example, using Equation (1) given earlier, the information processing system 1 calculates the certainty factors of the domain goal and the slot values. In the example illustrated in FIG. 22, the information processing system 1 calculates the certainty factor of the slot value “music piece A” to be smaller than the threshold value. Hence, the information processing system 1 decides to treat the slot value “music piece A” as the highlighting target.

Then, the information processing system highlights the slot value “music piece A”. In the example illustrated in FIG. 22, the information processing system 1 generates an image IM91 in which the character string “music piece A” of a slot value D91-V1 is underlined. The information processing system 1 generates the image IM91 that includes a domain goal D91 representing the domain goal “Music-Play”, a slot D91-S1 representing the first-level slot “Target_Music”, a slot D91-S1-1 representing the second-level slot “music album”, and a slot D91-S1-2 representing the second-level slot “artist”. Moreover, the information processing system 1 generates the image IM91 that includes a slot value D91-V1 representing the slot value “music piece A” and a slot value D91-V1-2 representing the slot value “music group A”. Then, the information processing system 1 displays the image IM91, in which the character string “music piece A” of the slot value D91-V1 is underlined, in the display unit 18.

Subsequently, the information processing system 1 receives a correction from the user U91 with respect to the highlighted slot value “music piece A” of the first-level slot “Target_Music”. With reference to FIG. 22, the information processing system 1 obtains correction information indicating that the user U91 has corrected the slot value of the first-level slot “Target_Music” from “music piece A” to “music piece L”. For example, based on an utterance made by the user U91 saying “play the music piece L” (hereinafter, referred to as an “utterance PA92”), the information processing system 1 identifies that the user correction is about changing the slot value of the first-level slot “Target_Music” from “music piece A” to “music piece L”. In this way, the information processing device 100 identifies that, as illustrated in correction information CH91, the user U11 has requested a correction of the slot value of the first-level slot “Target_Music” from “music piece A” to “music piece L”.

Subsequently, because of the updating of the slot value of the first-level slot “Target_Music”, the information processing system 1 also updates the slot values of the slots belonging to the lower hierarchy of the first-level slot “Target_Music”. Thus, based on the correction, the information processing system 1 decides on the modification targets from among the other elements other than the corrected element. In this case, based on the correction of the slot value of the first-level slot “Target_Music”, apart from the corrected slot value of the first-level slot “Target_Music”, the information processing system 1 decides to treat the slot values of the second-level slots “music album” and “artist” as the modification targets. Thus, the information processing system 1 updates the slot values also of the second-level slots “music album” and “artist” belonging to the lower hierarchy of the first-level slot “Target_Music”.

For example, based on the slot value “music piece L” of the slot “Target_Music” and based on knowledge information obtained from a knowledge base such as a predetermined music database, the information processing system 1 estimates that the slot “artist” has a slot value “singer G”. In this way, if any one particular slot value is corrected, the information processing system 1 also performs reanalysis of the other slot values that are affected by the correction.

Then, the information processing system 1 calculates the certainty factors of the elements related to the dialogue state of the user U91 of the dialogue system. In the example illustrated in FIG. 22, the information processing system 1 calculates the certainty factor of the domain goal “Music-Play” representing a first-type element of the dialogue state of the user U91 (i.e., calculates a first-type certainty factor). Moreover, the information processing system 1 calculates the certainty factor of the slot value “music piece L” of the first-level slot “Target_Music” and the certainty factor of the slot value “singer G” of the second-level slot “artist” of the domain goal “Music-Play” (i.e., calculates second-type certainty factors).

For example, using Equation (1) given earlier, the information processing system 1 calculates the certainty factors of the domain goal and the slot values. In the example illustrated in FIG. 22, the information processing system 1 calculates the certainty factor of the slot value “singer G” to be smaller than the threshold value. Hence, the information processing system 1 decides to treat the slot value “singer G” as the highlighting target.

Then, the information processing system 1 highlights the slot value “singer G”. In the example illustrated in FIG. 22, the information processing system 1 generates an image IM92 in which the character string “singer G” of the slot value D91-V1-2 is underlined. The information processing system 1 generates the image IM92 that includes the domain goal D91 representing the domain goal “Music-Play”, the slot D91-S1 representing the first-level slot “Target_Music”, the slot D91-S1-1 representing the second-level slot “music album”, and the slot D91-S1-2 representing the second-level slot “artist”. Moreover, the information processing system 1 generates the image IM92 that includes the slot value D91-V1 representing the slot value “music piece L” and the slot value D91-V1-2 representing the slot value “singer G”. Then, the information processing system 1 displays the image IM92, in which the character string “singer G” of the slot value D91-V1-2 is underlined, in the display unit 18.

With reference to FIG. 23, based on an utterance made by a user U95 related to a search for a spot (hereinafter, referred to as an “utterance PA95”), the information processing system 1 estimates that “Spot-Search” related to a search for a spot represents the domain goal indicating the dialogue state of the user U95. Moreover, the information processing system 1 analyzes the utterance PA95 and the corresponding sensor information, and estimates the slot values of the slots included in the domain goal “Spot-Search”.

Herein, among the slots of the domain goal “Spot-Search”, a slot “Place” belongs to the slots of the uppermost hierarchy (first-level slots). To the slot “Place” representing a first-level slot, a value enabling identification of, for example, the uppermost range indicating a spot is assigned as the slot value. In the example illustrated in FIG. 23, the search is meant for a spot located in Japan, and the uppermost range represents the prefecture level.

The slots belonging to the immediate lower hierarchy of the slot “Place” representing a first-level slot (i.e., second-level slots) include a slot “Area”. Thus, the second-level slot belonging to the lower level of the slot “Place” representing a first-level slot includes the slot corresponding to the more detailed spot within the range of the slot “Place”. The slot value of the slot “Area” representing a second-level slot is assigned with a value enabling identification of the area within the prefecture indicated by the slot value of the upper-level slot “Place”.

Based on the analysis result of the contents of the utterance PA95, the information processing system 1 estimates that the slot “Place” has a slot value “Hokkaido” and the slot “Area”, which indicates an area obtained by further narrowing down the search in Hokkaido, has the slot value “Asahikawa”.

Then, the information processing system 1 calculates the certainty factors of the elements related to the dialogue state of the user U95 of the dialogue system. In the example illustrated in FIG. 23, the information processing system 1 calculates the certainty factor of the domain goal “Spot-Search” that represents a first-type element indicating the dialogue state of the user U95 (i.e., calculates a first-type certainty factor). Moreover, the information processing system 1 calculates the certainty factor of the slot value “Hokkaido” of the first-level slot “Place” and the certainty factor of the slot value “Asahikawa” of the second-level slot “Area” of the domain goal “Spot-Search” (i.e., calculates second-type certainty factors).

For example, using Equation (1) given earlier, the information processing system 1 calculates the certainty factors of the domain goal and the slot values. In the example illustrated in FIG. 23, the information processing system 1 calculates the certainty factors of the domain goal and the slot values to be equal to or greater than the threshold value. Hence, the information processing system 1 decides that there is no target for highlighted display.

The information processing system 1 generates an image IM95 that includes a domain goal D95 representing the domain goal “Spot-Search”, a slot D95-S1 representing the first-level slot “Place”, and a slot D95-S1-1 representing a second-level slot “Area”. Moreover, the information processing system 1 generates the image IM95 that includes a slot value D95-V1 representing the slot value “Hokkaido” and a slot value D95-V1-2 representing the slot value “Asahikawa”. Then, the information processing system 1 displays the image IM95 in the display unit 18.

Subsequently, the information processing system 1 receives a correction made by the user U95 with respect to the highlighted slot value “Hokkaido” of the first-level slot “Place”. With reference to FIG. 23, the information processing system 1 obtains correction information indicating that the user U95 has corrected the slot value of the first-level slot “Place” from “Hokkaido” to “Okinawa”. For example, based on an utterance made by the user U95 saying “I wish to go to Okinawa” (hereinafter, referred to as an “utterance PA96”), the information processing system 1 identifies that the user correction is about changing the slot value of the first-level slot “Place” from “Hokkaido” to “Okinawa”. In this way, as illustrated in correction information CH95, the information processing device 100 identifies that the correction made by the user U11 is about requesting a correction of the slot value of the first-level slot “Place” from “Hokkaido” to “Okinawa”.

Subsequently, because of the updating of the slot value of the first-level slot “Place”, the information processing system 1 also updates the slot values of the slots belonging to the lower hierarchy of the first-level slot “Place”. In this case, the information processing system 1 also updates the slot value of the second-level slot “Area” belonging to the lower hierarchy of the first-level slot “Place”. Thus, since the first-level slot “Place” and the second-level slot “Area” are in a hierarchical relationship, the information processing system 1 updates the slot values of both slots. In this way, based on the correction, the information processing system 1 decides on the modification targets from among the other elements other than the corrected element. In this case, based on the correction of the slot value of the first-level slot “Place”, apart from the corrected slot value of the first-level slot “Place”, the information processing system 1 decides to treat the slot value of the second-level slot “Area” as the modification target.

For example, since information indicating an area in Okinawa is not included in the utterance PA96 or the utterance

PA95, the information processing system 1 estimates the slot value of the area “Area” to be “- (unclear)”. In this way, if any one particular slot value is corrected, the information processing system 1 also performs reanalysis of the other slot values that are affected by the correction.

Then, the information processing system 1 calculates the certainty factors of the elements related to the dialogue state of the user U95 of the dialogue system. In the example illustrated in FIG. 23, the information processing system 1 calculates the certainty factor of the domain goal “Spot-Search” representing a first-type element of the dialogue state of the user U95 (i.e., calculates a first-type certainty factor). Moreover, the information processing system 1 calculates the certainty factor of the slot value “Okinawa” of the first-level slot “Place” of the domain goal “Spot-Search) (i.e., calculates a second-type certainty factor).

For example, using Equation (1) given earlier, the information processing system 1 calculates the certainty factors of the domain goal and the slot value. In the example illustrated in FIG. 23, the information processing system 1 calculates the certainty factors of the domain goal and the slot values to be equal to or greater than the threshold value. Hence, the information processing system 1 decides that there is no target for highlighted display.

Then, the information processing system 1 generates an image IM92 that includes the domain goal D95 representing the domain goal “Spot-Search”, the slot D95-S1 representing the first-level slot “Place”, and the slot D95-S1-1 that includes the second-level slot “Area”. Moreover, the information processing system 1 generates the image IM96 that includes the slot value D95-V1 representing the slot value “Okinawa”. Then, the information processing system 1 displays the image IM96 in the display unit 18.

[1-11-2. Data Structure of Hierarchized Slots]

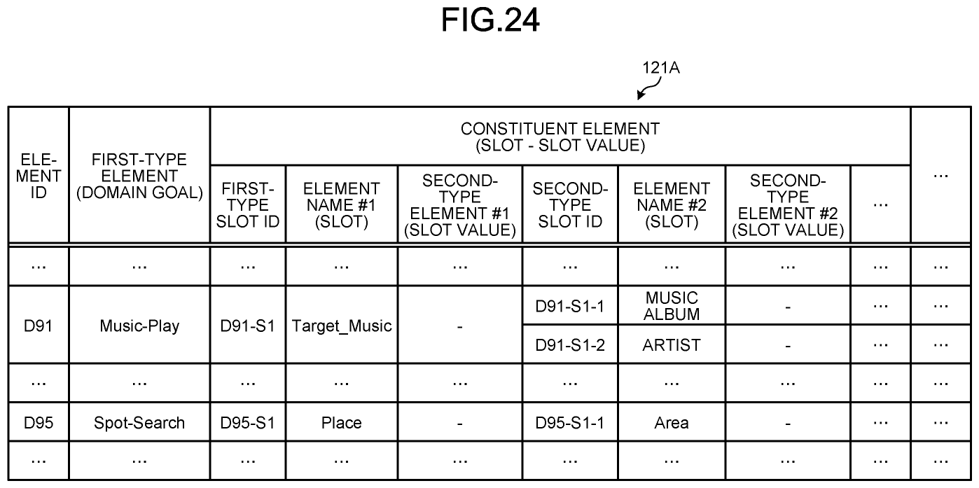

Explained below with reference to FIG. 24 is a data structure of the hierarchized slots. FIG. 24 is a diagram illustrating an example of an element information storing unit in which the slots have a hierarchical relationship. An element information storing unit 121A illustrated in FIG. 24 is obtained when the items of the constituent elements of the element information storing unit 121 illustrated in FIG. 4 are expanded according to the hierarchical structure of the slots.

The element information storing unit 121A illustrated in FIG. 24 is used to store a variety of information related to the elements. The element information storing unit 121A is used to store a variety of information of the elements related to the dialogue state of the user. The element information storing unit 121A is used to store a variety of information such as the first-type elements (the domain goals) indicating the dialogue state of the user and the second-type elements (the slot values) corresponding to the elements (slots) that belong to the first-type elements.

In the element information storing unit 121A illustrated in FIG. 24, the following items are included: “element ID”, “first-type element (domain goal)”, and “constituent element (slot-slot value)”. In the item “constituent element (slot-slot value)”, the following items are included: “first-type slot ID”, “element name #1 (slot)”, “second-type element #1 (slot value)”, “second-type slot ID”, “element name #2 (slot)”, and “second-type element #2 (slot value)”. Meanwhile, in the example illustrated in FIG. 24, for ease of explanation, information up to the second-level slots is stored. However, when there are three or more hierarchies of the slots, items corresponding to each hierarchy, such as “third-type slot ID”, “element name #3 (slot)”, and “second-type element #3 (slot value)”, can also be included.

The item “element ID” represents identification information enabling identification of an element. The item “element ID” represents identification information for enabling identification of the domain goal representing the first-type element. The item “first-type element (domain goal)” represents the first-type element (the domain goal) that is identified by the element ID. Thus, the item “first-type element (domain goal)” indicates the specific name of the first-type element (the domain goal) that is identified by the element ID.

In the item “constituent element (slot-slot value)”, a variety of information regarding the constituent elements of the concerned first-type element (the domain goal) is stored. In the item “constituent element (slot-slot value)” illustrated in FIG. 24, the information about the slots having a hierarchical structure is stored.

The item “first-type slot ID” represents identification information enabling identification of a constituent element (slot). The item “element name #1 (slot)” represents the specific name of the constituent element identified by the corresponding slot ID. The item “element name #1 (slot)” is used to store the information indicating a first-level slot. The item “second-type element #1 (slot value)” represents a second-type element that is the slot value of the corresponding first-level slot.

The item “second-type slot ID” represents identification information enabling identification of a constituent element (slot). The item “element name #2 (slot)” represents the specific name of the constituent element identified by the corresponding slot ID. The item “element name #2 (slot)” is used to store the information indicating a second-level slot. The item “second-type element #2 (slot value)” represents a second-type element that is the slot value of the corresponding second-level slot.

In the example illustrated in FIG. 24, the first-type element identified by the element ID “D91” (corresponding to the “domain goal D91” illustrated in FIG. 1) is “Music-Play” representing the domain goal corresponding to the dialogue about the music playback. Moreover, to the domain goal D91, the first-level slot having the first-type slot ID “D91-S1” is associated. The first-level slot identified by the first-type slot ID “D91-S1” (corresponding to the “slot D91-S1” illustrated in FIG. 22) represents the slot corresponding to “Target_Music”.

Moreover, to the first-level slot “Target_Music”, the second-level slots representing the lower hierarchy are associated. Thus, to the first-level slot “Target_Music”, the second-level slot having the second-type slot ID “D91-S1-1” and the second-level slot having the second-type slot ID “D91-S1-2” are associated. The second-level slot identified by the first-type slot ID “D91-S1-1” (corresponding to the “slot D91-S1-1 illustrated in FIG. 22) represents the slot corresponding to “music album”. The second-level slot identified by the first-type slot ID “D91-S1-2” (corresponding to the “slot D91-S1-2 illustrated in FIG. 22) represents the slot corresponding to “artist”.

Meanwhile, the element information storing unit 121A is not limited to store the information explained above, and can be used to store a variety of other information depending on the objective. For example, the element information storing unit 121A can be used to store, in a corresponding manner to the element ID, information indicating conditions by which the dialogue state of the user is determined to correspond to the domain goal. In the element information storing unit 121A, when the slot value of a slot is changed, the information enabling identification of the other slots affected by the change can be stored in a corresponding manner to the changed slot.

[1-12. Sequence of Information Correction Operation]

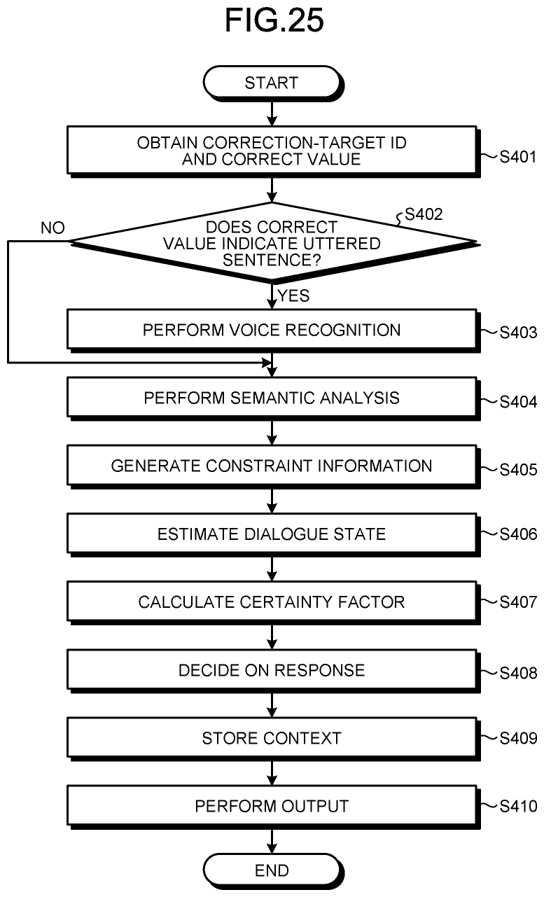

Explained below with reference to FIG. 25 is a detailed flow of the operations performed when the user makes a correction. FIG. 25 is a flowchart for explaining the sequence of operations performed when the user makes a correction. More particularly, FIG. 25 is a flowchart for explaining the sequence of operations performed in the information processing system 1 in response to a correction made by the user. Herein, the operation performed at each step can be performed by any device included in the information processing system 1, such as either by the information processing device 100 or by the display device 10.

As illustrated in FIG. 25, the information processing system 1 obtains the correction-target ID and the correct value (Step S401). Then, the information processing system 1 determines whether or not the correct value is an uttered sentence (Step S402). If it is determined that the correct value is not an uttered sentence (No at Step S402), then the information processing system 1 skips the operation at Step S403 and performs the operation at Step S404.

On the other hand, if it is determined that the correct value is an uttered sentence (Yes at Step S402), then the information processing system 1 performs a voice recognition operation (Step S403).

Subsequently, the information processing system 1 performs semantic analysis (Step S404). Herein, the information processing system 1 performs semantic analysis by analyzing the correction-target ID and the correct value. For example, the information processing system 1 identifies the target for correction according to the correction-target ID. Moreover, for example, the information processing system 1 identifies the correct value by performing semantic analysis thereof. For example, from the correction-target ID, the information processing system 1 identifies the domain goal or the slot value to be updated (changed).

Then, the information processing system 1 generates constraint information (Step S405). For example, the information processing system 1 generates constraint information indicating a constraint that an element corrected according to the correct value is unchangeable.

Subsequently, the information processing system 1 estimates the dialogue state (Step S406). For example, from among the candidates for domain goal as extracted at Step S404, the information processing system 1 selects the domain goal by taking into account the constraint information and the context. Moreover, for example, the information processing system 1 estimates the slot value of the selected domain goal and the slot values of the slots included in the selected domain goal. Then, the information processing system 1 calculates the certainty factors (Step S407). For example, the information processing system 1 calculates the certainty factors of the domain goal and the slot values corresponding to the estimated dialogue state.

Then, the information processing system 1 decides on a response (Step S408). For example, the information processing system 1 decides on a response (utterance) to be output in a corresponding manner to the user utterance. For example, the information processing system 1 decides on the highlighting targets from among the displayed elements, and decides on the screen display.

Moreover, the information processing system 1 stores the context (Step S409). For example, the information processing system 1 stores the context information in the context information storing unit 125 (see FIG. 8). For example, the information processing system 1 stores, in the context information storing unit 125 (see FIG. 8), the context information in a corresponding manner to the user from which it is obtained. For example, the information processing system 1 stores, as the context information, a variety of information such as the user utterance, the semantic analysis result, the sensor information, and the system response information.

Then, the information processing system 1 performs the output (Step S410). For example, the information processing system 1 outputs the response decided at Step S408. The information processing system 1 outputs the response in the form a voice to the user. Moreover, for example, the information processing system 1 displays a screen in which the decided highlighting targets are displayed in a highlighted manner.

[1-13. Visualization According to Utterance Order]

Meanwhile, the timings at which the information processing system 1 displays information can be various timings. For example, the information processing system 1 is not limited to displaying an image after calculating the certainty factors or after deciding on the highlighting targets, and can dynamically update the display according to the utterances made by the user. That is, the information processing system 1 can perform visualization according to the utterance order. For example, if the user utters “tomorrow, how is the weather” in Japanese, then the information processing system 1 can visualize the slot “date and time” and the slot value “tomorrow” at the point of time utterance of “tomorrow”, and can visualize a domain goal “Weather-Check” at the point of time of utterance of “how is the weather”. More particularly, for example, if the user utters “tomorrow, how is the weather”, then the information processing system 1 generates an image (an image IMX) that includes the slot “date and time” and the slot value “tomorrow” at the point of time utterance of “tomorrow”. Then, at the point of time of utterance of “how is the weather”, the information processing system 1 can update the displayed image IMX, and display an image (an image IMY) that includes the domain goal “Weather-Check”.

In an identical manner, for example, if the user utters “check today's weather” in English, then the information processing system 1 can visualize the slot “date and time” and the slot value at the point of time utterance of “today's”, and can visualize the domain goal “Weather-Check” at the point of time of utterance of “weather”. In this way, in the information processing system 1, visualization is performed at the time of utterance and recognition; and, regardless of the language, visualization can be performed according to the utterance order.

### 2. Other Exemplary Configurations

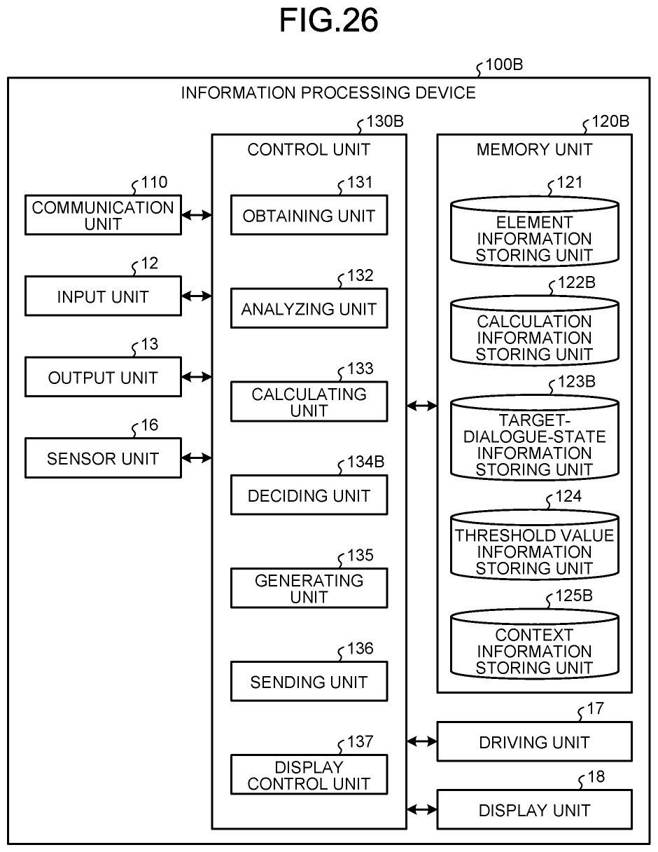

In the example explained above, the device that calculates the certainty factors and decides on the highlighting targets (i.e., the information processing device 100 or the information processing device 100A) is different than the device that displays the information (i.e., the display device 10 or the display device 10A). Alternatively, those devices can be integrated into a single device. For example, the device used by the user can be an information processing device equipped with the function of calculating the certainty factors and deciding on the highlighting targets as well as equipped with the function of displaying information. That point is explained below with reference to FIGS. 26 to 29.

[2-1. Configuration of Information Processing Device According to Second Modification Example]

Given below is the explanation of an information processing device 100B that is an example of the information processing device for performing information processing according to a second modification example. FIG. 26 is a diagram illustrating an exemplary configuration of an information processing device according to the second modification example of the application concerned. For example, the information processing device 100B obtains a variety of information from a service provision device (not illustrated) meant for providing a dialogue system service, and performs various operations using the obtained information. For example, the information processing device 100B obtains, from the service provision device, a variety of information such as the information stored in the element information storing unit 121 and the information stored in the threshold value information storing unit 124; and performs various operations using the obtained information. Meanwhile, in the following explanation of the information processing device 100B, the constituent elements that are identical to the constituent elements of the information processing device 100 illustrated in FIG. 3 and the display device 10 illustrated in FIG. 10 are referred to by the same reference numerals, and their explanation is not given again.

As illustrated in FIG. 26, the information processing device 100B includes the communication unit 110, the input unit 12, the output unit 13, a memory unit 120B, a control unit 130B, the sensor unit 16, the driving unit 17, and the display unit 18.

The communication unit 110 sends information to and receives information from other information processing devices such as a voice recognition server. The input unit 12 receives input of various operations from the user. The output unit 13 outputs a variety of information.

The memory unit 120B is implemented using, for example, a semiconductor a memory device such as a RAM or a flash memory, or a memory device such as a hard disk or an optical disk. As illustrated in FIG. 26, the memory unit 120B according to the second modification example includes the element information storing unit 121, a calculation information storing unit 122B, a target-dialogue-state information storing unit 123B, the threshold value information storing unit 124, and a context information storing unit 125B.

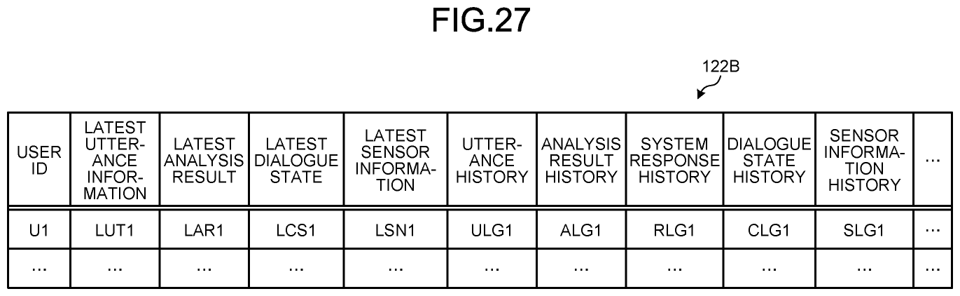

The calculation information storing unit 122B according to the second modification example is used to store a variety of information to be used in calculating the certainty factors. Thus, the calculation information storing unit 122B is used to store a variety of information to be used in calculating the first-type certainty factors, which represent the certainty factors of the first-type elements, and the second-type certainty factors, which represent the certainty factors of the second-type elements. FIG. 27 is a diagram illustrating an example of the calculation information storing unit according to the second modification example. In the calculation information storing unit 122B illustrated in FIG. 27, in an identical manner to the calculation information storing unit 122 illustrated in FIG. 5, the following items are included: “user ID”: “latest utterance information”, “latest analysis result”, “latest dialogue state”, “latest sensor information”, “utterance history”, “analysis result history”, “system response history”, “dialogue state history”, and “sensor information history”.

As compared to the calculation information storing unit 122 illustrated in FIG. 5, the calculation information storing unit 122B illustrated in FIG. 27 differs in the way of being used to store the calculation information related only to the user of the information processing device 100B. Herein, the explanation is given about the case in which the calculation information storing unit 122B illustrated in FIG. 27 is used to store the calculation information about only the user U1 who uses the information processing device 100B. If a plurality of users is using the information processing device 100B, then the calculation information storing unit 122B is used to store the calculation information of each of those users in a corresponding manner to the information (user ID) enabling identification of that user.

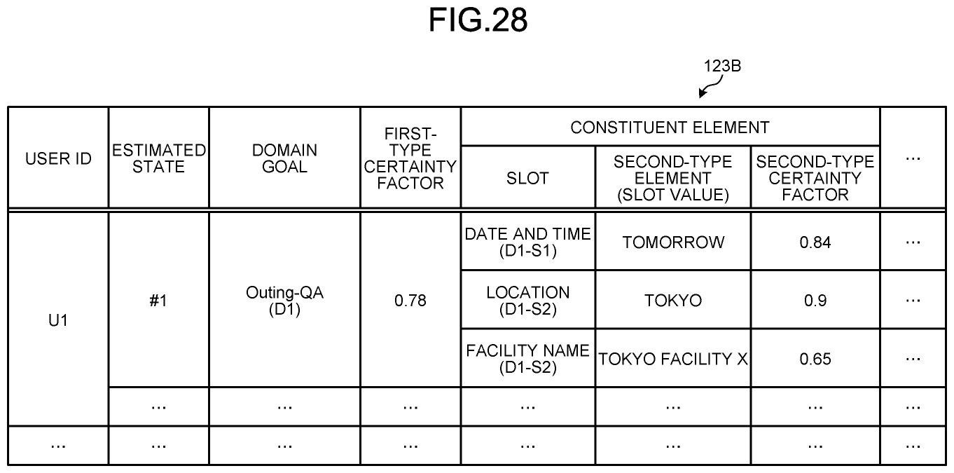

The target-dialogue-state information storing unit 123B illustrated in FIG. 23 is used to store the information corresponding to the estimated dialogue state. For example, the target-dialogue-state information storing unit 123B is used to store the information corresponding to the dialogue state estimated for each user. FIG. 28 is a diagram illustrating an example of the target-dialogue-state information storing unit according to the second modification example. In the target-dialogue-state information storing unit 123B illustrated in FIG. 28, in an identical manner to the target-dialogue-state information storing unit 123 illustrated in FIG. 6, the following items are included: “user ID”, “estimated state”, “domain goal”, “first-type certainty factor”, and “constituent element”. Moreover, in the item “constituent element”, the following items are included: “slot”, “second-type element (slot value)”, and “second-type certainty factor”.

As compared to the target-dialogue-state information storing unit 123 illustrated in FIG. 6, the target-dialogue-state information storing unit 123B illustrated in FIG. 28 differs in the way of being used to store the target dialogue state related only to the user of the information processing device 100B. Herein, the explanation is given for the case in which the target-dialogue-state information storing unit 123B illustrated in FIG. 28 is used to store the target dialogue state of only the user U1 who uses the information processing device 100B. If a plurality of users is using the information processing device 100B, then the calculation information storing unit 122B is used to store the target dialogue state of each of those users in a corresponding manner to the information (user ID) enabling identification of that user.

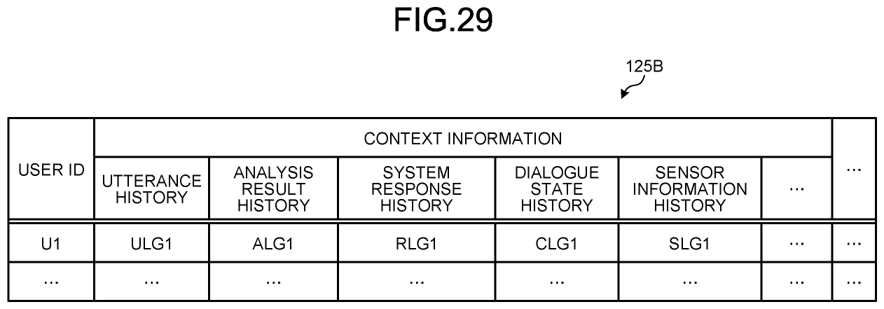

The context information storing unit 125B according to the second modification example is used to store a variety of information related to the context. The context information storing unit 125B is used to store a variety of information related to the context corresponding to each user. Thus, the context information storing unit 125B is used to store a variety of information related to the context collected regarding each user. FIG. 29 is a diagram illustrating an example of the context information storing unit according to the second modification example. In the context information storing unit 125B illustrated in FIG. 29, in an identical manner to the context information storing unit 125 illustrated in FIG. 8, items such as “user ID” and “context information” are included. In the item “context information”, the following items are included: “utterance history”, “analysis result history”, “system response history”, “dialogue state history”, and “sensor information history”.

As compared to the context information storing unit 125 illustrated in FIG. 8, the context information storing unit 125B illustrated in FIG. 29 differs in the way of storing the context information related only to the user of the information processing device 100B. Herein, the explanation is given for the case in which the context information storing unit 125B illustrated in FIG. 29 is used to store the context information of only the user U1 who uses the information processing device 100B. If a plurality of users is using the information processing device 100B, then the context information storing unit 125B is used to store the context information of each of those users in a corresponding manner to the information (user ID) enabling identification of that user.

Returning to the explanation with reference to FIG. 26, the control unit 130B is implemented when a CPU or an MPU executes programs stored in the information processing device 100B (for example, a decision program representing an information processing program according to the application concerned), using the RAM as the work area. Alternatively, the control unit 130B is a controller implemented using an integrated circuit such as an ASIC or an FPGA.

As illustrated in FIG. 26, the control unit 130B includes the obtaining unit 131, the analyzing unit 132, the calculating unit 133, a deciding unit 134B, the generating unit 135, the sending unit 136, and a display control unit 137; and implements or executes the functions and the actions of information processing explained below. The internal configuration of the control unit 130B is not limited to the configuration illustrated in FIG. 26, and it is possible to have some other configuration as long as the information processing explained below can be performed. Moreover, the connection relationship among the processing units of the control unit 130B is not limited to the connection relationship illustrated in FIG. 26, and it is possible to have some other connection relationship.

The deciding unit 134B decides on a variety of information. The deciding unit 134B decides on a variety of information in an identical manner to the deciding unit 134 of the information processing device 100 illustrated in FIG. 3. Moreover, the deciding unit 134B decides on a variety of information in an identical manner to the deciding unit 153 of the display device 10 illustrated in FIG. 10. Thus, the deciding unit 134B decides on the highlighting targets to be displayed in a highlighted manner in the display unit 18.

The display control unit 137 controls a variety of display. The display control unit 137 controls the display in the display unit 18. The display control unit 137 controls the display in the display unit 18 according to the information obtained by the obtaining unit 131. Moreover, the display control unit 137 controls the display in the display unit 18 based on the information decided by the deciding unit 134B. Thus, the display control unit 137 controls the display in the display unit 18 according to the decisions made by the deciding unit 134B. The display control unit 137 controls the display in the display unit 18 in such a way that an image in which the highlighting targets are highlighted is displayed in the display unit 18.

The sensor unit 16 detects a variety of sensor information. The driving unit 17 has the function of driving the physical configuration in the information processing device 100B. Meanwhile, the information processing device 100B need not include the driving unit 17. The display unit 18 is used to display a variety of information. When the deciding unit 134B decides to treat an element as the target for highlighted display, that element is displayed in a highlighting manner in the display unit 18.

Of the processes described in the embodiment, all or part of the processes explained as being performed automatically can be performed manually. Similarly, all or part of the processes explained as being performed manually can be performed automatically by a known method. The processing procedures, the control procedures, specific names, various data, and information including parameters described in the embodiment or illustrated in the drawings can be changed as required unless otherwise specified. For example, the variety of information explained with reference to the drawings is not limited to the information illustrated in the drawings.

The constituent elements of the device illustrated in the drawings are merely conceptual, and need not be physically configured as illustrated. The constituent elements, as a whole or in part, can be separated or integrated either functionally or physically based on various types of loads or use conditions.

Moreover, embodiments and modification examples can be combined without causing any contradiction in the operation details.

Meanwhile, the effects described in the present written description are only explanatory and exemplary, and are not limited in scope. That is, it is also possible to achieve other effects.

### 3. Hardware Configuration

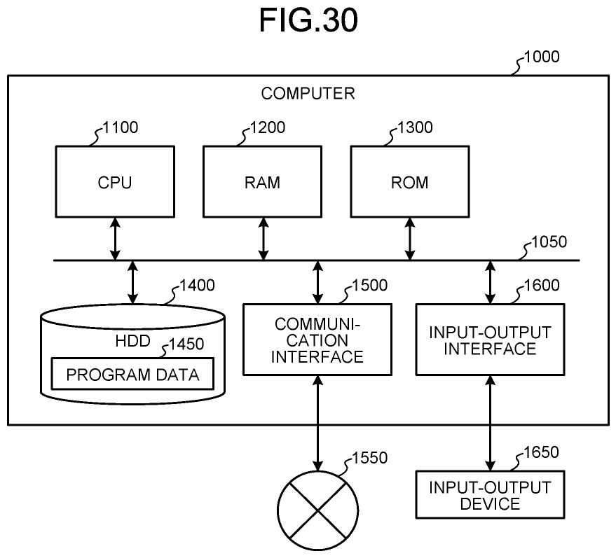

An information device according to the embodiment and the modification examples explained above, such as the information processing device 100, the information processing device 100A, the information processing device 100B, the display device 10, or the display device 10A, is implemented using a computer 1000 having a configuration as illustrated in, for example, FIG. 30. FIG. 30 is a hardware configuration diagram illustrating an example of the computer 1000 used for implementing the functions of the information processing device 100, the information processing device 100A, the information processing device 100B, the display device 10, or the display device 10A. The following explanation is given with reference to the information processing device 100 according to the embodiment. The computer 1000 includes a CPU 1100, a RAM 1200, a ROM (Read Only Memory) 1300, an HDD (Hard Disk Drive) 1400, a communication interface 1500, and an input-output interface 1600. The constituent elements of the computer 1000 are connected to each other by a bus 1050.

The CPU 1100 performs operations based on the programs stored in the ROM 1300 or the HDD 1400, and controls the other constituent elements. For example, the CPU 1100 loads the programs from the ROM 1300 or the HDD 1400 into the RAM 1200, and performs processing according to those various programs.

The ROM 1300 is used to store a boot program such as the BIOS (Basic Input Output System) that is executed by the CPU 1100 at the time of booting of the computer 1000, and to store the programs dependent on the hardware of the computer 1000.

The HDD 1400 is a computer-readable recording medium used to store, in a non-temporary manner, the data programs to be executed by the CPU 1100 and the data used in those programs. More particularly, the HDD 1400 is a recording medium used to store, as an example of program data 1450, the information processing program according to the application concerned.

The communication interface 1500 is an interface for connecting the computer 1000 to an external network 1550 (for example, the Internet). For example, it is via the communication interface 1500 that the CPU 1100 receives data from other devices and sends data generated therein to other devices.

The input-output interface 1600 is an interface for connecting an input-output device 1650 and the computer 1000. For example, it is via the input-output interface 1600 that the CPU 1100 receives data from an input device such as a keyboard or a mouse. Moreover, it is via the input-output interface 1600 that the CPU 1100 sends data to an output device such as a display, a speaker, or a printer. The input-output interface 1600 can also function as a media interface for reading programs recorded in a predetermined recording medium (media). Examples of the media include an optical recording medium such as a DVD (Digital Versatile Disc) or a PD (Phase change rewritable Disk); a magneto-optical recording medium such as an MO (Magneto-Optical disk); a tape medium; a magnetic recording medium; and a semiconductor memory. For example, when the computer 1000 functions as the information processing device 100 according to the embodiment, the CPU 1100 of the computer 1000 executes the information processing program loaded in the RAM 1200 and implements the functions of the control unit 130. Meanwhile, the HDD 1400 is used to store the information processing program according to the application concerned, and to store the data in the memory unit 120. Meanwhile, although the CPU 1100 reads the program data 1450 from the HDD 1400 and executes it, it can alternatively obtain the programs from other devices via the external network 1550.

Meanwhile, a configuration as explained below also falls within the technical scope of the application concerned.

(1)

An information processing device comprising: an obtaining unit that obtains an element related to dialogue state of user of a dialogue system, and certainty factor of the element; and a deciding unit that, according to the certainty factor obtained by the obtaining unit, decides on whether or not to treat the element as target for highlighted display.

(2)

The information processing device according to (1), wherein the obtaining unit obtains a threshold value to be used in deciding on whether or not to have the target for highlighted display, and based on comparison between the certainty factor and the threshold value, the deciding unit decides on whether or not to treat the element as the target for highlighted display.

(3)

The information processing device according to (2), wherein, when the certainty factor is smaller than the threshold value, the deciding unit decides to treat the element as the target for highlighted display.

(4)

The information processing device according to any one of (1) to (3), wherein

the obtaining unit obtains correction information indicating correction made by the user with respect to the element, and

the deciding unit changes the element to a new element based on the correction information obtained by the obtaining unit.

(5)

The information processing device according to (4), wherein, based on the correction information obtained by the obtaining unit, the deciding unit decides on target for change from among other elements other than the element.

(6)

The information processing device according to any one of (1) to (5), further comprising a calculating unit that calculates the certainty factor based on information related to the dialogue system, wherein the obtaining unit obtains the certainty factor calculated by the calculating unit.

(7)

The information processing device according to (6), wherein the calculating unit calculates the certainty factor based on information related to the user.

(8)

The information processing device according to (7), wherein the calculating unit calculates the certainty factor based on utterance information of the user.

(9)

The information processing device according to any one of (6) to (8), wherein the calculating unit calculates the certainty factor based on sensor information detected by a predetermined sensor.

(10)

The information processing device according to any one of (1) to (9), wherein

the obtaining unit obtains
a first-type element representing dialogue state of the user, and
a first-type certainty factor representing certainty factor of the first-type element, and

according to the first-type certainty factor, the deciding unit decides on whether or not to treat the first-type element as the target for highlighted display.

(11)

The information processing device according to (10), wherein

the obtaining unit
obtains a second-type element representing a constituent element of the first-type element, and
obtains a second-type certainty factor representing certainty factor of the second-type element, and

according to the second-type certainty factor, the deciding unit decides on whether or not to treat the second-type element as the target for highlighted display.

(12)

The information processing device according to (11), wherein the obtaining unit

obtains the second-type element belonging to lower hierarchy of the first-type element, and

obtains the second-type certainty factor.

(13)

The information processing device according to (11) or (12), wherein

the obtaining unit obtains first-type correction information indicating correction made by the user with respect to the first-type element, and

the deciding unit
changes the first-type element to a new first-type element based on the first-type correction information obtained by the obtaining unit, and
changes the second-type element to a new second-type element corresponding to the new first-type element.
   (14)

The information processing device according to (13), wherein

the obtaining unit obtains
a new first-type certainty factor representing certainty factor of the new first-type element, and
a new second-type certainty factor representing certainty factor of the new second-type element,

according to the new first-type certainty factor, the deciding unit decides on whether or not to treat the first-type element as the target for highlighted display, and

according to the new second-type certainty factor, the deciding unit decides on whether or not to treat the second-type element as the target for highlighted display.

(15)

The information processing device according to any one of (11) to (14), wherein

the obtaining unit obtains second-type correction information indicating correction made by the user with respect to the second-type element, and

the deciding unit changes the second-type element to a new second-type element based on the second-type correction information obtained by the obtaining unit.

(16)

The information processing device according to (15), wherein

the obtaining unit obtains a particular element and obtains a second-type element including a lower level element belonging to lower hierarchy of the particular element, and

according to change in the particular element, the deciding unit decides on whether or not to change the lower-level element.

(17)

The information processing device according to any one of (1) to (16), further comprising a display unit that, when the deciding unit decides to treat the element as the target for highlighted display, displays the element in a highlighted manner.

(18)

An information processing method comprising: obtaining an element, which is related to dialogue state of user of a dialogue system, and certainty factor of the element; and

deciding that, according to the obtained certainty factor, includes deciding on whether or not to treat the element as target for highlighted display.

(19)

An information processing device comprising:

a receiving unit that receives highlighting/no highlighting information indicating whether or not an element, which is related to content of dialogue of user of a dialogue system, is target for highlighted display; and

a display unit that, if the element is the target for highlighted display based on the highlighting/no highlighting information received by the receiving unit, displays the element in a highlighted manner.

(20)

An information processing method comprising:

receiving highlighting/no highlighting information indicating whether or not an element, which is related to content of dialogue of user of a dialogue system, is target for highlighted display; and

displaying that, if the element is the target for highlighted display based on the received highlighting/no highlighting information, includes displaying the element in a highlighted manner.

### REFERENCE SIGNS LIST

1 information processing system
100, 100A, 100B information processing device
110 communication unit
120, 120B memory unit
121 element information storing unit
122, 122B calculation information storing unit
123, 123B target-dialogue-state information storing unit
124 threshold value information storing unit
125, 125B context information storing unit
130, 130B control unit
131 obtaining unit
132 analyzing unit
133 calculating unit
134, 134B deciding unit
135 generating unit
136 sending unit
137 display control unit
10, 10A display device
11 communication unit
12 input unit
13 output unit
14 memory unit
15 control unit
151 receiving unit
152 display control unit
153 deciding unit
154 sending unit
16 sensor unit
17 driving unit
18 display unit

1. An information processing device comprising:
an obtaining unit that obtains
an element related to dialogue state of user of a dialogue system, and
certainty factor of the element; and
a deciding unit that, according to the certainty factor obtained by the obtaining unit, decides on whether or not to treat the element as target for highlighted display.

2. The information processing device according to claim 1, wherein
the obtaining unit obtains a threshold value to be used in deciding on whether or not to have the target for highlighted display, and
based on comparison between the certainty factor and the threshold value, the deciding unit decides on whether or not to treat the element as the target for highlighted display.

3. The information processing device according to claim 2, wherein, when the certainty factor is smaller than the threshold value, the deciding unit decides to treat the element as the target for highlighted display.

4. The information processing device according to claim 1, wherein
the obtaining unit obtains correction information indicating correction made by the user with respect to the element, and
the deciding unit changes the element to a new element based on the correction information obtained by the obtaining unit.

5. The information processing device according to claim 4, wherein, based on the correction information obtained by the obtaining unit, the deciding unit decides on target for change from among other elements other than the element.

6. The information processing device according to claim 1, further comprising a calculating unit that calculates the certainty factor based on information related to the dialogue system, wherein
the obtaining unit obtains the certainty factor calculated by the calculating unit.

7. The information processing device according to claim 6, wherein the calculating unit calculates the certainty factor based on information related to the user.

8. The information processing device according to claim 7, wherein the calculating unit calculates the certainty factor based on utterance information of the user.

9. The information processing device according to claim 6, wherein the calculating unit calculates the certainty factor based on sensor information detected by a predetermined sensor.

10. The information processing device according to claim 1, wherein
the obtaining unit obtains
a first-type element representing dialogue state of the user, and
a first-type certainty factor representing certainty factor of the first-type element, and
according to the first-type certainty factor, the deciding unit decides on whether or not to treat the first-type element as the target for highlighted display.

11. The information processing device according to claim 10, wherein
the obtaining unit
obtains a second-type element representing a constituent element of the first-type element, and
obtains a second-type certainty factor representing certainty factor of the second-type element, and
according to the second-type certainty factor, the deciding unit decides on whether or not to treat the second-type element as the target for highlighted display.

12. The information processing device according to claim 11, wherein the obtaining unit
obtains the second-type element belonging to lower hierarchy of the first-type element, and
obtains the second-type certainty factor.

13. The information processing device according to claim 11, wherein
the obtaining unit obtains first-type correction information indicating correction made by the user with respect to the first-type element, and
the deciding unit
changes the first-type element to a new first-type element based on the first-type correction information obtained by the obtaining unit, and
changes the second-type element to a new second-type element corresponding to the new first-type element.

14. The information processing device according to claim 13, wherein
the obtaining unit obtains
a new first-type certainty factor representing certainty factor of the new first-type element, and
a new second-type certainty factor representing certainty factor of the new second-type element,
according to the new first-type certainty factor, the deciding unit decides on whether or not to treat the first-type element as the target for highlighted display, and
according to the new second-type certainty factor, the deciding unit decides on whether or not to treat the second-type element as the target for highlighted display.

15. The information processing device according to claim 11, wherein
the obtaining unit obtains second-type correction information indicating correction made by the user with respect to the second-type element, and
the deciding unit changes the second-type element to a new second-type element based on the second-type correction information obtained by the obtaining unit.

16. The information processing device according to claim 15, wherein
the obtaining unit obtains a particular element and obtains a second-type element including a lower level element belonging to lower hierarchy of the particular element, and
according to change in the particular element, the deciding unit decides on whether or not to change the lower-level element.

17. The information processing device according to claim 1, further comprising a display unit that, when the deciding unit decides to treat the element as the target for highlighted display, displays the element in a highlighted manner.

18. An information processing method comprising:
obtaining an element, which is related to dialogue state of user of a dialogue system, and certainty factor of the element; and
deciding that, according to the obtained certainty factor, includes deciding on whether or not to treat the element as target for highlighted display.

19. An information processing device comprising:
a receiving unit that receives highlighting/no highlighting information indicating whether or not an element, which is related to content of dialogue of user of a dialogue system, is target for highlighted display; and
a display unit that, if the element is the target for highlighted display based on the highlighting/no highlighting information received by the receiving unit, displays the element in a highlighted manner.

20. An information processing method comprising:
receiving highlighting/no highlighting information indicating whether or not an element, which is related to content of dialogue of user of a dialogue system, is target for highlighted display; and
displaying that, if the element is the target for highlighted display based on the received highlighting/no highlighting information, includes displaying the element in a highlighted manner.
